(19) United States
(12) Patent Application Publication
(10) Pub. No.: US 2021/0324837 A1
(43) Pub. Date: Oct. 21, 2021

(54) Inertial Propulsion and Attitude-Control System and Methodology

(71) Applicant: Mark David Abers, Riga (LV)

(72) Inventor: Mark David Abers, Riga (LV)

(21) Appl. No.: 17/361,308

(22) Filed: Jun. 28, 2021

Related U.S. Application Data
(63) Continuation-in-part of application No. 15/944,754, filed on Apr. 3, 2018, now Pat. No. 11,047,369.

(51) Int. Cl. F03G 3/00

(52) U.S. Cl. CPC F03G 3/00

(57) ABSTRACT

This invention discloses an Inertial Propulsion and Attitude-Control System (IPACS) and Methodology that employ inertial-thruster technology to achieve rotational and linear movement. An architecture has been developed that merges methodological and mechanical embodiment that result in the redirection of the effects of torque-induced precession on both oscillatory and rotary devices. Said embodiments demonstrate that the redirection of precession by using appropriate methods will alter the behavior of inertia so as to achieve either rotational or rectilinear inertial thrust wherein rotational inertial thrust is applicable to attitude control of free bodies such as satellites and wherein rectilinear inertial thrust is applicable to propellant-less propulsion.

### CROSS REFERENCED TO RELATED APPLICATIONS

This application is a continuation-in-part (CIP) of application Ser. No. 15/944,754, filed Apr. 3, 2018, now patent Ser. No. 11/047,369, titled “Multiple Torques Inertial Thruster Engine and Methodology”, (Attorney Docket Number: ABER 1 US).

### FEDERALLY SPONSORED RESEARCH

Not Applicable.

### SEQUENCE LISTING

Not Applicable.

### RELATED APPLICATION DATA

Int. Cl: B64G1/28; F03G3/08; B64G1/409; F03G3/06; F03G7/10; F16H27/04; G01C19/02; Y10T74/1225.
U.S. Cl: 74/84S; 244/165; 244/171.5; 74/5.37; 74/84R.

### FIELD OF CLASSIFICATION SEARCH

74/5.37; 74/84R; 74/84S; 244/165; 244/171.5;
B64G1/28; B64G1/409; F03G3/06; F03G3/08; F03G7/10; F16H27/04;
G01C19/02; Y10T74/1225.

Should I personally receive any financial profits from this invention I do hereby dedicate the totality of said profits to be used for religious and/or humanitarian purposes (according to my choosing).

### BACKGROUND OF THE INVENTION

### 1. Field of the Invention

Various terms are defined in the following specification. For convenience, a Glossary of Terms is provided herein, in the end portion of this specification.

This invention introduces a unique damping methodology to the field of inertial thrusters. Damping is defined, in this disclosure, as being an influence within or upon a precessional system that has the effect of redirecting, modifying, reducing, and/or increasing its precessional torque. Thus damping, depending on the situation, can be used to both reinforce and diminish precession. Inertial thrusters are theoretically based on the dual-configuration concept wherein the thrust phase 212, also referred to as the maximized-thrust phase, is the cycle that provides linear or rotational forward thrust by either maintaining inertia at its normal level of reactivity or by enhancing inertia with an increased level of reactivity. The null phase 211, also referred to as the minimized-thrust phase, is the cycle that creates less reactivity than the thrust phase which is usually considered to be zero or minimal reverse thrust. The null phase and thrust phase in this approach follow one another in succession so as create said unidirectional motion in an intended direction of rectilinear or curvilinear movement of said engine and wherein said null phase and said thrust phase, in combination, comprise a methodology for operating of an inertial-thruster.

The present invention relates to the design and operation of an inertial thruster that does not require any reactive engagement with a supporting surface or fluid medium and that uses damping to modify the direction of torque-induced precession. The term “precession,” for the purposes of this disclosure, is any orthogonal or diagonal movement that occurs when a torque is applied to a spinning or vibrating mass. This invention is concerned with an architecture 300 in which precessional torque is damped, redirected and/or interfered with in such a way that it is exploited to create unidirectional or rotational propulsion. For the purposes of this invention, this inertial-propulsion device will be called a Multiple Torques Inertial Thruster (MUTINT). Said MUTINT is used in the context of an Inertial Propulsion and Attitude-Control Control System (IPACS).

### 2. Description of Related Art

It appears to be a tradition for inertial-thruster patents to begin with a treatment of Newton's third law of motion. Newton's law states that every action (singular) has an equal and opposite reaction. Newton's Third Law relates specifically to a single action-reaction scenario. Given that Newton's Law does not specifically cover the reaction to multiple simultaneous actions therefore Newton's third law of motion does not deny the plausibility of an inertial thrust device.

It is commonly known that the angular torque applied to a precessable mass (e.g., a spinning rotor) causes precessional torque. This precessional torque is described by the Second Law of Gyrodynamics. Said law relates to the effect on one of the gyro's axes when an attempt is made to change its direction on any of its three axes. In a given gyro, where the spin axis is horizontal (e.g., X-axis), an external torque on a perpendicular axis (e.g., Y-axis) will cause precession not about the Y-axis but on an orthogonal axis (e.g., the Z-axis). (See FIG. 7A.) Hence ωₚ (precessional-angular velocity) rotates about an axis that, in this case, is substantially perpendicular to the spin axis of the rotor and the axis on which torque is applied. The generic formula for precession is given by the equation ωₚ ma_{g}r/Iₛωₛ (FIG. 7D) where “ωₚ” is the angular velocity of precession (precession rate), “Iₛ” is the moment of inertia, “ωₛ” is the angular velocity of the rotor's spin about the spin axis, “m” is the mass creating the torque, “a_{g}” is the acceleration due to gravity and “r” is the perpendicular distance of the spin axis about the axis of precession. Thus, an accelerating mass “m” applied to the axis of a spinning rotor (ωₛ) having a rotational inertia (Iₛ) causes precessional torque (ωₚ) wherein torque comprises actual angular movement or merely pressure or force in an orthogonal direction. (However, in this invention the “a_{g}” i.e., gravity-induced acceleration, is substituted with a generic acceleration “a” that is induced by an element(s) of a first-axis or third-axis torquing system such as an actuator, spring, locking device, motor, guide track, or other such torque-producing devices wherein a torquing system is a means for conveying and controlling rotational energy. The term axis (singular of axes), in this disclosure is the imaginary line around which something rotates or could rotate. Multiple axes are often, but not necessarily, orthogonal to each other. A given axis may be either at a right angle (orthogonal) to another axis or a given axis could be diagonal to another axis.

The direction of a given precessional torque can be changed by the hurrying or delaying of precession resulting in the redirecting of the precession torque by as much as 90 degrees. Although not well known, nonetheless, this redirection of precessional torque is well documented. Some of the earlier observations are in the context of the oscillations (nutations) of a spinning top. In 1911, Edwin Barton wrote of positive and negative torques that can be induced upon a precessional torque. Said positive and negative torques can also be called the hurrying or retarding (delaying) of the precessional torque. As a more in-depth explanation of hurrying and delaying effects, Barton said that if precession is slowed or prevented in a gyroscope, that a spinning top (gyroscope) would fall over. However, if the precession was made to go more quickly (hurried) that the spinning top (gyro device or gyroscope) would rise (pp. 274-275). This is in accordance with the old saying “Hurry the precession, the top (gyroscope) rises. Retard (delay) the precession, the top (gyroscope) falls.” (Crabtree, p. 47).

This “hurrying” (or delaying/retarding/resisting) of the top (or gyro device) has two variations: hurrying/delaying torque or “turning effect.” (NOTE: The “turning effect” is understood to be a reference to the yaw axis wherein said axis can also have a hurrying and delaying effect on precession.)

Ervin Ferry described how to damp precession in his book published in 1933. He describes a simple procedure that exemplifies the effect of a damping procedure to achieve the hurrying 262 and delaying 261 of gyroscopic precession. He writes “Attach a small mass to the inner frame (i.e., gimbal) of the gyroscope at the point “m” thereby producing a torque on Axis “Y” as indicated. (See mass “m”, FIG. 7A.) Set the gyro-wheel spinning in the direction indicated. Observe that . . . the gyro-axle (precesses) with an angular velocity in the direction represented by “ωₚ” (precessional-angular velocity). Push horizontally against the second gyro-frame (i.e., gimbal) with the rubber tip of a lead pencil so that the spin-axle is moved in the direction of its precession. (See hurrying effect “H”, FIG. 7B.) Observe that the weighted side of the inner gyro-frame rises. Now push on the second frame (i.e., gimbal) so that the spin-axle is moved in the direction opposite its precession. (See Delaying effect “D”, FIG. 7C.) Observe that the weighted side of the inner frame sinks”” (p. 69).

Ferry describes the hurrying and delaying of precession as follows: “When the precessional speed of the axle of a spinning gyro is increased, the gyro is acted upon by an internal torque in opposition to the torque that produces the precession. When the precessional speed of the axle (shaft) of a spinning gyro is decreased, the gyro is acted upon by an internal torque in the same direction as the torque that produces the precession. When an external torque is applied to the axle (shaft) of a spinning gyro in the direction of the precession, an internal torque is developed which acts upon the gyro in opposition to the torque that produces the precession. When an external torque is applied to the axle (shaft) of a spinning gyro in the direction opposite to that of the precession, an internal torque is developed which acts upon the gyro in the same direction as the torque that produces the precession” (Ferry, p. 70). In summary, a hurrying torque applied in the direction of the original precession (ωₚ) will damp and thereby redirect the original precession into the opposite direction (180 degrees) of the original torque (or perpendicular to the original precession). Furthermore, a retarding (delaying) torque applied in the opposite direction of the original precession (ωₚ) will damp and thereby redirect the original precession into the same direction as the original torque (or perpendicular to the original precession). NOTE: For this disclosure said original precession is a reference to precessional torque that has not been damped as such it is referred to as a first-precessional torque for the null phase and as a second precessional torque for the thrust phase.

Much speculative effort to invent an inertial thruster has gravitated around gyroscopic devices. An inertial thruster of the gyroscopic class uses a reciprocating or revolving mass wherein the goal is to have more inertia in one direction (e.g., thrust phase) than the other (e.g., null phase). Harvey Fiala, in 2008 (U.S. Pat. No. 8,066,226B2, active), applied for a patent on an inertial-thrust device. Fiala's design demonstrated great ingenuity, however it was premised on an at least one faulty assumption. That assumption related to the interrelationship between precession and inertia. Prior art indicates that a spinning rotor with an induced precession, in and of itself, will have a reduced level of inertia when precessing even without damping. Said assertion does not withstand experimental rigor. All things being equal, a precessing rotor 14 moving along a curved trajectory has the same reactive thrust as a non-precessing rotor that is being moved along an equivalent trajectory at an equivalent speed. Experimental results show that a precessing rotor 14 will exhibit a diminished level of linear momentum in the null phase (also, depending on the method, referred herein as “Phase One”) only when the precessing mass is subjected to the appropriate form of damping 200. Damping, comprises the use of an additional torque to redirect, absorb, and interfere with the torque-induced precession. Said redirection will be up to 90 degrees of the torque axis causing the hurrying of precession 262 or by the delaying of precession 261. Damping 200, in order to be strategic should involve the hurrying 262 or delaying 261 of precessional torque and should be executed with the correct timing, for the correct duration (brief 251 or prolonged 252), in the correct direction on a three-dimensional scale (hurried 262 or delayed 261), with the correct category (passive 241 or active 242), and with the correct magnitude (i.e., dampable forcing torque is greater than or less than the damping torque). NOTE: The dampable-forcing torque was formerly referred to as “damped forcing torque.”

This invention is in agreement with the basic concept of dual-phase inertial thrusters: a first phase attempts to minimize or lessen the reaction and a second phase tries to maximize or obtain more of a reaction. (A second variation is when the first phase maintains the original level of inertia in a given direction and the second phase enhances or increase the level of inertia in a given direction.) A major problem with prior art dealing with inertial thrusters is that prior art does not adequately address the crucial issue of strategic damping 200. Furthermore, the thrust phase 212 (depending on the method used, also referred herein as “Phase Two”) of an inertial thruster, must have a method to displace, in a cyclical fashion, the precessable mass back to a start point in such a way that linear or rotational movement is achieved. Prior art's attempts at inertial thrust do not adequately describe either a device and/or a method to appropriately incorporate the requirement of active and passive damping of precessional torque.

### SUMMARY OF THE INVENTION

The object of this invention is to disclose an inertial-thrust engine (also referred to as an “inertial thruster”) in the context of an Inertial Propulsion and Attitude-Control System (IPACS). Given that inertial propulsion can be either linear or rotational and given that free bodies, such as satellites or ships can be benefitted by both rotational and linear propulsion wherein rotational propulsion can change or maintain a given posture of a free body and wherein linear propulsion can provide thrust to a free body or to any class of vehicle or moving platform. The MUTINT engine operates without the aid of gravity and has at least two distinguishing characteristics. The first distinguishing characteristic is an inertial thrust engine that uses methodological embodiments 200 that damp and/or redirect the direction of a torque-induced precession by a hurrying 262 or delaying 261 of a precessional torque. The second distinguishing characteristic is an inertial-thrust engine that is configured to cyclically displace, in at least two directions, a precessable mass 14 that has undergone or is undergoing precessional torque. The damping torque of said strategic damping, as has been mentioned, is applied at the correct time of a given mechanical configuration, for the required duration (brief 251 or prolonged 252), in the correct direction on a three-dimensional scale (hurrying 262 or delaying 261), with the correct category of damping (active 242 or passive 241), and with the correct magnitude (i.e., relatively greater than or less than the torque that induces original precession).

In order to incorporate the aforementioned criteria of angular displacement and strategic damping it is necessary to have a mechanical device that has at least three features. First, the engine will need a first-axis torquing system to provide either a dampable forcing torque (formerly referred to as “damped-forcing torque) or a damping torque (as needed) during the minimized-thrust 211 and/or thrust 212 phases on a first axis (The first axis, depending on the method used, can be either the pitch axis or the roll axis.) Second, the engine will need a precessable mass that has precession-related motion (e.g., spins or vibrates) on a second axis (e.g., spin axis) wherein said mass is capable of being precessed. Third, the engine will need a third-axis torquing system that serves the dual function of providing a dampable forcing torque (to initiate precession) and also to provide a damping torque that can be applied either passively 241 or actively 242 to either hurry 262 or delay 261 said precessional torque on a third axis. Said first-axis torquing systems has the dual purposes of producing a null-phase dampable-forcing torque and producing said thrust-phase damping forcing torque on said first or third axis, wherein said null-phase dampable-forcing torque can cause a rotation in either direction of said first-axis torquing system and said at least one precessable mass, wherein said thrust-phase damping forcing torque immobilizes or reverses the rotation of said first-axis torquing system, and wherein said first-axis torquing system comprises at least one of a first-axis motive torquer or a first-axis resistive torquer. Similarly, the third-axis torquing system has a dual function of both producing a thrust-phase dampable-forcing torque and a said null-phase damping forcing torque on said third axis, wherein said thrust-phase dampable-forcing torque initiates a second precessional torque by displacing said at least one precessable mass, and wherein said null-phase damping forcing torque damps said first precessional torque. (The third axis, depending on the method used, can be either the pitch axis or the roll axis.) In this disclosure it will be shown how the above three features can be applied to at least six different mechanical embodiments 100. (See FIG. 7 for a listing of representative mechanical embodiments.) I will describe an integrated architecture 300 that will demonstrate how to apply multiple methodological embodiments of strategic damping 200 within the context of these six representatives mechanical embodiments 100. However, these six embodiments are examples of how to associate at least one precessable mass with a first-axis torquing system and a third-axis torquing system wherein said these six embodiments are not intended to limit the scope and application of either mechanical or methodological embodiments.

This invention is the disclosure of discoveries that can be leveraged to achieve inertial thrust when properly integrated with the correct mechanical device along with an appropriate operational method. (I will explain several discoveries but others will be described during the course of this disclosure.) Of major significance is that I discovered that a modification of inertial reaction can be achieved when the precessional torque of a precessable mass is properly damped or redirected during either the initial onset of precession and/or during the entire null phase 211. The concept of the hurrying 262 or delaying 261 of precession is not new. What is novel is that this hurrying or delaying of precession can be used to redirect the torque axis of precessional torque of a given precessable mass both when the precessable mass is being displaced on a first axis but is stationary on a third axis as well as when the precessable mass is being displaced on both the first and third axes in such a way that there is a diminished level of inertia in the direction of the curved trajectory of said precessable mass. Numerous such methods of redirecting precession are discussed during this disclosure. Said redirecting and damping of torque can be done during Phase One (i.e., null phase, 211) but can also be used in Phase Two (i.e., thrust phase, 212).

An additional feature of this disclosure is that the thrust of Phase Two is enhanced when the equipment is configured to accelerate the pendulous gimbals 29 along with the attached rotors 14 (i.e., precessable mass). This is in contradistinction to Phase One where constant speed and no acceleration is desirable.

Another feature of this disclosure is that thrust can be improved upon (i.e., enhanced) during Phase Two (i.e., thrust phase) by immobilizing or reversing the rotation of the central shaft 28 & 36. This impedance or reversal of the rotation of the first-axis motive torquer (e.g., central shaft 28 & 36) redirects precessional torque and enhances the return of the precessable mass 14 to the configuration of Phase One.

I will now describe several advantages of this inertial-thrust engine. As has already been mentioned, one of the critical shortfalls of prior art attempting to achieve inertial thrust by exploiting torque-induced precession is the lack of damping 200 capable of providing a hurrying 262 or delaying 261 torque on said torque-induced precession. Contrary to the assertions of prior art, a precessing rotor 14 will cause a reverse-thrusting motion (i.e., an opposite reaction) to an inertial thruster as a whole the instant that the spinning rotor 14 is first affected by precessional movement. This initial rearward reverse-thrusting motion needs to be damped and thereby redirected by one of two techniques: hurrying of precession 262 or delaying of precession 261. Said techniques reduce or eliminate the initial rearward reaction caused by the precessional movement by redirecting the precession in an orthogonal direction. Operational methods use damping methods 200 wherein the damping forcing torque caused by third-axis motive torquer (e.g., an actuator such as a pneumatic cylinder 11) of the third-axis torquing system is combined with the activation of a first-axis torquing system (e.g., braking and/or a reversal of the rotation of the central motor 1 & 26) so as to provide the desired redirecting of the original torque-induced precession. Said techniques redirect the original precession and thereby reduce or eliminate the reaction to the movement of the precessable masses during said null phase. A torquing system is a means for conveying and controlling rotational energy on a first-axis. A motive torquer is means for generating motive torque. A resistive torquer is a means for generating resistive torque. NOTE: Similar techniques can be used to enhance or increase the reaction to the movement of the precessable masses during said thrust phase.

Other areas of improvement are as follows. One such area is the acceleration of the precessable mass 14 while in the thrust phase 212. The null phase 211 of an inertial thruster 100 ideally should have a steady, constant speed. On the other hand, the thrust phase 212 should be, as much as possible, in a state of constant acceleration. This disclosure exploits the fact that the ratio of angular rate of change between a pendulous gimbal 29 and the central shaft of a torquing system relatively increases when moved in one direction and relatively decreases when moving in the other. An illustration of this concept is the scissor jack that we use on our cars in the event of a flat tire. When the jack is fully extended and the vehicle is at its maximum distance from the ground you notice that it takes several rotations of the central screw to make a minimal difference on lowering the car. In contrast, when the car is halfway down, then an application of several rotations of the jack handle noticeably drops the elevation of the vehicle. Thus, in one direction the rotation-to-elevation ratio increases (accelerates) and in the other direction it decelerates. By applying this concept to this disclosure, the most advantageous direction of movement is diametrically opposed to the direction of prior art (a 180-degree change). More particularly, in the Pivot 151 and Flex 152 embodiments (FIGS. 1A through 2C), the varying wedge (or triangular) shape created by the push-pull rod 30, and the pendulous gimbals 29 makes for a more rapid acceleration in one direction, when the air valve 27 is in the open or “out” position, as compared to the other direction (when the air valve is in the closed or “in” position). The same is true for the Spring MUTINT embodiment 153 (FIG. 3A), the varying wedge shape created by the central shaft 28 & 36 of a given motive torquer, and the pendulous gimbals 29 makes for a more rapid acceleration in one direction as compared to the other direction. This difference of accelerational rates enhances inertial-thrust during the thrust phase.

Another novel area of change is the forced cessation (or reversal) of the shaft's rotation during the thrust phase 212. If precessional movement is allowed to continue undamped during the thrust phase, these undamped precessional movements can negatively affect the accelerational rate of the pendulous gimbals 29 during the thrust phase and can thereby detract from the amount of thrust achieved during said thrust phase 212. It is preferable that the precessable mass not be allowed to precess during said thrust phase. In FIGS. 1A through 3C, precession is negated when the central shaft 28 & 36 of the roll-axis torquing system is not allowed to rotate, but is either braked or reversed during the thrust phase 212. Crabtree makes a supporting observation: “(If) the top begins to lean over, the gravity-couple about the edge of support causes it to precess; and if the precession is hindered by a rough surface, the top falls down” (p. 139). Referring to FIG. 7A, he similarly states that if the screw controlling axis “Z” is tightened (to stop precessional movement) that the spinning rotor will at once turn over about axis Y′Y (p. 10). This, of course, is also an application of the retarding (delaying) of precession 261 wherein the spinning wheel “turns over” because the precessional movement has been resisted (by tightening the screw “z”) and thereby aligning the torque axis of the redirected precessional torque with the direction of the original torque (i.e., gravity functioning a dampable-forcing torque). (This is depicted in FIG. 7C.) However, this alignment of precession with the original torque during the thrust phase 212 does NOT decrease inertia in the direction of movement and for this reason this technique is used to maximize or enhance thrust during the thrust phase 212.

Another significant application in this disclosure is the correct use of shock absorbers 12 that absorb the impact of each pendulous gimbal 29 at the end of the thrust phase. It is helpful to absorb the impact of unwanted momentum at the end of the thrust phase 212. The impact of pendulous gimbals 29 (or any moving part) against the device can create undesirable rearward movement of the entire inertial-thruster engine. The shock absorber's 12 primary function is to reduce, diffuse, and/or absorb the impact of the pendulous gimbals 29 (or any moving part) caused the instant that a given pendulous gimbal 29 reaches the end of its travel.

A novel feature that is specific to the Flex MUTINT is the bendable (flexible) characteristic of the flexible pendulous gimbals 35. Said flexible quality provides for both a smoother operation as well a simpler, lighter design. The stiffness of given flexible pendulous gimbals can be altered by changing materials or modifying the thickness or width of said flexible pendulous gimbals. Changes in stiffness are especially important for the overlap methods such as Method II 282 (Pivot-Flex Overlapping Method) where a lessening of stiffness of the flexible pendulous gimbals will increase the overlap time between both phases.

Another feature that is specific to the Spring MUTINT engine 153 (FIG. 3A) is the use of tension springs 40 as an example of a type of pitch-axis motive torquer. Said springs 40, by either a pulling or pushing action, accelerate the pendulous gimbals 29 as they move from the contracted configuration to the extended configuration. The tension spring 40 (in combination with pitch-axis resistive torquer such as a locking mechanism 38) could replace the pneumatic cylinder 11 and the three-way air valve 27 as the primary pitch-axis torquing system in other embodiments.

An additional feature is the use of a plurality of inertial thrusters on a single platform. Given that a single unit's motion tends to be intermittent, it is recommended that multiple units be interconnected on the same platform 16 so as to smooth out intermittent movement thereby creating continuous rectilinear or rotary unidirectional motion, wherein the phases of operation are carried out within two or more interconnected engines on a platform, and wherein said null phase and said thrust phase occur simultaneously or overlap so as to smooth out intermittent movement, thereby creating a generally continuous unidirectional motion of said platform.

Previous art does not disclose a credible design for a rotary inertial thruster. This disclosure describes three such devices: The Radius MUTINT 154 & 157, the Tangent MUTINT 155 and the Tilt MUTINT 156. A rotary device improves the overall smoothness and efficiency of operation besides broadening the base for the types of methods that can be used. Other improvements over prior art in this invention include design simplification and critical weight reduction that accommodates the above modifications.

### BRIEF DESCRIPTION OF THE DRAWINGS

NOTE: Non-limiting and non-exhaustive depictions, charts, and prior art for the present embodiments are described with reference to the following FIGURES (FIG.). The drawings featured in the figures are for the purpose of illustrating certain convenient mechanical or methodological embodiments of the present invention and are not to be considered as limitation thereto. Corresponding reference characters indicate corresponding components throughout the several views of the drawings. Persons of skill in the art will appreciate that elements in the figures are illustrated for simplicity and clarity and have not necessarily been drawn to scale. Also, common but well-understood elements that are useful or necessary in a feasible embodiment are often not depicted in order to facilitate a less obstructed view of these various embodiments. Dot dash lines in certain figures is indicative of a feature or device that is either optional or is not central to the operation of that embodiment.

FIG. 1A displays a simplified schematic side view of the Pivot MUTINT engine 151 in accordance with one or more illustrative embodiments of the present invention with the pivot pendulous gimbals 29 in the contracted configuration (also referred to as a Phase-One configuration). Said contracted configuration is an example of the range of motion of a given embodiment but it is not intended to limit the full range of pitch-axis motion that is exploitable for a given mechanical embodiment. Said full range of pitch-axis motion is up to 180 degrees for an oscillatory embodiment.

FIG. 1B displays a simplified schematic side view of the Pivot MUTINT engine 151 in accordance with one or more illustrative embodiments of the present invention with the pivot pendulous gimbals 29 in a Phase-Two configuration.

FIG. 1C displays a simplified schematic top view of the Pivot MUTINT engine 151 in accordance with one or more illustrative embodiments of the present invention with the pivot pendulous gimbals 29 in a Phase-Two configuration.

FIG. 2A displays a simplified schematic side view of the Flex MUTINT engine 152 in accordance with one or more illustrative embodiments of the present invention with the flexible pendulous gimbals 35 in a Phase-One configuration. Said Phase-One configuration is an example of the range of motion of a given embodiment but it is not intended to limit the full range of pitch-axis motion that is exploitable for a given mechanical embodiment. Said full range of pitch-axis motion is up to 180 degrees for an oscillatory embodiment.

FIG. 2B displays a simplified schematic side view of the Flex MUTINT engine 152 in accordance with one or more illustrative embodiments of the present invention with the flexible pendulous gimbals 35 in the Phase-Two configuration.

FIG. 2C displays a simplified schematic top view of the Flex MUTINT engine 152 in accordance with one or more illustrative embodiments of the present invention with the flexible pendulous gimbals 35 in the Phase-Two configuration.

FIG. 3A displays a simplified schematic side view of the Spring MUTINT engine 153 in accordance with one or more illustrative embodiments of the present invention with the pivot pendulous gimbals 29 in a Phase-Two configuration. Said Phase-Two configuration is an example of the range of motion of a given embodiment but it is not intended to limit the full range of pitch-axis motion that is exploitable for a given mechanical embodiment. Said full range of pitch-axis motion is up to 180 degrees for an oscillatory embodiment.

FIG. 3B displays a simplified schematic top view of the Spring MUTINT engine 153 in accordance with one or more illustrative embodiments of the present invention with the pivot pendulous gimbals 29 in a Phase-Two configuration.

FIG. 3C displays a simplified schematic side view of the Spring MUTINT engine 153 in accordance with one or more illustrative embodiments of the present invention with the pivot pendulous gimbals 29 in the Phase-One configuration.

FIG. 4A displays a simplified schematic side view of the Radius MUTINT engine 154 in accordance with one or more illustrative embodiments of the present invention with the rotors 14 in illustrative positions.

FIG. 4B displays a simplified schematic front view of the Radius MUTINT engine 154 in accordance with one or more illustrative embodiments of the present invention with the rotors 14 in illustrative positions.

FIG. 4C displays a simplified schematic side view of a modified Radius MUTINT engine 157 in accordance with one or more illustrative embodiments of the present invention with the rotors 14 in illustrative positions.

FIG. 4D displays a simplified schematic side view of a twin-rotor Radius MUTINT engine 158 in accordance with one or more illustrative embodiments of the present invention with the rotors 14 in illustrative positions.

FIG. 5A displays a simplified schematic side view of the Tangent MUTINT engine 155 in accordance with one or more illustrative embodiments of the present invention with the rotors 14 in illustrative positions.

FIG. 5B displays a simplified schematic front view of the Tangent MUTINT engine 155 in accordance with one or more illustrative embodiments of the present invention with the rotors 14 in illustrative positions.

FIG. 5C displays a simplified schematic side view of a modified Tangent MUTINT engine 159 in accordance with one or more illustrative embodiments of the present invention with the rotor 14 in an illustrative position.

FIG. 6A displays a simplified schematic side view of the Tilt MUTINT engine 156 in accordance with one or more illustrative embodiments of the present invention with the rotors 14 in illustrative positions.

FIG. 6B displays a simplified schematic front view of the Tangent MUTINT engine 156 in accordance with one or more illustrative embodiments of the present invention with the rotors 14 in illustrative positions.

FIG. 7A is a depiction of a gyroscope from prior art that is being subjected to a downwards torque and thereby inducing precessional torque.

FIG. 7B is a depiction of a gyroscope from prior art with a precession that has been redirected by the hurrying 262 of the precessional torque.

FIG. 7C is a depiction of a gyroscope from prior art with precessional torque that has been redirected by the delaying 261 of said precessional torque.

FIG. 7D is an example of an illustrative mathematical formula, from prior art, depicting one of the methods used to calculate gyroscopic precession.

FIG. 8 is a chart depicting the inter-relationship of various illustrative Mechanical Embodiments of the Inertial-Thrust Architecture 100 in accordance with one or more illustrative embodiments of the present invention.

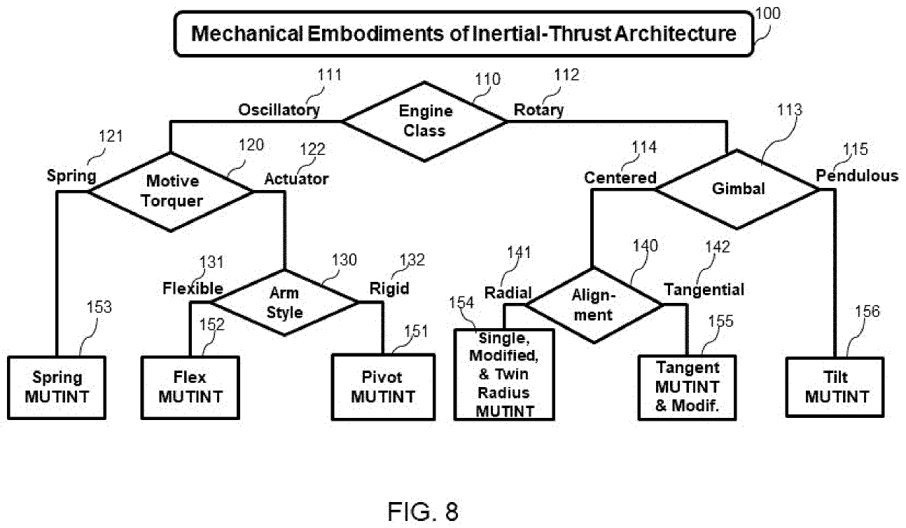

FIG. 9 is a chart depicting lists of examples of various Strategic Damping Methods and their inter-relationship with Methodological Embodiments of the Inertial-Thrust Architecture 200 in accordance with one or more illustrative embodiments of the present invention. Said lists of examples are illustrative of the methods that can be used with each mechanical embodiment but is not intended to be comprehensive since methods from one or more mechanical embodiment can be adapted and/or combined to function with another embodiment.

### DETAILED DESCRIPTION OF THE INVENTION

While this invention is susceptible to embodiments in many different forms, there is shown in the drawings and will herein be described in detail specific mechanical and methodological embodiments, with the understanding that the present disclosure of such embodiments is be considered as an example of the principles and is not intended to limit the invention to the specific embodiments shown and described. In the description below, like reference numerals are used to describe the same, similar or corresponding parts in several views of the drawings. Furthermore, there is no intention to be bound by any expressed or implied theory presented in the preceding technical field, background, brief summary or the following detailed description. This description describes embodiments in order for persons of skill in the art to practice the invention. The glossary (in the end portion of this specification section) defines the meaning of many of the terms used herein.

By way of overview, each of the mechanical embodiments (i.e., MUTINTs) comprise three devices and/or functions: a first-axis torquing system, at least one precessable mass associated with said first-axis torquing system, and a third-axis torquing system wherein said third-axis torquing system is associated with said first-axis torquing system and said at least one precessable mass.

It is important to take into consideration that the supported axis of a given torquing system (first axis or third axis) will change from method to method. Said first-axis torquing system, depending on the method used, can be either the pitch-axis torquing system or the roll-axis torquing system. The same is true for the third axis. Said third-axis torquing system, depending on the method used, can be either the pitch-axis torquing system or the roll-axis torquing system.

Said first-axis torquing system is configured to cause a forcing torque on a first axis in a forward or reverse direction. Said first-axis torquing system comprises a first-axis motive torquer and a first-axis resistive torquer, wherein said first-axis motive torquer causes, as needed, a forward or a reverse angular movement of said precessable mass on said first axis, and wherein said first-axis resistive torquer causes, as needed, a first-axis resisting of angular movement of said precessable mass on said first axis. Said first-axis motive torquer and said first-axis resistive torquer can either be a single device that accomplishes both functions of causing a first-axis motive torque and causing a first-axis resistive torque or both functions can be accomplished by two or more devices that are either collocated on the engine or located on different locations of the engine. Said first-axis torquing system has the function of causing a first-axis torque wherein said first-axis torque can resist a first-axis movement and can also induce a first-axis movement of said at least one precessable mass in either a substantially perpendicular direction relative to said first axis when precession is being induced or in a substantially parallel direction relative to said first axis when precession is not being induced. (See submethods A, B, C, and D.)

Said at least one precessable mass is either directly or indirectly pendulous, and is configured to have a precession-related motion on a second axis (e.g., spin axis) in a forward or reverse direction. The precessable mass becomes pendulous by at least one of two ways. First the precessable mass can take on pendulum-like characteristics directly by means of a pendulous gimbal 29 such as the rigid connecting arm of the Pivot MUTINT, the rigid connecting arm of the Spring MUTINT, the flexible connecting arm of the Flex MUTINT, or the connecting arm of the Tilt MUTINT. A second way that a given precessable mass can take on pendulum-like characteristics is by means of a pendulous subframe 52. Said pendulous subframe is indirectly connected to or associated with a centered frame gimbal 55 that allows for the precessable mass to pivot in place without being displaced. Each precessable mass needs to have the capability of both being displaced on a curved trajectory and the capability of angular rotation. A given pendulous gimbal 29 and a given pendulous subframe both provide the capability of not only rotating but also displacing a precessable mass on a curved trajectory. Thus, each precessable mass is pendulously associated, either directly or indirectly, to said first-axis torquing system and each precessable mass is pendulously associated, either directly or indirectly, to said third-axis torquing system.

A given precessable mass must have precession-related motion to induce precession when said precessable mass is rotated or displaced on a curved trajectory. Precession-related motion comprises spinning, vibration, elliptical movement, and erratic movement. An erratic movement is any movement that can cause precession but is not classed as spinning, vibration, or elliptical movement. Said curved trajectory can be caused by either a first-axis movement or by a third-axis movement. Said first-axis movement is a first-axis displacement that causes said curved trajectory of said at least one precessable mass. Said third-axis movement is a third-axis displacement that causes said curved trajectory of said at least one precessable mass.

Said third-axis torquing system is configured to cause a forcing torque on a third axis in a forward or a reverse direction, wherein upon an angular movement of said at least one precessable mass on either said first axis or on said third axis, and upon having a precession-related motion of said at least one precessable mass on said second axis, a precessional torque is induced on either said first axis or said third axis, wherein said first-axis torquing system and said third-axis torquing system are able to simultaneously cause a redirection of said precessional torque. (Said precessional torque is referred to as a first precessional torque if it is the primary precessional torque of the null phase. Said precessional torque is referred to as a second precessional torque if it is the primary precessional torque of the thrust phase.) The third axis torquing system further comprise a third-axis motive torquer and a third-axis resistive torquer wherein both torquers can either be a single device that accomplishes both functions of a third-axis motive torquer and a third-axis resistive torquer or both functions can be accomplished by two or more devices that are either collocated on the engine or located on different locations of the engine. Said third-axis torquing system can cause a third-axis torque wherein said third-axis torque can resist a third-axis movement and can induce a third-axis movement of said at least one precessable mass in either a substantially perpendicular direction relative to said third axis when precession is being induced or a substantially parallel direction relative to said third axis when precession is not being induced. (See submethods A, B, C, and D.) The redirection of the torque axis of a given precessional torque comprises at least one of a modification of the magnitude of precessional torque without changing direction, a maintaining of the same magnitude of precessional torque in another direction, an increase of the magnitude of precessional torque in another direction, or a decreasing of the magnitude of precessional torque in another direction. Said first precessional torque comprises a force that is either substantially rearward and opposite to the general direction of movement of the engine or substantially forward and in the general direction of movement of the engine.

The first and third axes of an inertial-thruster engine are configured to function both sequentially as well as simultaneously. Said third-axis torquing system can cause a third-axis torque at the same time that said first-axis torquing system causes a first-axis torque, wherein a combination of torques causes a redirection of the torque axis of said precessional torque in either a substantially perpendicular direction or a substantially parallel direction. The redirection of precessional torque on a given torque axis comprises at least one of a modification of the magnitude of precessional torque without changing direction, a maintaining of the same magnitude of precessional torque in another direction, an increase of the magnitude of precessional torque in another direction, or a decreasing of the magnitude of precessional torque in another direction.

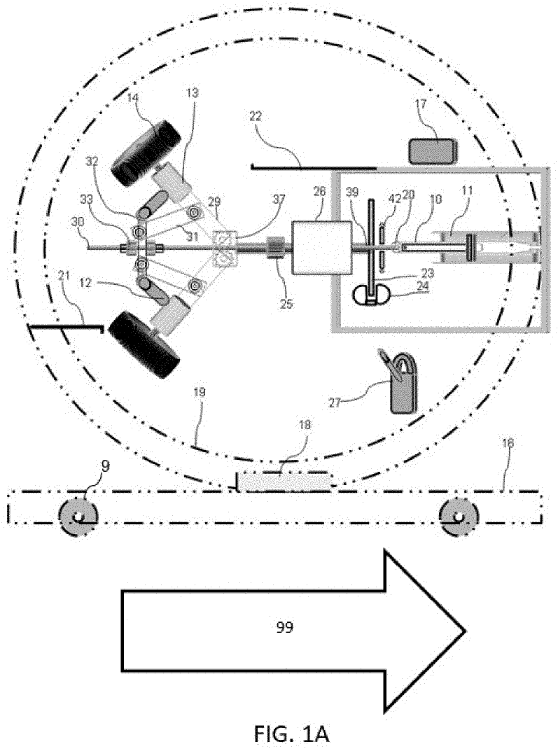

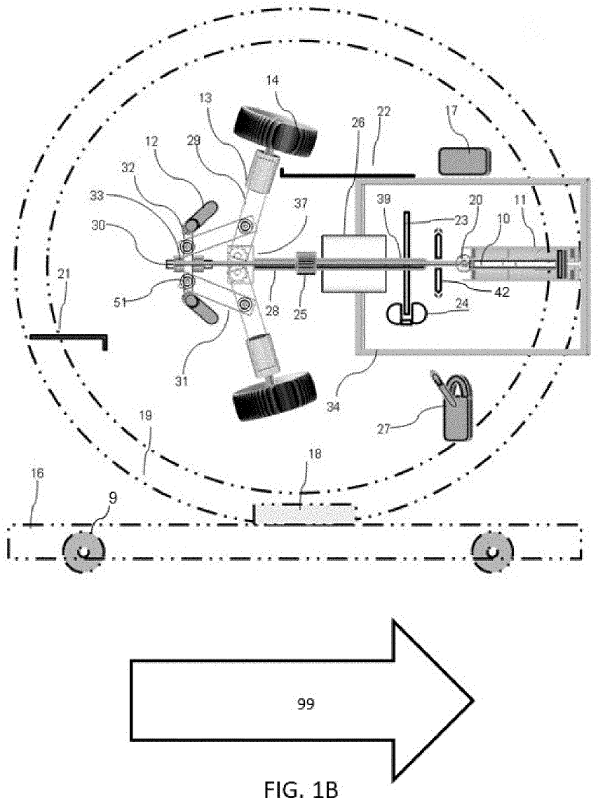

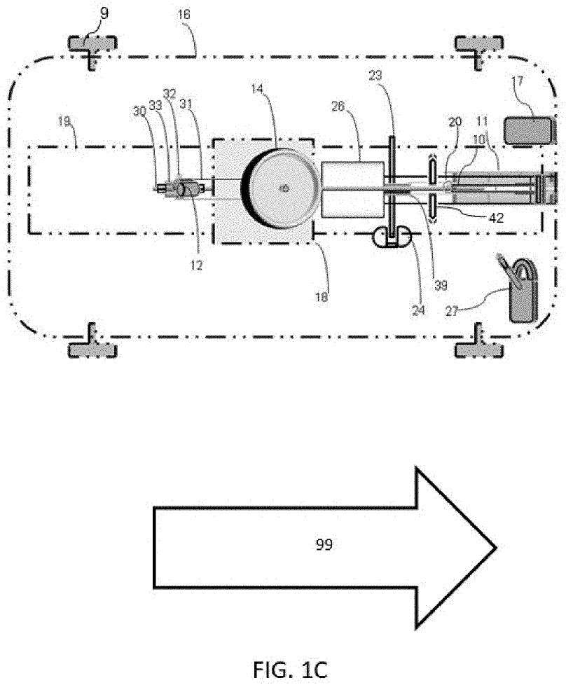

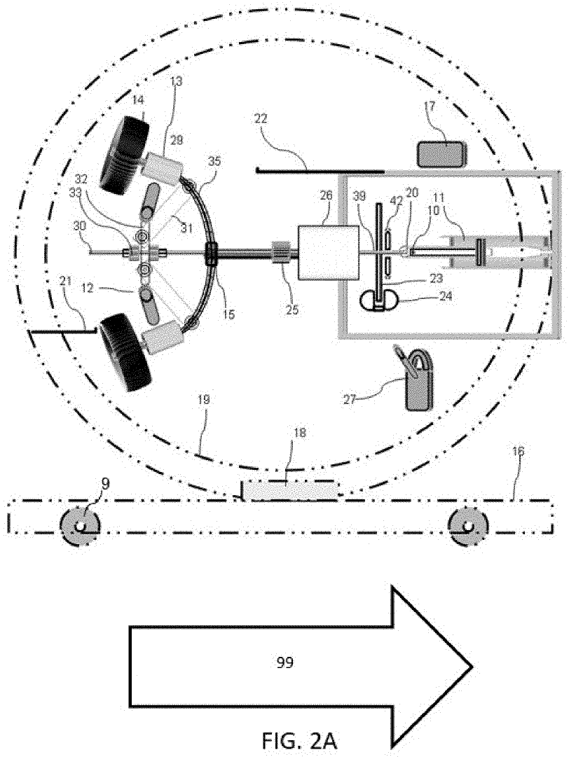

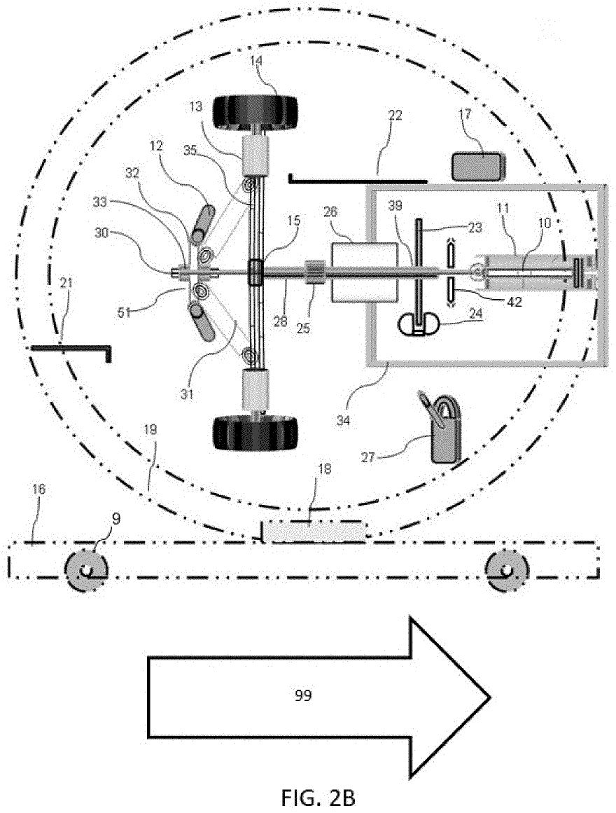

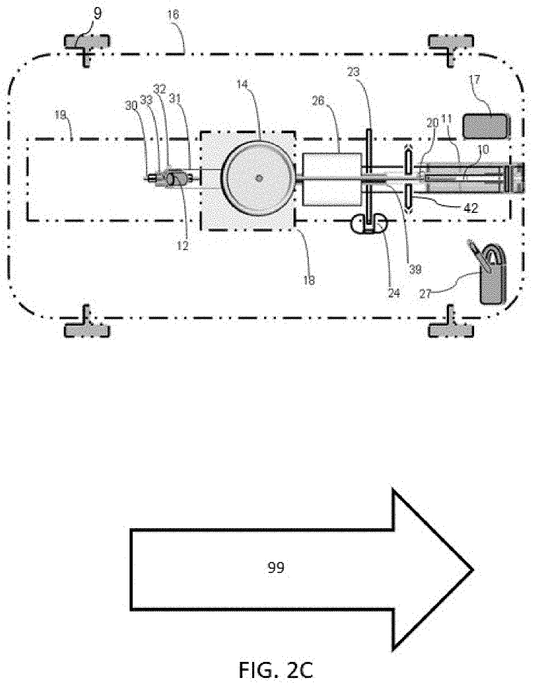

In FIGS. 1A through 2C we have the Pivot MUTINT 151 and the Flex MUTINT 152 embodiments. In said embodiments, a roll-axis motive torquer (e.g., a variable-speed, non-geared, hollow-shaft motor 26) which is part of the roll-axis torquing system wherein said roll-axis motive torquer is mounted onto a rotatable frame 19. Said variable-speed motor 1 will be referred to as “central motor.” The central motor 26 is mounted onto the rotatable frame 19 by means of a motor-support frame 34. Said rotatable frame 19 is termed “optional” since the focus of this invention is to create an inertial-thruster engine that can be attached to a larger device such as an inertial propulsion vehicle or to a free-body platform such as a satellite in a limited gravity environment.

NOTE: The “non-geared” trait of this central motor 26 allows the motor to continue spinning or “wind milling” even after power has been removed. The term “wind milling” is being used to signify the rotation of the shaft due to both gyroscopic precession and to the continued “glide” or coasting of angular velocity due to residual momentum even after the causational factor of the precessional torque has ceased. (Certain of the methods, especially those of the active damping category, are benefited by the wind-milling or coasting trait that can be better exploited by use of a non-geared motor.) The rotatable frame 19 can be mounted to a mobile platform (16; also, optional) by means of a clamp 18. Said rotatable frame 19 allows the operator to “point” the MUTINT engine and create thrust in any direction (vertically, horizontally, or diagonally).

A roll-axis resistive torquer (e.g., brake disk 23 and brake calipers 24) is part of the roll-axis torquing system. Said roll-axis resistive torquer is attached to the motor shaft 39 of the central motor 26 or on the central shaft 28 wherein said central motor 26 or on the central shaft 28 are elements of the roll-axis motive torquer. If the engine shaft 39 does not extend out sufficiently then said shaft 39 can be connected to a hollow central shaft 28 by use of a shaft connector 25. One end of the pendulous gimbal 29 is attached or associated to the shaft 28 in such a way that the pendulous gimbal 29 can pivot between the gear plates (37, as seen in the Pivot MUTINT embodiment 151) or in such a way that the flexible pendulous gimbal 35 can bend freely. Said pendulous gimbals are firmly attached or associated to a rotational element(s) of the roll-axis motive torquer such as said hollow central shaft 28. This connecting or associating of said rotational element can be done by using gear plates (37, in the Pivot MUTINT embodiment 151) or a shaft bracket (15, in the Flex MUTINT embodiment 152). The other end of a given pendulous gimbal 29 & 35 is associated with or attached to the rotor motor 13. In order to ensure that the pendulous gimbals 29 & 35 contract and extend uniformly, it is recommended that synchronization gears 37 be attached. (e.g., Pivot MUTINT 151 embodiment) on the end of the pendulous gimbals 29 that are in closest proximity to the shaft 28. In said Pivot MUTINT embodiment 151, the gears will mesh with each other on the shaft-end of the pendulous gimbals 29 in such a way that both pendulous gimbals 29 oscillate (move back and forth or rise and fall) in a substantially uniform rhythm.

On the Flex MUTINT embodiment 152, the synchronization links 31 will assist in obtaining uniform movement. Passing through the middle of the roll-axis torquing system (e.g., hollow central-motor shaft 39 and the hollow central shaft 28) is the adjustable push-pull rod 30. On one end of said rod 30 is a bar collar 32 that is retained by a push-pull-rod bearing 33 on either side of said collar 32. Said bearings 33 will allow the push-pull rod 30 to remain stationary while the bar collar 32 and all that is attached to it orbit around it. Connected diagonally between each pendulous gimbal 29 & 35 and each bar of the bar collar 32 is a synchronization link 31. Attached to each end of the bar collar 32 is a shock absorber 12. NOTE: Said shock absorber 12 can be placed in any appropriate location so long as it meets the criteria of being in a position to absorb the shock (impact, momentum) of the rotor motors 13 and rotors 14 as they finish their range of travel at the end of a given phase, especially the thrust phase. Placed between the end of the push-pull rod 30 and the motor-support frame 34 is a pitch-axis torquing system. Said pitch-axis torquing system comprises the functions and or elements of a pitch-axis motive torquer and a pitch-axis resistive torquer. Certain devices such as a pneumatic actuator can fulfill the functions of both a pitch-axis motive torquer and a pitch-axis resistive torquer. An example of an actuator is a variable-acceleration, double-acting, duplex pneumatic cylinder 11 (hereafter called “pneumatic cylinder”). Said cylinder 11 is part of the pitch-axis torquing system and, as such, provides tension, pressure, and/or torque to assist the pendulous gimbals 29 & 35 to extend or contract when said cylinder 11 is activated. The piston rod 10 that reciprocates within the cylinder 11 is connected to the push-pull rod 30 by means of a swivel connector 20. Should the MUTINT engine be automated, sensors 21 & 22 can be used. These contraction 21 and extension 22 sensors are multiple and adjustable and can be placed in any location deemed helpful to provide feedback on movement status and rate. Said sensors 21 & 22 assist by sending signals to any or all portions of the roll-axis and pitch axis torquing systems (e.g., motors, air valves, and brakes) to signal when and to what degree they should be activated or deactivated.

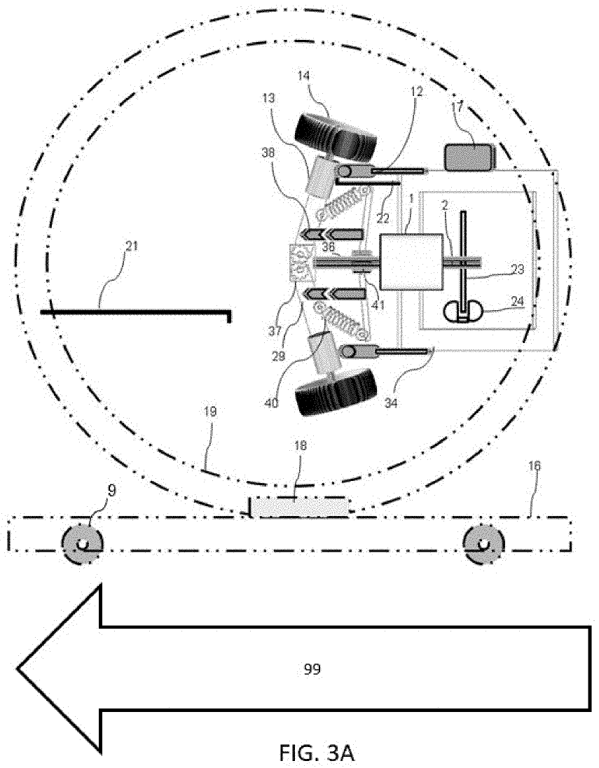

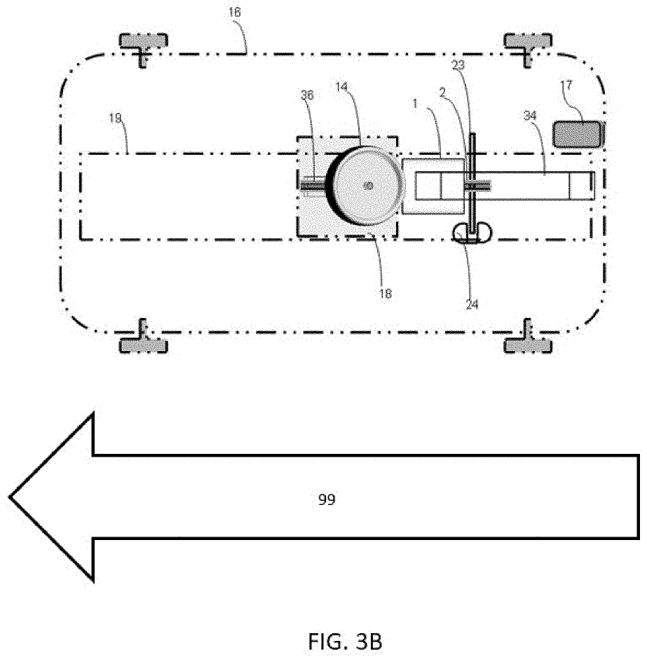

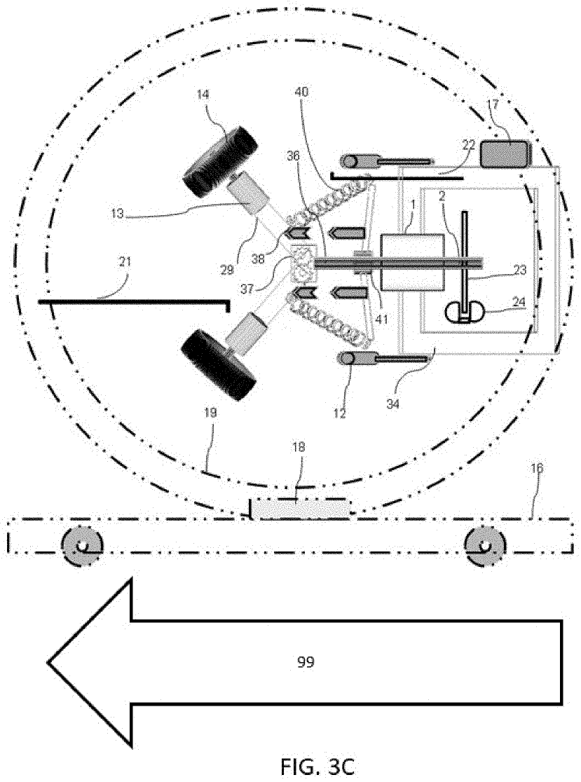

In FIG. 3A we have the Spring-MUTINT 153 embodiment. The roll-axis motive torquer (e.g., central motor 1) of the Spring MUTINT is mounted onto an optional rotatable frame 19 by means of a motor-support frame 34. The rotatable frame 19 can be mounted to an optional mobile platform 16 by means of a clamp 18. A Roll-axis resistive torquer (e.g., brake disk 23 and brake calipers 24) is are attached to the shaft 2 of the roll-axis motive torquer (e.g., central motor 1). The roll-axis resistive torquer (e.g., brake calipers 24) can be activated manually or automatically in conjunction with the switching off of the central motor 1. The central-motor shaft 2 of the roll-axis motive torquer (e.g., central motor 1) is connected to a solid central shaft 36 by use of the shaft-connector-extension bars 41. One end of the pendulous gimbal 29 is attached to a rotational element (e.g., the solid central shaft 36) of the roll-axis motive torquer in such a way that said pendulous gimbal can hinge between the plates on the gear-plate assembly 37 that are firmly attached to a rotational element of the roll-axis motive torquer (e.g., the solid central shaft 36). The other end of said pendulous gimbal 29 is attached to a rotor motor 13 and precessable mass 14 unit. Stretched between each protruding bar of the shaft connector 41 and each rotor motor 13 (or on any suitable location on the pendulous gimbal) is a tension spring 40 which is one of the devices that can fulfill the function of a pitch-axis motive torquer. (A “bar” in this context refers to a rod-like extension that protrudes from the shaft connector.) Said bar will serve to retain the tension spring. Should automation be used, then the contraction 21 and extension 22 sensors should be of an adjustable configuration. Said sensors assist by sending signals to any or all pitch-axis and roll axis motive torquers (e.g., motors) to signal when they should be stopped, slowed, or accelerated. Attached to the motor-support frame 34 (or to any other appropriate location) are shock absorbers 12 with their appropriate brackets. Said shock absorbers 12 should be so mounted so that the pendulous gimbals 29 strike the rotor motor housing (or any other suitable place on the pendulous gimbal 29) when the pendulous gimbals 29 reach the end of their travel. Said travel is especially relevant to the thrust phase.

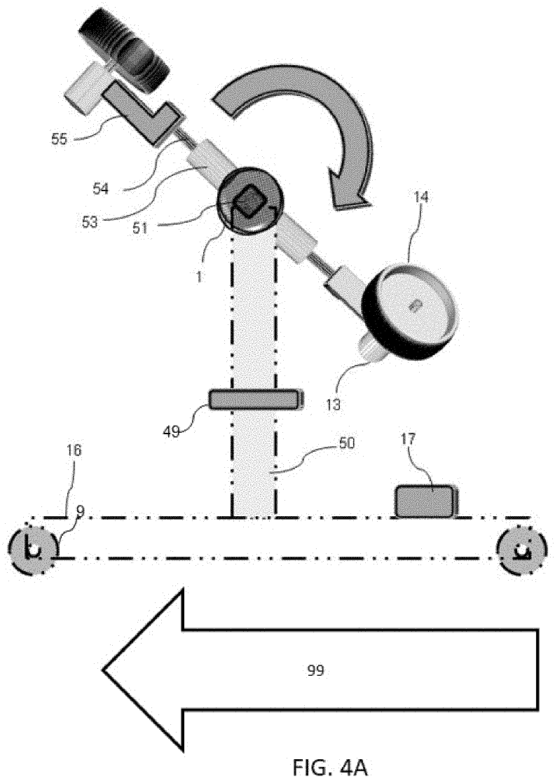

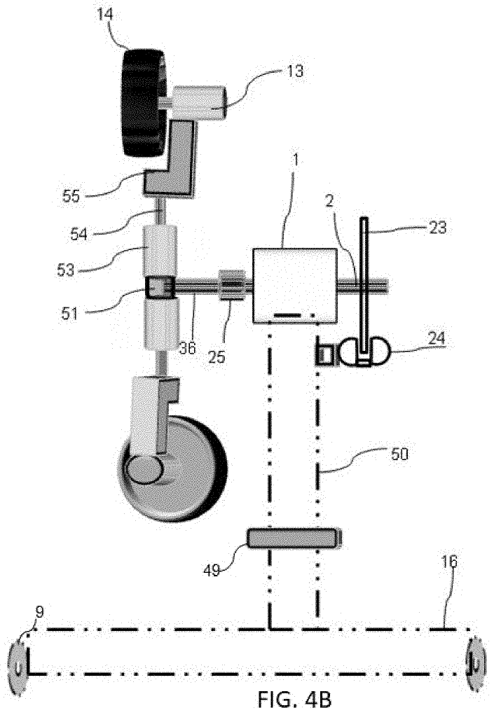

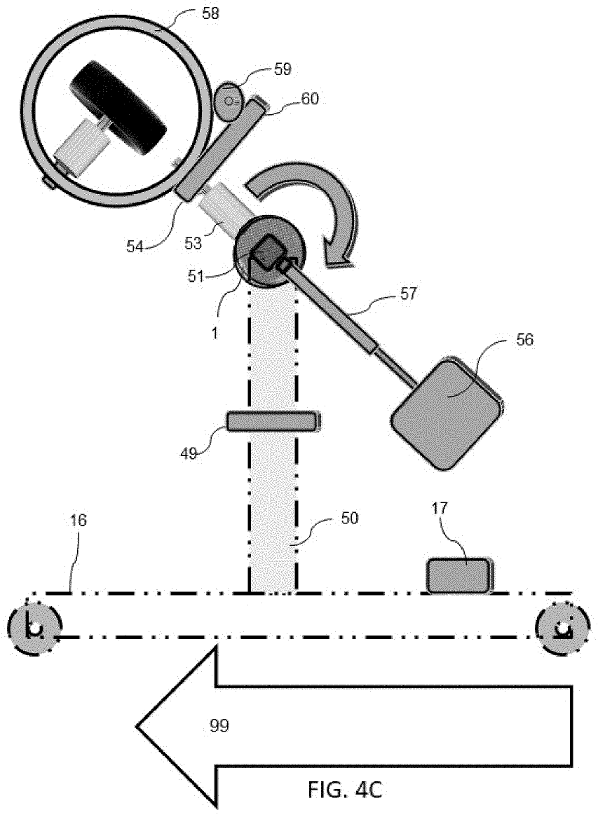

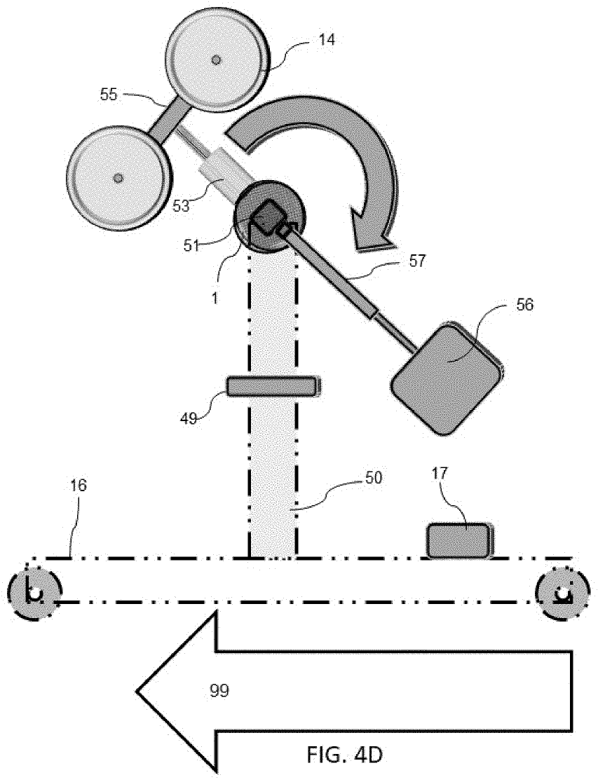

In FIGS. 4A and 4B we have the Radius-MUTINT embodiment 154. The roll-axis motive torquer (e.g., central motor 1) of the Radius MUTINT 154 is mounted onto an optional vertical frame 50 wherein said frame has a vertical-frame rotational connecter 49. Said vertical-frame rotational connecter 49 allows for a given rotary embodiment (e.g., Radius, Tangent, Tilt MUTINTs) to change the alignment of the roll-axis motive torquer from perpendicular to the general direction of movement to parallel to the general direction of movement (and any interim position.) Said vertical frame 50 can be mounted onto an optional mobile platform 16. A roll-axis resistive torquer (e.g., a brake disk 23 and brake calipers 24) is attached to the shaft 2 of the roll-axis motive torquer (e.g., central motor 1). The central-motor shaft 2 of the central motor 1 is connected to a solid central shaft 36 by use of a shaft connector 25. The central-shaft mounting brackets 51 are secured to the central shaft 36. The pitch-axis torquing system (e.g., gimbal step motors 53) are attached to the mounting brackets 51. The step motor shaft 54 is secured to the portion of the gimbal 55 that is closest to the central shaft 36 of the roll-axis torquing system. The rotor motor 13 with its rotor 14 is attached to the end of the gimbal 55 that is furthest from the roll-axis motive torquer. Where desired, an automation unit 17 will guide the smooth functioning of the radius MUTINT embodiment 154.

FIG. 4C is substantially the same as FIG. 4A except for the counter balance 56 and the motorized-rotation gimbal 58. The counterbalance is useful because it allows for the rotor 14 that it counterbalances to change its orbital velocity on the roll axis from the null phase to the thrust phase. (With multiple rotors on opposite sides from each other, the roll-axis motive torquer is mostly restricted to one rotational speed but with only one rotor there can be varying levels of acceleration on the roll axis.) The motorized-rotation gimbal 58 allows for changing the angle of incidence of the rotor relative to its roll-axis trajectory and its pitch-axis rotation. Said changing the angle of incidence affects the amount of precessional torque that can be induced on the precessable mass 14 as well as to how a given submethod is used with the angle of incidence. Said motorized-rotation gimbal 58 is powered by a motorized-rotation gimbal motor 59. Said motorized-rotation gimbal motor 59 is preferably a step motor wherein said gimbal motor rotates said gimbal about a 360-degree axis and said gimbal motor is mounted onto a motorized-rotation gimbal motor bracket 60.

FIG. 4D is substantially the same as FIG. 4A except for the counter balance 56 and the addition of a second precessable mass. The Said second precessable mass allows for a greater amount of torque on the pitch axis and thereby greatly increasing the leverage of the precessional torque induced by a given pitch-axis rotation.

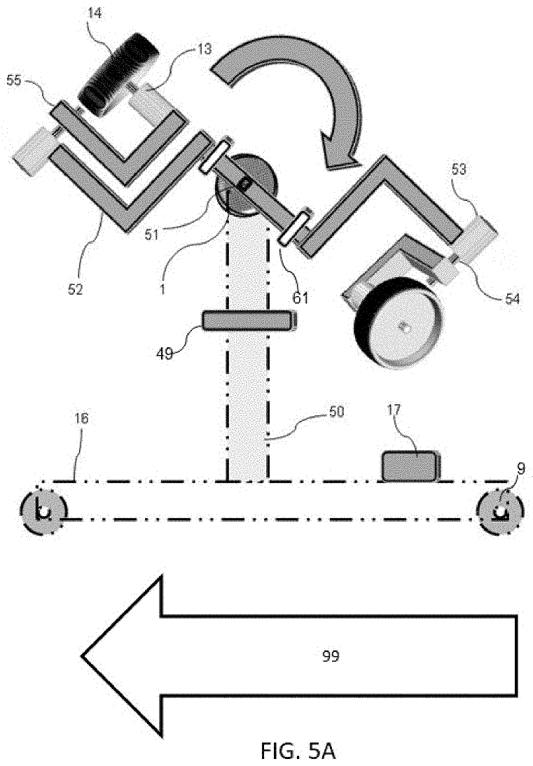

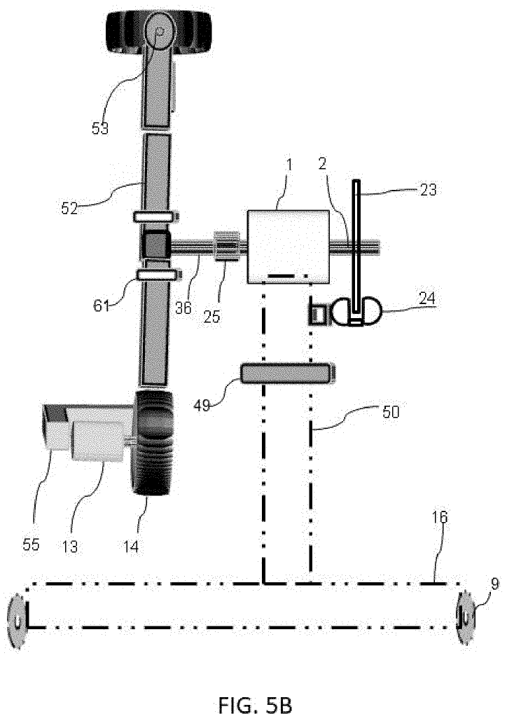

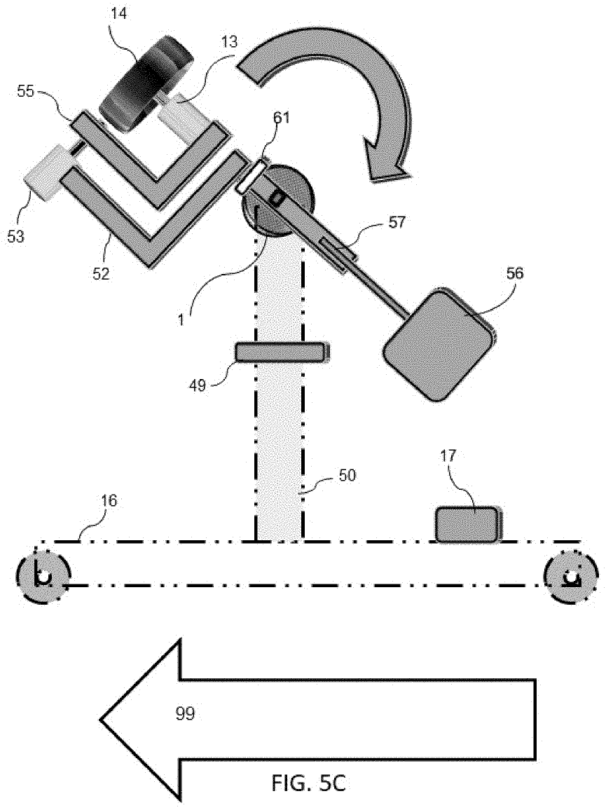

In FIGS. 5A and 5B we have the Tangent-MUTINT embodiment 155. The roll-axis motive torquer (e.g., central motor 1) of the Tangent MUTINT 155 is mounted onto an optional vertical frame 50 wherein said vertical frame is equipped with a vertical-frame rotational connecter 49. Said vertical-frame rotational connecter 49 allows for a given rotary embodiment (e.g., Radius, Tangent, Tilt MUTINTs) to change the alignment of the roll-axis motive torquer from perpendicular to the general direction of movement to parallel to the general direction of movement (and any interim position.) Said vertical frame 50 can be mounted onto an optional mobile platform 16. A roll-axis resistive torquer (e.g., brake disk 23 and brake calipers 24) is attached to the shaft 2 of the central motor 1 of the roll-axis torquing system. The central-motor shaft 2 of the central motor 1 is connected to a solid central shaft 36 by means of a shaft connector 25. The central-shaft mounting bracket 51 is secured to the central shaft 36. The pendulous subframe 52 is centered and attached to said mounting bracket 51 on the shaft 36. The motor end of a given pitch-axis torquing system (e.g., gimbal step motors 53) is attached close to each outer extremity of said pendulous subframe 52. Said step motor's shaft 54 is affixed to its respective gimbal 55 in such a way that the gimbal pivots laterally when the pitch-axis torquing system (e.g., step motor) is activated. The rotor motors 13 with their rotors 14 are mounted to the opposite end of the gimbal 55. As desired, an automation unit 17 will guide the smooth functioning of the Tangent MUTINT embodiment 155. Said pendulous subframe 52 is rotatable by 360 degrees by means of a motorized-rotation gimbal motor 61. Said motorized rotational device allows for the pivoting of said subframe and the attached gimbal by 360 degrees. (Motor is not shown but is understood to be included as part of said device.)

FIG. 5C is a modified Tangent-MUTINT embodiment 159. Said modified Tangent-MUTINT embodiment is substantially the same as FIG. 5A with the exception that it has a counter balance that allows for the precessable mas to have varying accelerations on the roll axis from Phase One relative to Phase Two.

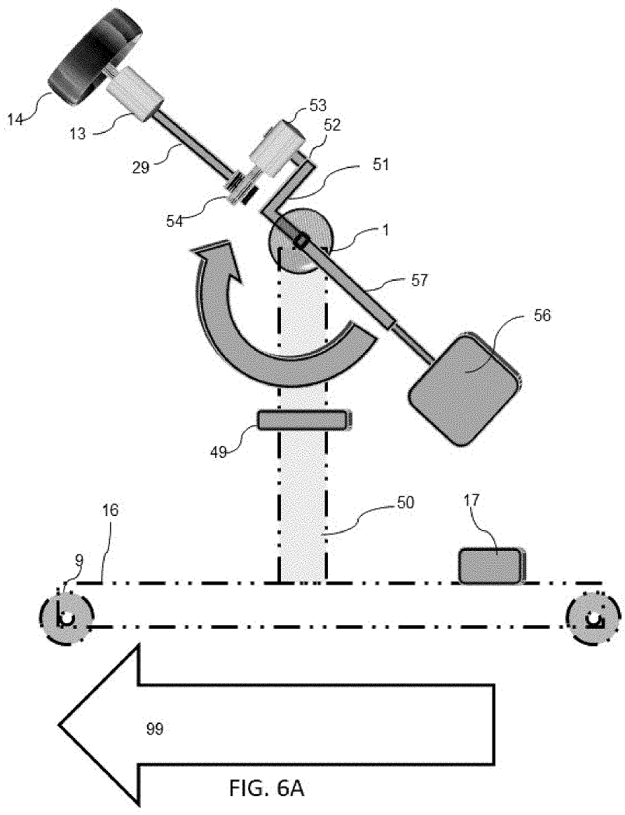

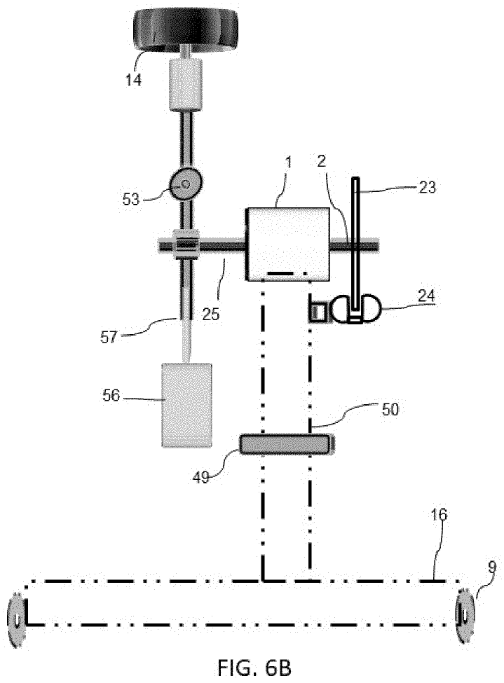

In FIGS. 6A and 6B we have the Tilt-MUTINT embodiment 156. The roll-axis motive torquer (e.g., central motor 1) of the Tilt MUTINT 156 is mounted onto an optional vertical frame 50 wherein said frame has a vertical-frame rotational connecter 49. Said vertical-frame rotational connecter 49 allows for a given rotary embodiment (e.g., Radius, Tangent, Tilt MUTINTs) to change the alignment of the roll-axis motive torquer from perpendicular to the general direction of movement to parallel to the general direction of movement (and any interim position.) Said vertical frame 50 can be mounted onto an optional mobile platform 16. If the roll-axis torquing system consists of separate devices then a roll-axis resistive torquer (e.g., a brake disk 23 and brake calipers 24) is attached to the shaft 2 of the roll-axis motive torquer (e.g., central motor 1). The central-motor shaft 2 of the central motor 1 is connected to a solid central shaft 36 by use of a shaft connector 25. The central-shaft mounting brackets 51 are secured to the central shaft 36 of the roll-axis motive torquer. The pitch-axis torquing system (e.g., gimbal step motor 53) is attached to the roll-axis shaft mounting brackets 51. The step motor shaft 54 is secured to the portion of the gimbal 55 that is closest to the central shaft 36 of the roll-axis torquing system. The rotor motor 13 with its rotor 14 is attached to the end of the pendulous gimbal 29 that is furthest from the roll-axis motive torquer. Where desired, an automation unit 17 will guide the smooth functioning of the radius MUTINT embodiment 154.

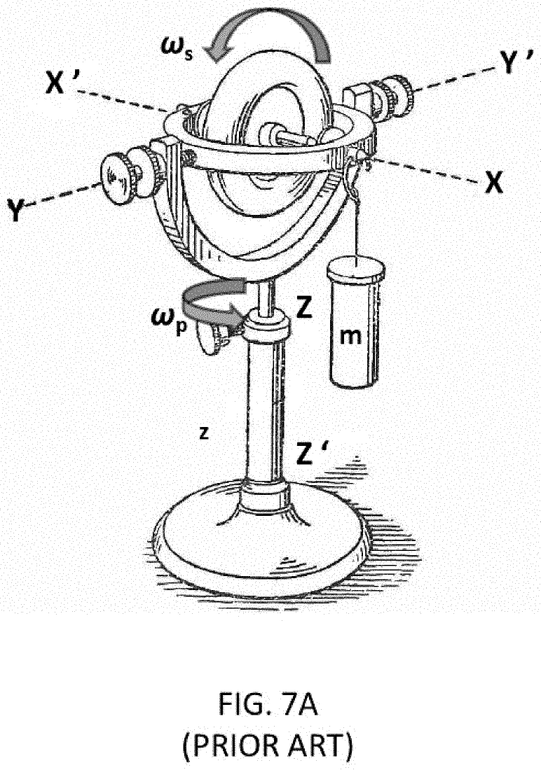

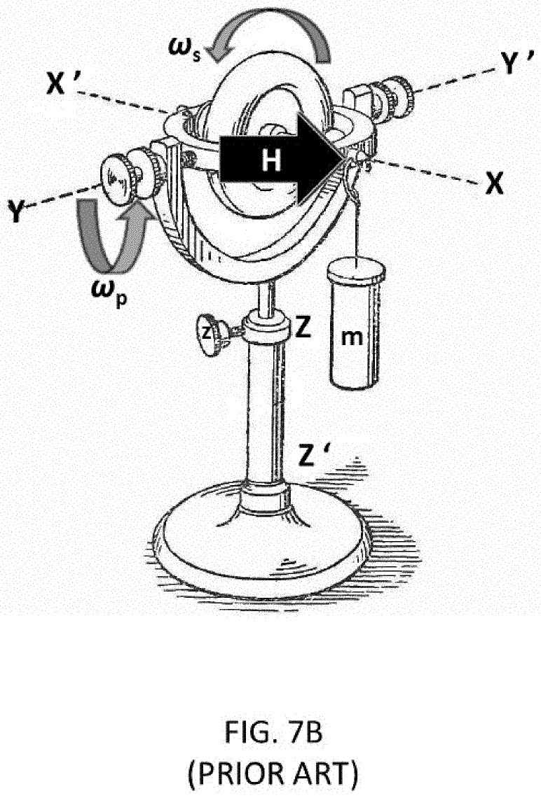

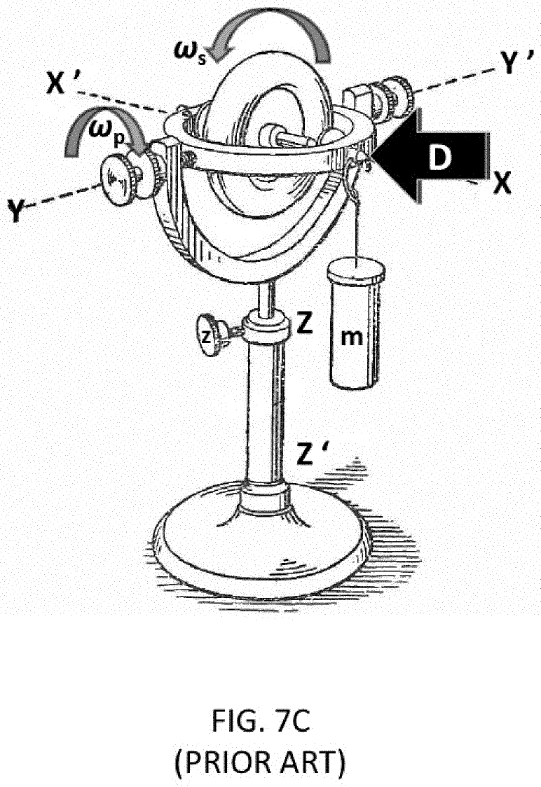

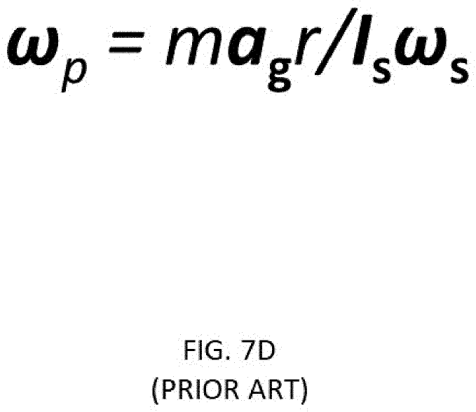

In FIGS. 7A through 7D are a precession formula and depictions of how a gyroscope can be used to induce a precessional torque (i.e., any precessional torque induced in either the null or thrust phase). Explanations for FIGS. 7A through 7D are given in the Description of Related Art section of this specification.

### REFERENCE NUMERALS

1. Roll-axis motive torquer (Also referred to as “Central motor,” and, depending on the method used, can be referred to as the “first-axis motive torquer” or the “third-axis motive torquer.”) NOTE: Other drive devices in lieu of the central motor 1 are also acceptable. Examples include, but are not limited to, fuel-powered, air-powered, gear-driven, flywheel, and air turbine. A brakeable motor or a motor with a worm-gear transmission could be used to replace both the central motor 1 & 26 as well as its associated brake components (calipers; 24 and disk; 23) especially when passive damping methods are being used. Furthermore, should it prove difficult to find or use a motor that is in line with the central shaft 36 then another option is to install a pulley or sprocket on a supported shaft and then power said shaft by placing a belt or chain to connect the pulley or chain with the central motor 1.
2. Roll-axis shaft. (Also referred to as “central-motor shaft” and, depending on the method used, can be referred to as the “first-axis shaft” or the “third-axis shaft.”)
9. Swivel wheel. This optional wheel is configured to swivel at least 90 degrees so as to modify the general direction of movement in a perpendicular direction. This is especially relevant when using the same mechanical embodiment for different methods. Usually a platform will have a plurality of swivel wheels.
10. Piston rod.
11. Pitch-axis torquing system (Also referred to as “variable-acceleration, double-acting, duplex pneumatic actuator” and, depending on the method used, can be referred to as the “first-axis torquing system” or the “third-axis torquing system.”). NOTE: Other types of torquing systems in lieu of the said pneumatic actuator are also viable. Examples include but are not limited to variable-acceleration double-acting telescopic pneumatic cylinder, electric magnet, geared track, hydraulic cylinder, coil springs or tension springs (in combination with a locking mechanism 38), or standard pneumatic actuators with a variable speed control. A method of achieving variable acceleration with standard pneumatic cylinders is the technique of “stacking” cylinders. If two or more cylinders are connected end-to-end then the end result will provide for an ever-increasing acceleration when all cylinders are activated simultaneously. If only two cylinders are “stacked” then one will create the equivalent what is called a duplex cylinder. Regardless of the method used, the objective is the same: an actuator stroke that can be accelerated while being retracted or pushed outwardly. If a given device provides motive torque alone but cannot provide resistive torque then such a device should be referred to as a motive torquer.
12. Shock absorber.
13. Rotor motor. NOTE: Other drive devices in lieu of the electric rotor motor are also acceptable. Examples include, but are not limited to, fuel-powered, air-powered, gear-driven, flywheel, and pneumatic turbine.
14. Precessable mass, such as a spinnable rotor, vibrating structure gyroscope, or seismic mass wherein the term “precessable” for the purposes of this disclosure, is a reference to any orthogonal or diagonal movement that occurs when an angular torque is applied to a spinning or vibrating mass.
15. Shaft bracket. Also referred to as “axle bracket.”
16. Mobile platform with swivel wheels or on a floatation device. (Platform is optional in the event that only the MUTINT engine is mounted on a vehicle or on a free body such as a satellite.)
17. Programmable-Automation Module.
18. Frame clamp. (Optional in the event that only the MUTINT engine is mounted on a vehicle).
19. Rotatable frame. (Optional in the event that only the MUTINT engine is mounted on a vehicle).
20. Swivel connector: NOTE: A bearing, pin, bushing, hinge, or some other comparable device can be used in lieu of the swivel connector.
21. Adjustable-contraction sensor.
22. Adjustable-extension sensor.
23. Resistance torquer disk. (Also referred to as “Brake disk”).
24. Resistance torquer calipers. (Also referred to as “brake calipers.”) NOTE: The resistance torquer 45 is comprised of a resistance torquer disk and the resistance torquer calipers.
25. Shaft connector. Also referred to as “axle connector.”
26. Hollow-shaft roll-axis motive torquer (Also referred to as “central motor” and, depending on the method used, can be referred to as the “Hollow-shaft first-axis motive torquer” or the “Hollow-shaft third-axis motive torquer.”) NOTE: Other drive devices in lieu of a central motor are also acceptable. See reference Numeral 1 above.
27. Three-way air valve.
28. Hollow-shaft roll-axis shaft (Also referred to as “hollow central shaft” and, depending on the method used, can be referred to as the “hollow-shaft first-axis shaft” or the “hollow-shaft third-axis shaft.”) Said shaft 28 will be supported by bearings, bearing housing, and supporting structure on both ends. (Not shown.)
29. Pendulous gimbal (Also referred to as “Pivot pendulous gimbal” or “Tilt pendulous gimbal”).
30. Adjustable push-pull rod. NOTE: If a pneumatic turbine or any other air-powered device is used to power the rotors 14 then said rod 30 should be hollow to allow for air pressurization of the shaft and thereby supply power to the pneumatic turbines 13.
31. Synchronization link.
32. Bar collar (Push-pull rod collar with bars). NOTE: Said “bars” in this context refers to a plate, lug, rod or similar protrusion to which the synchronization links 31 and shock absorbers can be mounted or attached.
33. Push-pull rod bearing.
34. Support frame (Also referred to as “Motor-support frame”).
35. Flexible pendulous gimbal (Also referred to as “Flexible connecting arm”).
36. Roll-axis solid shaft. Also referred to as “solid central shaft” and, depending on the method used, can be referred to as the “first-axis solid shaft” or the “third-axis solid shaft.”). Said shaft will be supported by bearings, bearing housing, and supporting structure on both ends (not shown).
37. Gear-plate assembly.
38. Pitch-axis resistance torquer. (Also referred to as “locking mechanism for the Spring MUTINT and, depending on the method, can be referred to as “first-axis resistance torquer” or “third-axis resistance torquer.”)
39. Roll-axis shaft (Also referred to as “Central-motor shaft” and, depending on the method, can be referred to as “first-axis shaft” or “third-axis shaft.”)
40. Pitch-axis motive torquer. (Also referred to as “tension spring for the Spring MUTINT and, depending on the method, can be referred to as “first-axis motive torquer” or “third-axis motive torquer.”) Other items may substitute the spring such as a stretchable band or a mechanical actuator.
41. Shaft connector with spring-extension bars. (Also referred to as “shaft connector.”) NOTE: A “bar” in this context refers to a rod-like or bar-like extension that protrudes from the shaft connector 41. Said bar will serve to retain the spring 40.
42. Push-pull rod resistance-torquer. (Also referred to as “push-pull rod braking mechanism.”)
43. Roll-axis torquing system. (Also, depending on the method used, can be referred to as the “first-axis torquing system” or the “third-axis torquing system.”) The roll-axis torquing system comprises a device(s) that can fulfil the functions of both a roll-axis motive torquer and a roll-axis resistive torquer.
44. Pitch-axis torquing system. (Also, depending on the method used, can be referred to as the “first-axis torquing system” or the “third-axis torquing system.”) The pitch-axis torquing system comprises a device(s) that can fulfill the function of both a pitch-axis motive torquer and a pitch-axis resistive torquer.
45. Roll-axis resistive torquer. Said resistive torquer comprises a resistance torquer disk 23 (also referred to as “brake disk”) and resistance torquer calipers 24 (also referred to as “brake calipers”).
49. Vertical-frame rotational connecter. Said vertical-frame rotational connecter allows for a given rotary embodiment (e.g., Radius, Tangent, Tilt MUTINTs) to change the alignment of the roll axis from perpendicular to the general direction of movement to parallel to the general direction of movement (and any interim position.)
50. Vertical frame (optional).
51. Roll-axis shaft mounting brackets. (Also, depending on the method used, referred to as “first-axis shaft mounting brackets” or “third-axis shaft mounting brackets.”)
52. Pendulous subframe.
53. Pitch-axis torquing system (Also referred to as “Gimbal step motor,” and, depending on the method used, can be referred to as the “first-axis torquing system” or the “third-axis torquing system.”) The gimbal step motor can generate a forward and reverse motive torque wherein said motive torque is a smooth rotation or a precise incremental movement. Said step motor can cause a resistive torque in that said step motor can both pivot the attached gimbal and said step motor can also brake the rotational movement of the associated gimbal. Said gimbal step motor is capable of performing the same motive and resistive functions as the roll-axis torquing system.
54. Pitch-axis torquing shaft (Also referred to as “gimbal motor shaft” and, depending on the method used, can be referred to as the “first-axis torquing shaft” or the “third-axis torquing shaft.”)
55. Frame gimbal.
56. Counterbalance.
57. Adjustable counterbalance support frame.
58. Motorized-rotation gimbal. The motorized-rotation gimbal allows for changing the angle of incidence of the rotor. Rotation of said gimbal will affect its roll-axis trajectory and its pitch-axis rotation.
59. Motorized-rotation motor.
60. Support bracket for motorized-rotation gimbal motor.
61. Motorized-rotational device. Said motorized rotational device allows for the pivoting of said subframe and the attached gimbal by 360 degrees. (Motor is not shown but is understood to be included as part of said device.)
97. Clockwise (CW) arrow.
98. Counter-clockwise (CCW) arrow.
99. Large arrow. Said arrow indicates the general direction of movement of the entire inertial-thrust engine. The trajectory of said general direction can be either linear or rotational.
100. Mechanical Embodiments of Inertial-Thrust Architecture.
110. MUTINT engine Class whether rotary or oscillatory.
111. Oscillatory MUTINT engine Class.
112. Rotary MUTINT engine Class.
113. MUTINT Gimbal Class whether centered or pendulous.
114. Centered Gimbal Class (the precessable mass is centered in the gimbal frame.)
115. Pendulous Gimbal Class (The precessable mass is pendulously attached to roll-axis motive torquer (e.g., shaft)
116. Roll axis orientation. (The roll axis of a given embodiment is either perpendicular or parallel to the general direction of movement.)
117. Perpendicular-axis orientation.
118. Parallel-axis orientation.
120. Roll-axis Motive Torquer device comprising a spring or an actuator.
121. Spring device.
122. Actuator device.
130. Pendulous-gimbal style (Also referred to as “Connecting Arm Style”) whether flexible or rigid.
131. Flexible pendulous-gimbal style (Also referred to as “Flexible Connecting Arm Style”).
132. Rigid pendulous-gimbal style (Also referred to as “Rigid Connecting Arm Style”).
140. Rotor alignment whether radial or tangential.
141. Radial-Rotor Alignment.
142. Tangential-Rotor Alignment.
151. Pivot MUTINT engine.
152. Flex MUTINT engine.
153. Spring MUTINT engine.
154. Single-rotor Radius MUTINT engine.
155. Tangent MUTINT engine.
156. Tilt MUTINT engine.
157. Modified Radius MUTINT engine.
158. Twin-rotor Radius MUTINT engine.
159. Modified Tangent MUTINT engine.
160. Phase One configuration for oscillatory MUTINTs whether extended-actuator configuration (formerly referred to as “contracted configuration”) or retracted-actuator configuration. (Formerly referred to as “extended configuration.”)
161. Phase One configuration is the extended-actuator configuration. Said extended-actuator configuration is an example of the range of motion of a given embodiment but it is not intended to limit the full range of oscillation available to persons of skill in the art. Said full range of motion is up to 180 degrees for an oscillatory embodiment.
162. Phase One configuration is the retracted-actuator configuration. Said retracted-actuator configuration is an example of the range of motion of a given embodiment but it is not intended to limit the full range of oscillation available to persons of skill in the art. Said full range of motion is up to 180 degrees for an oscillatory embodiment.
200. Strategic-Damping Methodological Embodiments of Inertial-Thrust Architecture.
210. Inertial Thruster Phases whether null phase or thrust phase.
211. Null phase. (Also referred to as “minimized-thrust phase.”)
212. Thrust phase. (Also referred to as “maximized-thrust phase.”)
220. Rotary Inertial Thruster Modes whether unimodal or bimodal.
221. Unimodal Mode.
222. Bimodal Mode.
230. Inertial Thruster Phase order whether distinct or overlapping. The null phase and the thrust phase follow one another in succession and are discrete or partially overlap with one another.
231. Distinct Phase order.
232. Overlapping Phase order.
240. Damping Categories whether passive or active.
241. Passive Damping (category).
242. Active Damping (category).
250. Torque Duration Categories whether brief or prolonged.
251. Brief Torque Duration for the hurrying or delaying of precession.
252. Prolonged Torque Duration for the hurrying or delaying of precession (duration).
260. Torque Direction Categories whether delaying or hurrying.
261. Delaying (i.e., resisting) of Precession.
262. Hurrying of Precession.
281. Method I: Pivot-Flex Brief Method.
282. Method II: Pivot-Flex Overlapping Method.
283. Method III: Partial-delaying Method.
284. Method IV: Active-Delaying Method.
285. Method V: Active-hurrying Method.
286. Method VI: Spring-Brief Method.
287. Method VII: Spring-Overlapping Method.
288. Method VIII: Rotary-hurrying Method.
289. Method IX: Bimodal Method.
291. Submethod A: Passive-Delaying submethod.
292. Submethod C: “No-spin” submethod.
293. Submethod D: “No-damping” submethod.
294. Submethod B: Active-Delaying submethod.
295. Method X: Modified Brief Method.
296. Method XI: Modified partial-delaying method.
297. Method XII: Modified active-delaying method.
298. Method XIII: Modified active-hurrying method.
300. Integrated Architecture of Mechanical and Methodological Embodiments of Inertial-Thrust.
301. Method XIV: Temporary-Reverse Method.
302. Method XV: Rotary-Overlapping Method.
303. Method XVI: Tilt-Motive Method.
304. Method XVII: Oscillatory-Tilt Method.
305. Method XVIII: Tilt-Resistive Method.
306. Method XIX: Thrust-Damping Method.
307. Method XX: Rotary-Delaying Method.
308. Method XXI: Double-Submethod Method.

### Operation

I will present twenty-one inertial-thrust methods 200 plus four submethods (291, 292, 193, and 194). As a non-binding general description of the oscillatory MUTINTs 111 (FIGS. 1A through 3C) and the Tilt MUTINT in the null phase, the dampable-forcing torque is caused by elements of the roll-axis torquing system (e.g., central motor 1 & 26) and the damping-forcing torque is caused by elements of the pitch-axis torquing system (e.g., the actuator 11 or the locking mechanism 38). As a non-binding general description of the null phase of the Radius MUTINT, the Tangent MUTINT (FIGS. 4A through 5B), and the modified oscillatory MUTINTs the inverse is true. (Modified oscillatory MUTINTs are Flex or Pivot MUTINTs that have been modified to function with the modified Methods (X through XIII) wherein only one precessable mass is used and the general direction of movement is at right angles to that of the standard Pivot or Flex MUTINTs.) In general, for the null phase of the Radius and Tangent MUTINTs 154 & 155 and the modified oscillatory MUTINTs, the damping torque is caused by elements of the roll-axis torquing system (e.g., central motor 1) and the dampable-forcing torque is provided by elements of the pitch-axis torquing system (e.g., gimbal step motor 53). Thus, for the Pivot and Flex MUTINTs 118, while the rotors are precessing, the damping torque (generated by elements of the pitch-axis torquing system such as the actuator 11 or locking device 38) must be greater than the dampable-forcing torque produced by the roll-axis torquing system (e.g., central motor 1 & 26). For the Radius and Tangent MUTINTs 114, while the rotors are precessing in Phase One, the damping torque from the roll-axis torquing system (e.g., central motor 1) must be greater than the torque from the pitch-axis torquing system (e.g., gimbal step motor 53).

The following discussion of methods and submethods are examples of how the various embodiments can be operated. These examples are not intended to limit the scope, applicability, configuration, or methods of the invention in any way. Persons of skill in the art will understand that the order of the actions can also be modified, new actions be added, existing actions be deleted, and actions from one method can be exchanged for actions from another described method.

First, I will present five methods on how to achieve inertial thrust with the Pivot 151 and Flex 152 MUTINT embodiments. (See methods I through V.) These two embodiments are presented together since they have certain features in common. (See FIGS. 1A and 2A.) At least four of these five methods for the Pivot and Flex MUTINTS can be adapted for use with a modified version of the Pivot and Flex MUTINTs. (See methods X, XI, XII, AND XIII.) Said modified version of the Pivot and Flex MUTINTs reorient the direction of movement by substantially 90 degrees and said modified version also changes the function of the roll axis of the Pivot and Flex MUTINTs so that oscillations occur on both the roll and pitch axes. I will provide two explanations that describe methods on how to achieve inertial thrust with the Spring MUTINT embodiment 153 (See method VI & VII, FIG. 3A).

I will provide five descriptions that can also be used on the rotary MUTINT methods for the Tangent and Radius embodiments. (See methods VIII, IX, XIX, XX, and XXI.) Five method descriptions will be provided for the Tilt Mutint the reader being advised that these methods, like the others, can be also adapted for other embodiments. (See methods XIV, XV, XVI, XVII, and XVIII.)

A unique description is given for Method XXI (the Double Submethod Method) wherein said method is a back-to-back use of two submethods wherein what is normally a thrust-phase method becomes the equivalent of a null phase method and wherein the submethod for the thrust phase is simply a submethod that has a greater enhanced thrust than said null=phase. The final four explanations are generic submethods for the thrust phase applicable to all six mechanical embodiments but also applicable to Phase One of method XXI 308. (See methods A, B, C, and D.)

NOTE: The direction of rotation (CW i.e., clock wise, or CCW i.e., counter clock wise) is taken to mean as seen from the pitch-axis torquing system (e.g., pneumatic cylinder 11) looking towards the direction of the rotors 14. Furthermore, the pendulous gimbals 29 & 35 are in the Phase-One configuration for the Pivot 151 and Flex 152 embodiments when said arms are in the extended-actuator configuration (i.e., contracted 161) and diagonal (or nearly parallel) to the shaft 28. For the Spring MUTINT 153, the Phase-One configuration is when the pendulous gimbals 29 are in the retracted-actuator configuration (i.e., extended 162) and nearly perpendicular to the shaft 28.

### Operational Method I 281 (Pivot-Flex Brief Method).

Phase One of Operational Method I (FIGS. 1A and 2A): The over-arching strategy of this method during Phase One is to first produce a dampable-forcing torque in Phase One by rotating the roll-axis motive torquer (e.g., shaft 28 & 36). In this method, the first axis is the roll axis and the third axis is the pitch axis.

What makes this method and method VI unique is that the immobilizing of the displacement of said at least one precessable mass is done, wherein the immobilizing is applied as said null-phase damping forcing torque on said third axis before precession begins and only during a beginning of said null phase with said immobilizing continuing only until the torque axis of said first precessional torque is redirected to an axis that is substantially parallel to said first axis, and wherein said null-phase damping forcing torque is of a force greater than said first precessional torque. Method I has the further distinctives reference the immobilizing of the displacement of said at least one precessable mass wherein said immobilizing of the displacement of said at least one precessable mass on said third axis is done by stopping a curved trajectory of said at least one precessable mass from moving into substantially the same direction as said general direction of movement of the engine by activating said third-axis torquing system to counter said first precessional torque from displacing said at least one precessable mass substantially forward and in the general direction of movement of the engine, and wherein said third-axis torquing system comprises at least one of a third-axis motive torquer or a third-axis resistive torquer.

In this method the pendulous gimbals 29 and rotors 14 are attached to and associated with said roll-axis motive torquer. Upon being orbited by the roll-axis motive torquer (e.g., central shaft 28 & 36), the rotors 14 will immediately have a tendency to precess forwards however this precession is briefly disallowed by a strong countering torque (i.e., a damping-forcing torque) from the resistive function of the pitch-axis torquing system (e.g., pneumatic cylinder or the push-pull rod brakes 11). This passive delaying of the original precession (first precessional torque) redirects said the torque axis of said first precessional torque substantially perpendicularly (by up to 90 degrees) to become substantially parallel with the torque axis of the roll-axis motive torquer. The axis of rotation of the redirected first precessional torque now coincides with the axis of rotation of the roll-axis motive torquer (e.g., central shaft 28 & 36) that is rotating in a given direction—(e.g., CCW). This is an application of inducing a delaying torque 261 on the first precessional torque during the null phase.

More specifically, we have at least one precessable rotor 14 that is undergoing precession-related motion (e.g., spinning) in a given direction (e.g., clock-wise direction) about a second axis (i.e., spin axis). The roll-axis motive torquer (e.g., central motor 1 & 26) is set to rotate the shaft 28 & 36 in another direction (e.g., a counter-clock wise direction) about a first axis (e.g., roll-axis). All resistive torquers (e.g., brakes) have been released. Before the roll-axis motive torquer (e.g., central motor 1 & 26) is rotated in a given direction (e.g., CCW direction), it is essential that the pendulous gimbals 29 & 35 be forced to stay in the extended-actuator (contracted) configuration 161 by applying outward air pressure from the resistive function of the pitch-axis torquing system (e.g., pneumatic cylinder 11) or by engaging a pitch-axis resistive torquer (e.g., locking or gating device 38) to immobilize the, at least one, pendulous gimbal 29 from moving on the third axis e.g., pitch axis. This passive delaying torque 261 (a damping forcing torque on the pitch axis), to prevent a first precessional torque on the third axis (e.g., pitch axis), should be greater than the dampable forcing torque caused by the rotation of the roll-axis motive torquer (i.e., caused by the central shaft's rotation). The third-axis damping forcing torque (i.e., external torque) is accomplished by placing the pneumatic cylinder's three-way air valve 27 in the open (“out”) position. Said third-axis damping forcing torque caused by the pitch-axis torquing system (e.g., pneumatic cylinder) 11 temporarily damps the null-phase precessional torque (i.e., first precessional torque) created by the orbiting of the spinning rotors 14 on the roll axis. This temporary damping continues till the torque axis of the first precessional torque is redirected to being parallel to the first axis (i.e., roll axis).

NOTE: The rotating of the roll-axis motive torquer (e.g., central motor) 1 & 26 in a given direction (e.g., CCW direction) on the first axis (e.g., roll axis) induces the rotors 14 to have a tendency to swing forwards about the third axis (e.g., pitch axis) and into the general direction of movement of the engine (see large arrow 99 in FIG. 1A, for example). The end result will be that the precessional torque along the torque axis (i.e., first precessional torque) will be redirected to being the same direction (i.e., CCW) as that of the axis of rotation of the roll-axis motive torquer (e.g., central shaft 28 & 36. As a result of the redirecting of the first precessional torque, the precessable masses (i.e., rotors 14) will temporarily have a lesser reaction in the direction of the curved trajectory during the null phase 211 than during the thrust phase 212.

Thus, during the null phase, after several revolutions of the roll-axis motive torquer (e.g., central motor 1 & 26) and after the torque axis of the first precessional torque has shifted and with the roll-axis motive torquer still rotating, the air-pressure valve 27 is placed in the neutral position. Said neutral position will cause the releasing of air pressure and will allow for gyroscopic precession (first precessional torque) to push the piston of the pitch-axis motive torquer (e.g., pneumatic cylinder's piston 3) and the associated pendulous gimbals 29 & 35 forward (and into the general direction of travel). (This is significant because even though the torque axis of said first precessional torque has been shift to being parallel to the roll axis, yet upon removing the third-axis resistive torque, the first precessional torque will again precess the precessable masses on the pitch axis in a direction that is generally the general direction of movement of the engine.) The pendulous gimbals 29 & 35 and the associated rotors 14 will swing forward into the general direction of movement of the engine at a basically constant rate of speed. You will observe that this forward movement of the pendulous gimbals 29 & 35 and rotors 14 does not produce an equal and opposite reactive motion on the unit as a whole. NOTE: A given embodiment may require a pitch-axis resistive torquer (e.g., braking mechanism) 42 to be applied on the push-pull rod 30 during the null phase 211 to ensure that the rotors precess in a forward direction at a uniform, resisted rate.

Phase Two of Operational Method I 281 (FIGS. 1B, 1C, 2B, and 2C): After the pendulous gimbals 29 & 35 are in the retracted-actuator (i.e., extended) configuration then the power is either: 1) switched off from the roll-axis motive torquer (e.g., central motor 1 & 26) or 2), the direction of the roll-axis motive torquer is reversed. In the first option, if the roll-axis motive torquer is switched off then a roll-axis resistive torquer (e.g., braking mechanism such as the disk-brake calipers 24 onto the brake disk 23) should be applied to the roll-axis motive torquer (e.g., central shaft 28 & 36). In the second option, the direction of the roll-axis motive torquer (e.g., central motor) is reversed and the roll-axis resistive torquer (e.g., brakes) is not applied to the roll-axis motive torquer. Immediately afterwards, for both options, the piston of the pitch-axis torquing system (e.g., pneumatic cylinder) is thrust outwardly by placing the air valve 27 in the out (“open”) position. The precessable mass(es) 14 will swing backwards in the opposite direction, of the general direction of movement of the engine, at an ever-increasing rate of acceleration and the frame supporting the precessable masses 14 will strike the shock absorbers 12 at the end of the travel of said precessable masses. The rearward swing of the rotors 14 on the pitch axis will cause the rest of the MUTINT engine to move in the opposite direction i.e., forward. The net result is that the MUTINT engine moves more in a forward direction during the thrust phase than it does in a rearward direction during the null phase. Once the pendulous gimbals 29 & 35 return to the extended-actuator (i.e., contracted) configuration 161, the two-phase operation will then be repeated ad infinitum. NOTE: The “rear” portion Pivot 151 and Flex 152 MUTINT engine is the end where the rotors 14 are located and the “forward” portion is the end of the MUTINT engine where the pitch-axis torquing system (e.g., pneumatic actuator 11) is located.

### Operational Method II 282 (Pivot-Flex Overlapping Method):

A variation to Operational Method I would be to alternate quickly between Phase One and Phase Two in such a way that the rearward momentum of the precessable masses 14 in Phase Two becomes the equivalent of the delaying torque (damping forcing torque) required for Phase One. In this method, the first axis is the roll axis and the third axis is the pitch axis.

What makes method II and method VII unique is that said null phase and said thrust phase partially overlap with one another, wherein a reversal of the curved trajectory of the at least one precessable mass on said third axis during a portion of said thrust phase initially generates a negative torque that causes a resistance and a delaying of precession at an onset of said null phase, wherein said resistance is from a rearward momentum of the at least one precessable mass during said thrust phase, and wherein said rearward momentum is opposite to the general direction of movement of the engine. The thrust-phase dampable-forcing torque causes a reversal of the curved trajectory of the at least one precessable mass on said third axis during a portion of said thrust phase and initially generates a negative torque that causes a resistance and a delaying of said first precessional torque at an onset of said null phase.

In method IL, the holding function of the pitch-axis torquing system (e.g., pneumatic cylinder 11) at the beginning of Phase One for Method I would become unnecessary since the residual momentum from the rearward motion would provide the necessary damping forcing torque to delay the first precessional torque at the beginning of Phase One. Thus, there would be a brief moment when both phases overlap 232 in which Phase One would begin before Phase Two ends. This method is called a “contracted” method to distinguish it from the same concept being used in the “extended” mode on the spring MUTINT engine in method VII 287 (FIG. 3A).

The thrust phase for Operational Method II 282 can employ one of the four submethods (A, B, C, or D) listed later in this specification.

### Method III 283 (Partial-Delaying Method.)

Phase One of Operational Method III (FIGS. 1A and 2A): The strategy of this method during Phase One is to produce a null-phase dampable forcing torque by rotating the roll-axis motive torquer (e.g., shaft 28 & 36) so that the attached rotors 14 begin to precess in a forward direction and into the general direction of movement of the engine 99. (In this method, the first axis is the roll axis and the third axis is the pitch axis.) What is unique about this Method VI is that a partial resistance is applied to said first precessional torque, wherein said partial resistance comprises a passive damping that slows the curved displacement of the at least one precessable mass on said third axis for a duration of said null phase, wherein the minimizing of a rearward reaction of the engine is achieved by said partial resistance of the first precessional torque resulting in the redirection of the torque axis of said first precessional torque, and wherein said passive damping generates a resistance less than that of said first precessional torque.

To apply this method to a given mechanical embodiment it is necessary that, as soon as said first precessional torque is induced, then this first-precessional torque is partially resisted (delayed) by a null-phase damping forcing torque that takes the form of either a resistive force or pressure from the pitch-axis torquing system (e.g., pneumatic cylinder 11) or from the pitch-axis resistive torquer (e.g., braking mechanism 42 such as a friction brake on the push-pull rod 30). This partial resistance of the first precessional torque incrementally redirects the torque axis of said first precessional torque to go towards being parallel to roll axis. The end result will be that part of the first precessional torque 261 will be redirected into the same direction (e.g., CCW) as the axis of rotation of the roll-axis motive torquer (e.g., central shaft 28 & 36).

More specifically, we have two rotors 14 spinning in a given direction (e.g., a CW direction). The roll-axis motive torquer (e.g., central motor 1 & 26) is set to rotate the shaft 28 & 36 in also in a given direction (e.g., in a CCW direction). The mechanical embodiment is in the extended-actuator (contracted) configuration 161. Any resistive torquers (e.g., brakes 24) on the roll-axis motive torquer (e.g., central shaft 28 & 36) have been released. As the roll-axis motive torquer (e.g., central motor 1 & 26) is rotated in said given direction (e.g., a CCW direction) it is essential that the pendulous gimbals 29 & 35 be partially delayed in their forward trajectory. (Said damping forcing torque, for this method, should be less than the dampable forcing torque caused by the rotation of the central shaft 28 & 36.) Resistance or delaying can be accomplished by placing the three-way air valve 27 in a slightly open (“out”) position or by lightly applying the pitch-axis resistive torquer (e.g., brakes 42 to the push-pull rod 30). An appropriate resistance to the forward movement of the pendulous gimbals will cause an incremental portion of the first precessional torque to be incrementally redirected towards a direction that coincides with the central shaft's axis of rotation.

NOTE: The rotating of the roll-axis motive torquer (e.g., central motor 1 & 26) in a CCW direction induces the rotors 14 to have a tendency to swing forwards on a curved trajectory into the overall intended direction of movement of the engine 99. You will observe that this forward movement of the pendulous gimbals 29 & 35 and rotors 14 does not produce an equal and opposite reactive motion on the engine as a whole during the null phase 211 when compared to the reactive motion of the thrust phase.

Phase Two of Operational Method III 283 is substantially the same as that of Phase Two of Operational Method I. (See above.) NOTE: It is during Phase Two that the actual forward thrust occurs.

### Operational Method IV 284 (Active-Delaying Method):

Phase one of Operational Method IV (FIGS. 1A and 2A): The general strategy of this method during Phase One is to create a net forward motion by using an active delaying technique 261 that will redirect the toque axis of the first precessional torque to be parallel to the torque axis of the roll-axis motive torquer (e.g., central shaft). In this method, the first axis is the roll axis and the third axis is the pitch axis. What makes this method unique is that said first precessional torque comprises a force that is substantially rearward and opposite to the general direction of movement of the engine, and wherein applying a negative torque as the null-phase damping forcing torque on said third axis actively damps said first precessional torque by displacing said at least one precessable mass in a curved trajectory that is substantially forward and in the same general direction of movement of the engine, and wherein said null-phase damping forcing torque is greater than said first precessional torque.

To apply method IV to a given mechanical embodiment place the device in the correct start position. The start position for this method is the extended-actuator (contracted) configuration 161 (FIGS. 1A and 2A). As Phase One begins there are two rotors 14 spinning in a given direction (e.g., a CW direction). With all resistive torquers (e.g., brakes) released, first place the air valve 27 of the pitch-axis torquing system on “out” (or “neutral” position). (NOTE: the neutral position is also acceptable since the first precessional torque will already be torquing (i.e., placing pressure on) the pendulous gimbals 29 in a rearward direction that is opposite to the general direction of movement.) Now begin to rotate the roll-axis motive torquer (e.g., central shaft 28 & 36) in a given direction (e.g., in a CW direction). After the central shaft's rotation has attained its full speed then switch the air valve 27 to the “in” position. The forward movement of the pendulous gimbals 29 will immediately place a null-phase damping forcing torque (i.e., active delaying torque 261) on the originally rearward precession (i.e., the first precessional torque in a rearward direction). In this set up, as the piston rod 10 of the pitch-axis motive torquer (e.g., pneumatic actuator 11) pulls inwardly (null-phase damping forcing torque) then the resulting gyroscopic precession causes the pendulous arms 29 to have a tendency to rotate on the axis of rotation of the roll axis in another given direction (e.g., a CW direction). Said direction of the axis of rotation on the roll axis coincides with the existent rotational direction (e.g., CW) of the roll-axis motive torquer (e.g., central shaft 28 & 36). Thus, the torque axis of the first precessional torque is conveniently redirected (or diverted) in a direction that is parallel to the roll axis and thereby minimizing (or eliminating) any reverse thrust in the overall intended direction of movement of the entire engine 99. This is an application of inducing a delaying torque 261 on the first precessional torque.

Phase Two of Operational Method IV 291 is substantially the same as phase Two of Operational Method I. (See above.) NOTE: It is during Phase Two that the actual forward thrust occurs.

### Operational Method V 285 (Active-Hurrying Method):

Phase One of Operational Method V (FIGS. 1A and 2A). The over-arching strategy of this method during Phase One is to lessen the reaction to the displacement of the precessable masses by actively hurrying the precession 262 of the rotors 14. In this method, the first axis is the roll axis and the third axis is the pitch axis.

What makes this method unique is that said first precessional torque comprises a force that is substantially forward and in the general direction of movement of the engine, wherein applying a positive torque as the null-phase damping forcing torque on said third axis actively damps said first precessional torque by further accelerating a curved trajectory of said at least one precessable mass substantially forward and in the general direction of movement of the engine, and wherein said null-phase damping forcing torque is greater than said first precessional torque.

To make this method V work on a given embodiment first induce a first precessional torque by rotating the roll-axis motive torquer (e.g., central shaft 28 & 36) in a given direction (e.g., in a CCW direction). This will cause the rotors 14 to precess forwards and into the general direction of movement of the engine 9. When the precessable masses begin to precess in a forward direction then activate the piston of the pitch-axis torquing system (e.g., pneumatic cylinder 11) so as to cause the rotors 14 to move forward even more quickly. This hurrying of the first precessional torque 262 redirects the torque axis of the precessional torque in such a way that the direction of the redirected precessional torque now counters the rotational direction of the roll-axis motive torquer (e.g., central shaft 28 & 36). Thus, the new direction of rotation of the precessional torque will be in another direction (e.g., in a CW direction) and in an opposite direction of the original direction of rotation of the roll-axis motive torquer (e.g., central shaft's CCW rotation). What is most significant is that the torque axis of the first precessional torque has now been redirected to being parallel to the roll axis.

More specifically, phase one begins with two rotors 14 spinning in a given direction (e.g., a CW direction). The start position for Phase One is with the pendulous gimbals 29 & 35 in the extended-actuator (contracted) configuration 161. With all resistive torquers (e.g., brakes) released, first place the air valve 27 on “out” and then begin to rotate the roll-axis motive torquer (e.g., central shaft 28 & 36) in a given direction (e.g., CCW direction). After the roll-axis motive torquer's (e.g., central shaft's) rotation has attained its full speed then switch the air valve 27 to the “in” position. The forced forward movement of the pendulous gimbals 29 will place a hurrying torque 262 on the original precession (i.e., first precessional torque). In this method, when the piston rod 10 of the pitch-axis motive torquer (e.g., pneumatic actuator 11) pulls inwardly then the resulting gyroscopic precession causes the arms 29 to rotate in another direction (e.g., in a CW direction). (Note that the damping forcing torque caused by the pneumatic cylinder 11 should be greater than the dampable forcing torque caused by the central shaft's rotation.) Said direction of rotation is in opposition to the direction of rotation of the central shaft 28 & 36 (i.e., CCW). Thus, the hurrying torque 262 causes the torque axis of the first precessional torque to be conveniently redirected in a direction that is parallel to the roll axis and thereby minimizing (or eliminating) any reverse thrust parallel to the overall intended direction of movement 99.

Phase Two of Operational Method V 285 is substantially the same as Phase Two of Operational Method I. (See above.) NOTE: It is during Phase Two that the actual forward thrust occurs.

### Operational Method VI 286 (Spring Brief Method):

Phase One of Operational Method VI (FIG. 3A): The Spring MUTINT mechanical embodiment 153 is different from the Pivot 151 and Flex 152 MUTINT mechanical embodiments in that the start position for the Spring MUTINT is in the retracted-actuator (extended) configuration 162. The over-arching strategy of this method during Phase One is to first induce a first precessional torque by orbiting the rotors 14 in a given direction (e.g., a CW direction) on the roll axis. In this method, the first axis is the roll axis and the third axis is the pitch axis. What is unique about method VI is that the immobilizing of the displacement of the at least one precessable mass on said third axis is done by locking said at least one precessable mass to restrain said at least one precessable mass from moving substantially forward and in the general direction of movement of the engine.

This method employs a Spring MUTINT engine 153 wherein gyroscopic precession, after a brief resistance 251, by the pitch-axis resistive torquer (e.g., locking mechanism 38), stretches the tension springs 40 (which, in this method, is the pitch-axis motive torquer) and moves the pendulous gimbals 29 towards the extended-actuator (contracted) configuration 161. (See FIG. 3C.) In Phase Two, once the roll-axis motive torquer (e.g., central motor 1) has resistive torque applied to it (e.g., braking, immobilizing, and/or reversing) and upon cessation of the null-phase dampable forcing torque, the pendulous gimbals 29 automatically move back to the retracted-actuator (extended) configuration due to the torque exerted by the pitch-axis motive torquer (e.g., tension springs).

More specifically, in Phase One we have two rotors 14 spinning in a given direction (e.g., CW direction). The roll-axis resistive torquer (e.g., shaft brake 24) has also been disengaged in Phase One. In this operational method, the roll-axis motive torquer (e.g., central motor 1) is set to rotate the shaft 36 in a given direction (e.g., CW direction). The start position in this method is with the pendulous gimbals 29 & 35 in the retracted-actuator (extended) configuration 162. Before the roll-axis motive torquer (e.g., central motor 1) is rotated in a CW direction, it is essential that the pendulous gimbals 29 be restrained or locked in the retracted-actuator (extended) position by activating the pitch-axis resistive torquer (e.g., locking device 38) and thereby temporarily neutralizing the original precession (i.e., first precessional torque). This passive delaying 261 of the first precessional torque redirects the torque axis of the first precessional torque perpendicularly (up to 90 degrees) to be parallel with the torque axis of the roll-axis motive torquer (e.g., shaft). While the pendulous gimbals 29 are pivoting in a direction away from the central motor 1 (and into the general direction of movement of the engine 99) they are also simultaneously stretching the tension springs 40 on the pitch axis. You will observe that the movement of the pendulous gimbals 29 and the associated precessable masses does not produce an equal and opposite reaction of the unit as a whole in the general direction of movement of the engine 99.

Phase Two of Method VI 291 (FIGS. 3B and 3C): After the pendulous gimbals 29 are in the extended-actuator (contracted) configuration then the power is turned off from the roll-axis motive torquer (e.g., central motor 1). Simultaneously the roll-axis resistive torquer (e.g., disk brake calipers 24 and brake disk 23) is immediately activated. This activation of the roll-axis resistive torquer immediately stops the roll-axis motive torquer (e.g., central shaft 36) from rotating. With the assistance of the tension springs 40 the pendulous gimbals 29 (with the attached motors 13 and rotors 14) will now swing back towards the central motor 1 on the pitch axis at an ever-increasing rate of acceleration and thereby resulting in the support frame of the precessable masses striking the shock absorbers 12 at the end of the thrust phase. The curved trajectory of the rotors 14 on the pitch axis will cause the rest of the MUTINT engine to move in the opposite direction wherein said opposite direction is in the general direction of movement of the engine 99. The net result is that the MUTINT engine moves more in one direction during Phase Two than it does in the other direction during Phase One. Once the pendulous gimbals 29 have returned to the retracted-actuator (extended) configuration, the two phases will repeat ad infinitum. NOTE: The “forward” portion of the Spring MUTINT engine is the end where the rotors 14 are located and the “rear” portion is the end of the MUTINT engine where the central motor 1 is located. NOTE: An alternate method of operation in Phase Two would be stop the rotor motors 13 from spinning in lieu of causing the roll-axis motive torquer (e.g., shaft 1) to cease rotation by the activation of the roll-axis resistive torquer (e.g., brakes 24). In this alternate method, the end of Phase Two would then require that the rotor motors 13 be turned on again before proceeding with Phase One. (See submethod C 292.)

### Operational Method VII 287 (Spring Overlapping Method):

This method uses the Spring MUTINT embodiment 153 which has a net movement in the opposite direction from the Pivot 151 and Spring 152 MUTINT embodiments given that the mechanical start configuration of the Spring MUTINT is the inverse of the Pivot MUTINT. In this method, the first axis is the roll axis and the third axis is the pitch axis. A variation to the above Operational Method (i.e., Method VI) would be to use the same steps as in Method VI but with the modification of quickly alternating between Phase One and Phase Two so that the residual rearward momentum of the precessable mass 14 in Phase Two becomes the equivalent of the damping forcing torque (i.e., braking) required for Phase One. In this scenario the locking mechanism 38 would not be needed since the residual momentum from the rearward motion would provide the needed damping forcing torque to damp the first precessional torque at the beginning of Phase One. Thus, there would be an instant where both phases overlap 232 in which Phase one would begin before Phase Two ends. After the damping forcing torque damps the first precessional torque then continue with the null phase by the continued rotation of the roll-axis motive torque (e.g., central motor) wherein said roll-axis motive torquer causes a first precessional torque that stretches the tension spring till the end of the travel of the null phase. At the end of the null phase stop the rotation of the roll axis motive torque and apply the brakes from the roll-axis resistive torquer. The springs will immediately begin pulling the pendulous arms in the opposite direction of the general direction of movement. At the end of the thrust phase a part of the supporting frame (e.g., pendulous gimbal) precessable masses will strike the shock absorbers. Simultaneous with the striking of the shock absorbers begin the null phase by activating the rotation of the roll-axis motive torquer.

### Operational Method VIII 288 (Rotary-Hurrying Method):

By way of introduction, the general concept for the Radius and Tangent rotary methods for the null phase is as follows. The null phase should have simultaneous action on both the first and the third axes wherein (for mechanical embodiments that have the rotor is centered on the gimbal such as the Tangent MUTINT and Radius MUTINT), the first axis is the pitch axis and the third axis is the roll axis. (NOTE: For mechanical embodiments where the precessable mass 14 is not centered but is on a pendulous gimbal (e.g., Tilt MUTINT), then first axis is the roll axis and the third axis is the pitch axis.) The motive torquer on the first axis generates a null-phase dampable forcing torque that induces the first precessional torque on the third axis. Said action on the first and third axes must result in the first precessional torque being transferred from the third axis back to the first axis. Thus, the motive torquer (on the first axis) by pivoting the spinning precessable mass causes a first precessional torque on the third axis.

The third-axis motive torquer damps the first precessional torque by either a hurrying or delaying of said first precessional torque. Said hurrying or delaying of the first precessional torque on the third axis will either increased in the angular velocity of the first axis pivoting (dampable forcing torque) or have a reverse pressure or torque that opposes the said angular velocity (dampable forcing torque). The damping forcing torque on the third axis for this method (during the null phase) should be of a greater magnitude than the dampable forcing torque on the first axis. NOTE: The above “general” description could be modified to having the first precessional torque being damped by another precessional torque (i.e., a pre-first precessional torque) wherein said pre-first precessional torque is a precessional torque that is of an opposing direction relative to the first precessional torque (and wherein said pre-first precessional torque is induced by a pivoting of the first-axis motive torquer in the opposite direction from that which will be used to induce the first precessional torque.) Said pre-first precessional torque would be briefly applied just prior to the inducing of the first precessional torque. By briefly applying (and then discontinuing) said pre-first precessional torque just prior to the first precessional torque, there will be a residual momentum left over from the pre-first precessional torque that will damp the first precessional torque. Thus, the residual momentum from the pre-first precessional torque will be simultaneous with the first precessional torque.

As for an introduction of the general concept in the rotary methods for the thrust phase, consider the following. The motive torquer on the third axis generates a thrust-phase dampable forcing torque that induces the second precessional torque on the first axis. The thrust phase, by using a damping forcing torque on the first axis redirects said second precessional torque from the first axis back to the third axis. The damping forcing torque on the first axis for this method should be of a greater magnitude than the dampable forcing torque on the third axis (for the thrust phase). NOTE: the above “general” description could be modified to having the axis of the precessable mass parallel to the axis of the motive torquer on the third axis (submethod D 293) or allow the rotor to naturally return to the start position (also submethod D 293) and then immobilize the pivoting of the first axis by the first-axis resistive torquer.

More specifically, Phase One of Operational Method VIII 288 (FIGS. 4A and 5A) is as follows. In the null phase for the centered-gimbal rotary MUTINTs 112 (e.g., Radius and Tangent MUTINTs), the null-phase damping forcing torque is produced by roll-axis motive torquer (e.g., the central motor 1) and the null-phase dampable forcing torque is produced by the pitch-axis motive torquer (e.g., gimbal step motor(s) 53). Thus, in the null phase for the Radius and Tangent MUTINTs, while the spinning rotor 14 is being displaced on the roll axis, the dampable forcing torque of a given pitch-axis motive torquer (e.g., gimbal step motor 53) on said first axis must be less than the damping forcing torque of the roll-axis motive torquer (e.g., central motor 1) on said third axis so as to allow the first precessional torque to be damped by said roll-axis motive torquer and the torque axis of said first precessional torque to be redirected to being substantially parallel to the first axis.

The over-arching strategy of method VIII is to redirect the torque axis of the first precessional torque from the roll axis to being parallel to the pitch axis during the null phase 211 and then redirect the torque axis of the second precessional torque from the pitch axis to being substantially parallel to the roll axis in the thrust phase 212. In the null phase, the simultaneous rotating of the roll-axis motive torquer e.g., central motor 1, (with the attached rotors 14) on said third axis and the pivoting action of said rotors 14 on said first axis induces a hurrying of the first precessional torque 262 if the roll-axis damping forcing torque is greater than the pitch-axis dampable forcing torque and if all forcing torques are in the correct direction. (Since there could be a plurality of rotors 14 and since a hurrying of precession 262 redirects the original precession by up to 90 degrees, then part of the engine could be constantly undergoing the null phase 211 and part of the engine could be constantly undergoing the thrust phase 212.) For simplicity of explanation, we will use the face of a watch as a reference (in a scenario where horizontal inertial thrust is desired). The explanation for operational method VIII will only discuss one of the rotors 14 (rotor one) since, should there be a plurality of rotors, the same would be done for the other rotor(s) as each rotor 14 passes a given “o'clock” position. For horizontal propulsion, the null phase for rotor one begins at the 3 o'clock position and continues in a CW direction to the 9 o'clock position. (For the purposes of the rotary MUTINT embodiments 112, the gimbal step motor's pivot direction on the first axis (i.e., CW or CCW) is determined as seen from the step motor 53 looking towards the rotor 14.)

The null phase 211 begins with the rotor 14 spinning in a given direction (e.g., a CW direction) on said second axis (i.e., spin axis) for the Radius MUTINT (CW for the Tangent MUTINT) and with the axis of the rotor substantially diagonal to the trajectory of the orbit of the precessable mass on the third axis for the Radius MUTINT 154. (The phrase “substantially diagonal,” in this method could be applied to mean 45 degrees or less and with the face of the rotor being diagonal with one part of the rim of the rotor at approximately the 10:30 position and the other side of the rim being at approximately the 4:30 position.) Pivot the pitch-axis motive torquer (e.g., gimbal motor) in a given direction (e.g., a CW direction). Simultaneously rotate the roll-axis motive torquer (e.g., central motor 1) on the third axis in a given direction (e.g., a CW direction). The pivoting of the precessable mass on the pitch axis will induce a first precessional torque that will have an axis of rotation that will coincide with the CW rotation of the roll-axis motive torquer and the associated pendulous subframe 52.

As the CW orbit progresses (due to the torque of the roll-axis motive torquer) on the third axis, the pitch-axis motive torquer (e.g., gimbal motor 53) on the first axis continues to pivot the gimbal 55 in a CW direction to complete at least ¼ of a turn. For the null phase, the dampable forcing torque that the pitch-axis motive torquer (e.g., gimbal step motor 53) exerts during the ¼ turn on the first axis should be less than the damping forcing torque caused by the roll-axis motive torquer (e.g., central motor 1) on the third axis. (Since, in the null phase, the torque from the central motor 1 on the third axis is relatively greater than that of the gimbal step motor 53 on the first axis, said ¼ turn should be completed shortly after the rotor 14 passes the 6 o'clock-position on the roll axis.) Said ¼ turn causes the rotor 14 to precess into the CW direction of orbit of the precessable mass on the third axis and, given the central motor's CW rotational direction on the third axis, said CW orbit hurries the first precessional torque 262. Since the first precessional torque is being hurried 262 by a damping forcing torque on the third axis, now the torque axis of said first precessional torque has been redirected to being substantially parallel to the torque axis of the first axis. This redirecting of the torque axis of said first precessional torque causes the axis of rotation of the pitch-axis motive torquer (e.g., rotor gimbal) to have a tendency (i.e., angular pressure) to pivot in a CCW direction. After the pitch-axis motive torquer (e.g., gimbal step motor 53) completes the ¼ turn, then the gimbal motor 53 stops pivoting the precessable mass on the first axis till the 9 o'clock position is reached (should said ¼ turn not already be completed).

The thrust phase 212, should horizontal propulsion be desired, begins at the 9 o'clock position and continues to the 3 o'clock position. At the 9 o'clock position, maintain the same magnitude of the forcing torque being exerted by the roll-axis motive torquer (e.g., central motor 1) on the third axis. The dampable forcing torque of the roll-axis motive torquer (e.g., central motor) will induce a second precessional torque that can cause the rotor gimbal 55 on the pitch axis (first axis) to pivot in a CCW direction by ¼ of a turn (if done appropriately). Said ¼ of a turn will return the rotor to the same position it had on the pitch axis at the start of the null phase. (See submethod D 293.) When the positioning of the rotor is configured as it was at the onset of the null phase then immobilized the pitch-axis motive torquer (e.g., gimbal step motor) until the 3 O'clock position is reached.

### Operational Method IX 289 (Bimodal Method):

The null phase 210 of Operational Method IX. This method has four cycles (first null phase, first thrust phase, second null phase, and second thrust phase.) This method uses a combination of the hurrying 262 and the delaying 261 of precession on a Radius 154 or of a Tangent 155 MUTINT. (See FIGS. 4A and 5A.) In this method, unlike some of the previous methods, the first axis is the pitch axis for the null phase and the third axis is the roll axis for the null phase. The strategy of this method is to alternate between hurrying on the first null phase and delaying on the second null phase. This changing between the hurrying and the delaying of the first precessional torque is accomplished by pivoting the rotor gimbal 55 on the pitch axis by up to ¼ of a turn in one direction during the first null phase and then reversing the direction of the pivot on the pitch axis for the second null phase. Since there could be a plurality of rotors 14 on rotary mechanical embodiments and since hurrying (and delaying) of precession redirects the original precession by substantially 90 degrees, one half of the engine could be constantly undergoing the null phase 211 and one half of the engine could be constantly undergoing the thrust phase 212. The explanation for operational method IX will discuss only one of the rotors (rotor one) since the same will be done for the other rotors when they pass a given “o'clock” position. The null phase for rotor one begins at the 3 o'clock position and continues till the 9 o'clock position.

For the purposes of the rotary MUTINT engine 112, the gimbal step motor pivot direction (i.e., CW or CCW) is determined as seen from the step motor 53 looking towards the rotor 14. The null phase begins with the rotor 14 spinning in a given direction (e.g., a CCW direction) for the Radial MUTINT (e.g., CW for the Tangent MUTINT). The position of the face of the rotor on the pitch axis is diagonal to the trajectory of the circular orbit the precessable mass on the roll axis.

Begin the first null phase by pivoting the rotor gimbal 55 in a given direction (e.g., a CW direction) on the pitch axis. As the gimbal 55 pivots on the pitch axis, simultaneously engage the roll-axis motive torquer (e.g., central motor 1). As the CW orbit of the precessable mass continues on the roll axis, the pitch-axis motive torquer (step motor 53) also continues to pivot the rotor gimbal 55 in a given direction (e.g., CW direction) to complete ¼ of a turn on the pitch axis. Since the dampable forcing torque from the pitch-axis motive torquer (gimbal step motor 53) must be less than the damping forcing torque from the roll-axis motive torquer (central motor 1) during the null phase then it is possible that only a portion of the ¼ turn will be completed (e.g., such as 3/16 of a turn) before the precessable mass passes the 9 O'clock position. Given that the rotor is spinning in a given direction (e.g., CW), the simultaneous application of a pitch-axis dampable forcing torque combined with the roll-axis damping forcing torque will cause a hurrying of the first precessional torque on the roll axis. Said hurrying will redirect the torque axis of the first precessional torque to become substantially parallel to the torque axis of the pitch-axis motive torquer and thereby decreasing the inertia of the precessable mass in the direction of the curved trajectory on the roll axis. (Said precessable mass is considered pendulous in that the subframe gives the precessable mass an offset and thereby rendering the precessable mass as pendulous.)

Begin the thrust phases at the 9 O'clock position and continue said thrust phases to the 3 O'clock position. In the first thrust phase, the roll-axis motive torquer continues to orbit the precessable mass. The torque that orbits said precessable mass is referred to as a thrust-phase dampable forcing torque. The pitch axis motive torquer, however, is turned off and the pitch-axis resistive torquer (e.g., the braking function of the step motor) is engaged. The resistive torque of the pitch-axis resistive torquer is a type of thrust-phase damping forcing torque. The resistive effect of the pitch-axis resistive torquer redirects the torque axis of the second precessional torque to be substantially parallel to the roll axis and thereby not decreasing the inertia of said precessable mass as it moves on a curved trajectory on the roll axis.

At this point begin the null phase again (i.e., the second null phase). However, this time reverse the direction (e.g., a CCW direction) that the precessable mass is pivoted on the pitch axis. This will cause a delaying of the first precessional torque. Said delaying will redirect the torque axis of the first precessional torque to become substantially parallel to torque axis of the pitch axis and thereby decreasing the inertia of the orbiting precessable mass in the direction of the axis of rotation that coincides with the roll axis. At this point begin the second thrust phase in a similar manner to that described above.

### Method X 295: (Modified-Brief Method).

Phase One of Operational Method I (FIGS. 1A and 2A): Persons of skill in the art will readily understand that Operational Method I can be varied by interchanging the first axis for the third axis and vice versa. Thus, the pitch-axis motive torquer (e.g., pneumatic cylinder 11) for this modified method becomes the first axis and the roll-axis motive torquer (e.g., roll-axis axle or shaft) now becomes the third axis. Also, only one precessable mass will be used in this method and the overall intended direction of movement is at right angles to Method I. (Thus, if the device is on wheels for horizontal movement, then the wheels should be pivoted by 90 degrees.)

The over-arching strategy of this alternate method during Phase One is to initially produce a null-phase dampable-forcing torque by extending the piston of the pitch-axis motive torquer (e.g., actuator) and thereby displacing the pendulous arms 29 and rotors 14. Upon being displaced by an actuator (such as a pneumatic cylinder), the rotors 14 will immediately have a tendency to precess and thereby rotate the roll-axis motive torque (e.g., shaft) on its axis of rotation. This precession is briefly disallowed (delayed) at the beginning of the pitch-axis motive torquer's movement (e.g., actuator's movement). This delaying of precession is done by a brief but strong countering torque (null-phase damping forcing torque) from the roll-axis resistive torquer (e.g., braking system) on the shaft which is now called the third axis. After a temporary resistive torque, the braking function is stopped and the pitch-axis motive torquer (e.g., actuator) finishes displacing the pendulous gimbal and attached precessable mass to the end of the oscillatory travel on the pitch axis. The precession caused by the stroke of the pitch-axis motive torquer (actuator) can cause the roll-axis motive torquer (e.g., shaft) to rotate nearly 180 degrees (if done correctly). If the desired movement is horizontal, said nearly 180 degrees could be seen as moving from substantially the 4 O'clock position to substantially the 8 O'clock position. This passive delaying of the first precessional torque by the braking of the shaft on the roll axis redirects the torque axis of said first precessional torque by up to 90 degrees to now be substantially parallel with the torque axis of the pitch-axis motive torquer (e.g., actuator). This is an application of inducing a delaying torque 261 on the first precessional torque.

Phase Two of Operational Method X 295 (FIGS. 1B, 1C, 2B, and 2C): After the pendulous gimbal 29 & 35 is in the retracted-actuator (extended) configuration then reverse the rotation of the roll-axis motive torquer (e.g., central shaft 28 & 36) by employing the precessional torque caused by retracting the actuator piston of the pitch-axis torquing system. First ensure that the roll-axis resistive torquer (e.g., braking mechanism such as disk-brake calipers 24 and brake disk 23) is disengaged from the roll-axis motive torquer (e.g., central shaft 28 & 36). Then activate the piston of the pitch-axis torquer (e.g., an actuator such as a pneumatic cylinder) by placing the air valve 27 in the out (“open”) position. The second precessional torque will cause the precessable mass 14 to pivot on the roll axis at an ever-increasing rate of acceleration and the support frame of the precessable masses will strike the shock absorbers 12 at the end of their oscillatory travel. (NOTE: The shock absorbers need to be resituated for this method from their original position in Method I.) The pitch-axis pivoting of the precessable mass will cause said precessable mass to precess and thereby rotate the roll-axis motive torquer shaft nearly 180 degrees. If the desired movement is horizontal, said nearly 180 degrees could be seen as moving from substantially the 8 O'clock position back to substantially the 4 O'clock position. This undamped movement of up to 180 degrees of the precessable masses by the precession caused by the pitch-axis motive torquer (e.g., actuator on a first axis) will cause the rest of the MUTINT engine to move in the opposite direction i.e., forward. The net result is that the MUTINT engine moves more in a forward direction during Phase Two than it does in a rearward direction during Phase One. Once the pendulous gimbal 29 & 35 returns to the extended-actuator (contracted) configuration 161, the two-phase operation will then be repeated ad infinitum. NOTE: The “rear” portion Pivot 151 and Flex 152 MUTINT engine is 90 degrees from where it is in Method I.

### Method XI 296 (Modified Partial-Delaying Method):

Phase One of Operational Method XI (FIGS. 1A and 2A): Persons of skill in the art will readily understand that Method III 283 can be modified by interchanging the first axis for the third axis and vice versa. Thus, the pitch-axis motive torquer (e.g., an actuator such as a pneumatic cylinder 11) becomes the first axis and the roll-axis motive torquer (e.g., the roll-axis shaft) becomes the third axis. Also, only one precessable mass 14 will be used in this method. Furthermore, the overall direction of movement is at right angles to Method III. (Thus, if the device is on wheels for horizontal movement, then the wheels should be turned by 90 degrees.)

The general strategy of this modified method during Phase One is to first produce a null-phase dampable-forcing torque by activating the pitch-axis motive torquer (e.g., actuator) to displace the pendulous gimbal 29 and precessable mass 14. Upon being extended by an actuator (such as a pneumatic cylinder), the precessable mass (e.g., rotor 14) will immediately have a tendency to precess and thereby rotate the roll-axis motive torquer (e.g., shaft) on what is now the third axis. This precession is partially resisted by a slight resistive torque (null-phase damping-forcing torque) from the roll-axis resistive torquer (i.e., a roll-axis shaft braking system) on the third axis. This partial resistance could last for up to 180 degrees of shaft rotation on said third axis (however a movement of less than 180 degrees is likely to be preferred). If the desired movement is horizontal, said movement of less than 180 degrees could be seen as moving from substantially the 4 O'clock position to substantially the 8 O'clock position. This passive and partial delaying of the first precessional torque redirects the axis of rotation of the precessional torque towards a perpendicular direction (by up to 90 degrees). This damping action partially redirects the torque axis of said first precessional torque towards a direction that is parallel to the first axis. The torque axis of the redirected precessional torque now coincides with the same direction as the axis of rotation of the pitch-axis motive torquer (e.g., actuator). This is an application of inducing a delaying torque 261 on the first precessional torque.

Phase Two of Operational Method XI 296 (FIGS. 1B, 1C, 2B, and 2C): After the pendulous gimbal 29 & 35 is in the retracted-actuator (extended) configuration then the rotation of the roll-axis motive torquer (e.g., central shaft) on the third axis is reversed by the precessional torque caused by the pitch-axis motive torquer (e.g., actuator) on the first axis. Ensure that the roll-axis resistive torquer (e.g., braking mechanism 24 such as disk-brake calipers 24 and brake disk 23) is disengaged from the roll-axis motive torquer (e.g., central shaft 28 & 36). Then activate the actuator piston of the pitch-axis motive torquer (e.g., pneumatic cylinder piston rod 10). As the piston (or equivalent) of the pitch-axis motive torquer moves on the first axis, the precessable mass (e.g., rotor motor 13 and the attached rotors 14) will pivot on the third axis (e.g., roll axis) due to the second precessional torque at an ever-increasing rate of acceleration and the support frame of the precessable masses will strike the shock absorbers 12 at the end of their travel. (NOTE: The shock absorbers will need to be resituated from the location that they were at in Method III.) The pivoting of the rotor 14 on the pitch axis will cause said rotor to precess on the roll axis and thereby rotate the roll-axis motive torquer (e.g., shaft) by up to 180 degrees. However, a movement of less than 180 degrees is likely to be preferred. If the desired movement is horizontal, said movement of less than 180 degrees could be seen as moving the precessable mass from substantially the 8 O'clock position back to the 4 O'clock position. This undamped movement of up to 180 degrees about the roll-axis motive torquer (e.g., roll-axis shaft) will cause the rest of the MUTINT engine to move in the opposite direction i.e., forward. The net result is that the MUTINT engine moves more in a forward direction during Phase Two than it does in a rearward direction during Phase One. Once the pendulous gimbal 29 & 35 returns to the extended-actuator (contracted) configuration 161, the two-phase operation will then be repeated ad infinitum. NOTE: The “rear” portion Pivot 151 and Flex 152 MUTINT engine is 90 degrees from where it is in Method IIIa. NOTE: It is during Phase Two that the actual forward thrust occurs.

### Method XII 297 (Modified Active-Delaying Method):

Phase One of Operational Method XII (FIGS. 1A and 2A): Persons of skill in the art will readily understand that Operational Method IV 284 can be modified by interchanging the first axis for the third axis and vice versa. Thus, the pitch-axis motive torquer (e.g., an actuator such as pneumatic cylinder 11) becomes the first axis and the roll-axis motive torquer (e.g., roll-axis shaft) becomes the third axis. Also, only one precessable mass will be used. Furthermore, the general direction of movement 99 is at right angles to Method VI. (Thus, if the device is on wheels for horizontal movement, then the wheels should be turned by 90 degrees.)

The general strategy of this modified method during Phase One is to first generate a null-phase dampable forcing torque by activating the pitch-axis motive torquer (e.g., by extending the actuator) to move the pendulous gimbal 29 and precessable mass (e.g., rotor 14). Upon being displaced in a curved trajectory by the pitch-axis motive torquer (e.g., pneumatic cylinder) on the first axis, the rotor 14 will immediately have a tendency to precess and thereby rotate the roll-axis motive torquer (e.g., shaft) on the third axis. This precession is aggressively countered (i.e., null-phase damping forcing torque) by rotating the roll-axis motive torquer (e.g., shaft) in the opposite direction of the induced precession. This countering of the precession will last for up to 180 degrees of shaft rotation on the third axis. However, since a movement of less than 180 degrees is likely preferred then the movement will be less. If the desired movement is horizontal then said movement of less than 180 degrees could be seen as moving from the 4 O'clock position to the 8 O'clock position. This active delaying of the first precessional torque redirects the axis of rotation of the first precessional torque substantially perpendicularly (by up to 90 degrees). This damping action (active delaying of precession) redirects the torque axis of the first precessional torque to a direction that is now parallel with torque axis of the pitch-axis motive torquer (e.g., actuator). This damped movement of up to 180 degrees about the roll axis (e.g., shaft) on the third axis will cause little or no rearward movement of the rest of the MUTINT engine. This is an application of inducing a delaying torque 261 on the first precessional torque.

Phase Two of Operational Method XII 297 (FIGS. 1B, 1C, 2B, and 2C): After the pendulous gimbal 29 & 35 is in the retracted-actuator (extended) configuration ensure that the roll-axis resistive torquer (e.g., braking mechanism 24) is disengaged. (NOTE: Using the retracted-actuator configuration to start the null or thrust phase is only for illustrative purposes. Use of the extended-actuator configuration is also acceptable to begin a given phase of operations.) Then reverse the rotational direction of the roll-axis motive torquer (e.g., central shaft) on the third axis by reversing the direction of the piston of the pitch-axis motive torquer (e.g., actuator piston) on the first axis. The rotor motor 13 (with the attached rotor 14) will pivot on the roll axis and the support frame of the precessable mass will strike the shock absorber 12 at the end of the travel of the precessable mass. (Note that the shock absorbers will need to be resituated from the location where they were located in Method IV.) The movement of the piston of the pitch-axis motive torquer will cause the precessable mass to precess on the roll axis and thereby rotate the shaft by up to 180 degrees. However, since a movement of less than 180 degrees is likely to be preferred and if the desired movement is horizontal said movement of less than 180 degrees could be seen as moving from the 4 O'clock position to the 8 O'clock position. This undamped movement of up to 180 degrees of the precessable mass on the third axis will cause the rest of the MUTINT engine to move in the opposite direction i.e., forward. The net result is that the MUTINT engine moves more in a forward direction during Phase Two than it does in a rearward direction during Phase One. Once the pendulous gimbal 29 & 35 returns to the extended-actuator (contracted) configuration 161, the two-phase operation will then be repeated ad infinitum. NOTE: The “rear” portion Pivot 151 and Flex 152 MUTINT engine is 90 degrees from where it is in Method IV.

### Method XIII 298 (Modified Active-Hurrying Method):

Phase One of Operational Method XIII (FIGS. 1A and 2A): Persons of skill in the art will readily understand that Operational Method V 285 can be modified by interchanging the first axis for the third axis and vice versa. Thus, the pitch-axis motive torquer (e.g., an actuator such as a pneumatic cylinder 11) becomes the first axis and the roll-axis motive torquer (e.g., roll-axis shaft) becomes the third axis. Also, only one precessable mass will be used. Furthermore, the overall intended direction of movement of the inertial thruster is at right angles to Method V. (Thus, if the device is on wheels for horizontal movement, then the wheels should be turned by 90 degrees.)

The general strategy of this alternate method during Phase One is to first generate a null-phase dampable-forcing torque by activating the motive-torquer function of the pitch-axis torquing system (e.g., by extending the actuator) to displace the pendulous gimbal 29 and precessable mass (e.g., rotor 14) on a curved trajectory on the pitch axis (i.e., first axis). Upon being displaced by the pitch-axis motive torquer (e.g., an actuator such as a pneumatic cylinder) on the first axis, the rotor 14 will immediately have a tendency to precess and thereby rotate the roll-axis motive torquer (e.g., roll-axis shaft) on the third axis. This first precessional torque on the roll axis needs to be further accelerated (i.e., a damping forcing torque) by rotating the roll-axis shaft on the third axis in the same direction as the induced precession (i.e., first precessional torque). This acceleration of the first precessional torque will last for up to 180 degrees of shaft rotation on the third axis. However, a movement of less than 180 degrees is likely to be preferred. If the desired movement is horizontal said movement of less than 180 degrees could be seen as moving from substantially the 4 O'clock position to the 8 O'clock position. This active hurrying of the first precessional torque redirects the torque axis of said first precessional torque substantially perpendicularly (by up to 90 degrees). The torque axis of said first precessional torque in now substantially parallel with the torque axis of the pitch-axis torquing system (e.g., actuator) on the first axis. This damped movement of the curved trajectory of the precessable mass of up to 180 degrees about the roll-axis (e.g., the shaft) will cause little or no rearward movement of the rest of the MUTINT engine. This is an example of applying a hurrying torque 261 on the first precessional torque.

Phase Two of Operational Method XIII 298 (FIGS. 1B, 1C, 2B, and 2C): After the pendulous gimbal 29 & 35 is in the retracted-actuator (extended) configuration then the rotation of the roll-axis motive torquer (e.g., central shaft) is reversed by the effect of the second precessional torque caused by reversing the direction of the pitch-axis motive torquer (e.g., actuator). At the same time ensure that the roll-axis resistive torquer (e.g., braking mechanism 24) is disengaged from the roll-axis motive torquer (e.g., central shaft 28 & 36), and also ensure that the (central motor) is not engaged. The rotor motor 13 (with the attached rotor 14) will be displaced on a curved trajectory on the pitch axis once the actuator rod of the pitch-axis motive torquer (e.g., pneumatic cylinder piston rod 10) is activated. The curved trajectory of the rotor 14 on the pitch axis will cause said rotor to precess on the roll axis and thereby rotate the shaft by up to 180 degrees. However, a movement of less than 180 degrees is likely to be preferred. If the desired movement is horizontal said movement of less than 180 degrees could be seen as moving from substantially the 8 O'clock position back to the 4 O'clock position. This undamped movement of up to 180 degrees will cause the rest of the MUTINT engine to move in the opposite direction i.e., forward. The net result is that the MUTINT engine moves more in a forward direction during Phase Two than it does in a rearward direction during Phase One. Once the pendulous gimbal 29 & 35 returns to the extended-actuator (contracted) configuration 161, the two-phase operation will then be repeated ad infinitum. NOTE: The “rear” portion Pivot 151 and Flex 152 MUTINT engine is 90 degrees from where it is in Method V.

### Overview of Methods XIV Through XVII.

The methods described below can be used for the Tilt MUTINT embodiment 156. These same methods, however, can also be used on other embodiments either directly without modification or said methods can be easily adapted to the mechanical embodiments of this specification as well to embodiments not described. Note that for the Tilt MUTINT that the first axis is the roll axis and the third axis is the pitch axis. It is important to take into consideration for the Tilt MUTINT methods below as well as for all methods indicated in this specification is that there are at least two types of null-phase damping torques that damp the dampable torques. The first null-phase damping torque is the null-phase damping-forcing torque and the second is a null-phase damping-precessional torque. The null-phase damping-forcing torque is a function that can be accomplished by either the motive torquer or the resistive torquer of given axis. Either of the motive torquers of a given torquing system can cause a null-phase damping forcing torque and thereby damp the dampable forcing torques and redirect a precessional torque (such as the first or second precessional torques). A given motive torquer has the additional capability of causing a damping-forcing torque that induces a damping precessional torque (e.g., pre-first precessional torque). Thus, a damping forcing torque can induce a precessional torque wherein said precessional torque can damp other precessional torques. An example of this is the pre-first precessional torque that can damp the first precessional torque.

In the Tilt MUTINT engine and in the other embodiments as well, what happens on one axis usually affects what happens on another axis. For example, by pivoting a shaft of said engine on a third-axis, wherein the pivoting of said shaft on the third axis, moves at least one precessable mass associated with said shaft, wherein said at least one precessable mass has precession-related motion on a second axis, wherein upon moving of said at least one precessable mass on said third axis, and upon having precession-related motion of said at least one precessable mass on said second axis, either a reverse precessional torque or a forwards precessional torque is induced on a first axis.

The above paragraph also works for the first axis. By pivoting a shaft of said engine on said first-axis, wherein the pivoting of said shaft moves at least one precessable mass associated with said shaft, wherein said at least one precessable mass has precession-related motion on said second axis, wherein upon moving of said at least one precessable mass on said first axis, and upon having precession-related motion of said at least one precessable mass on said second axis, either a reverse precessional torque or a forwards precessional torque is induced on said third axis.

Now that we have clearly described how one axis affects the other, we are now ready to describe the two phases of the inertial-thruster methodology as relates to the Tilt MUTINT engine and to the other MUTINT engines as well. To define a null phase, we begin by applying a null-phase damping torque (i.e., damping forcing torque or a damping precessional torque) and a null-phase dampable-forcing torque, wherein said null-phase dampable-forcing torque is caused by said pivoting of the shaft on the third axis and thereby inducing a first-precessional torque on said first axis, wherein said null-phase dampable-forcing torque is applied for a majority of the null phase, and wherein at least one null-phase damping torque redirects the torque axis of said first precessional torque in a different direction.

To define a thrust phase, we can begin by applying a thrust-phase dampable-forcing torque on the first axis that causes a curved trajectory of said precessable mass on said first axis, wherein said thrust-phase dampable-forcing torque creates a second precessional torque on said third axis, if said precessable mass has precession-related motion, and applying a thrust-phase damping forcing torque that damps said second precessional torque of the at least one precessable mass on said third axis, wherein said thrust-phase damping forcing torque either redirects said second precessional torque in a different direction, if said at least one precessable mass spinning, or does not redirect said second precessional torque if spinning (i.e., precession-related movement) of said at least one precessable mass is stopped, and wherein the movement of the at least one precessable mass causes an opposite reaction that produces a unilinear or curvilinear motion of the engine that is substantially forward and in said general direction of movement of the engine 99.

The above mentioned null-phase damping torque can have multiple variations. One such variation is when said null-phase damping torque is damping precessional torque such as a pre-first precessional torque. (See Method XIV 301 for a rotary version and see Method XVII 304 for an oscillatory version.)

Another variation is when the null-phase damping torque is a damping forcing torque such as a forward residual momentum that is left over from the orbiting of said precessable mass that occurred on said first axis during said thrust phase. (See Operational Method XV 302.)

A third variation is when said null-phase damping torque is a damping forcing torque such as a forward motive torque caused by the first-axis motive torquer wherein said forward motive torque is caused for a majority of said null phase. (See Operational Method XVI 303.)

A fourth variation is when said null-phase damping torque is damping forcing torque such as a temporary resistive torque caused by said first-axis resistive torquer. (See Operational Method XVIII 305.)

### Operational Method XIV 301 (Temporary-Reverse Method):

This method is especially applicable to the Tilt MUTINT embodiment 156 (FIG. 6A) wherein the first axis is the roll axis and said third axis is the pitch axis. This method is also relevant to the Tangent MUTINT embodiment 155 (wherein the first axis becomes the pitch axis and the third axis becomes the roll axis.)

The steps below, however, are described with the Tilt MUTINT in mind. (To help adapt the following method for use with the Tangent MUTINT, substitute the first axis for the third axis and also substitute the third axis for the first axis.) For this method, the first-axis motive torquer (on the roll axis) is powered for most, if not all, of the thrust phase. Movement on the third axis (pitch axis) during the thrust phase is mostly restricted (braked, immobilized, or reversed). There can, however, be exceptions for having pitch-axis movement during the beginning and end portions of said thrust phase.

What makes Method XIV 301 unique is that, for a rotary method, the null-phase damping torque is a pre-first precessional torque on the first-axis caused by a third-axis damping forcing torque, wherein said pre-first precessional torque causes a rearward momentum that becomes residual once the damping forcing torque is stopped and wherein said pre-first precessional torque is substantially in the opposite direction to the general direction of movement of the engine, wherein said rearward residual momentum is instantly followed by said first-precessional torque, wherein the delaying of precession caused by said pre-first residual momentum causes the redirection of the torque axis of said first precessional torque in a different direction.

The thrust phase, for horizontal inertial propulsion in Method XIV, begins with the precessable mass at substantially the 9 O'clock position and said thrust phase continues with the precessable mass orbiting on the roll axis till substantially the 3 o'clock position. Begin the thrust phase by orbiting the precessable mass on the first axis (e.g., roll axis) in a given direction (e.g., CW) with the precessable mass spinning in a given direction (e.g., CCW). The orbiting of the spinning precessable mass by the roll-axis motive torquer will cause a second precessional torque on the third axis (e.g., pitch axis). A thrust-phase damping forcing torque needs to be applied to said second precessional torque so as to redirect said second precessional torque to be shifted by 90 degrees. Said thrust-phase damping forcing torque is accomplished by either passively resisting (e.g., braking or immobilizing) the precessional movement of said third-axis (e.g., pitch axis) or by actively reversing the second precessional torque on the third axis. (There is also the option of turning off the precession-related movement (e.g., spin) of the precessable mass during the thrust phase so that Newton's third-law reaction occurs.) The general strategy for the thrust phase of this method is to displace the precessable mass from substantially the 9 O'clock to the 3 O'clock position with the goal of maximizing reactivity. Said reactivity moves the entire engine in the opposite direction, be it linear or rotary.

At the beginning of the null phase (or near the end of the thrust phase), when the precessable mass is in close proximity to the 3 O'clock position, cause a counter precession that create a temporary (i.e., brief) delaying of the first precessional torque. Said counter precession (i.e., pre-first precessional torque) is induced by tilting the precessable mass (e.g., with a left-ward tilt) on the third axis (e.g., pitch-axis) so as to cause a temporary reverse precessional torque (e.g., CCW) on the roll axis. Said brief or temporary reverse precessional torque is a null-phase damping precessional torque that will be referred to as the pre-first precessional torque. Said tilting of the pendulous precessable mass (e.g., applying a leftward tilt) on the third axis (i.e., pitch axis) will have a tendency to precess the precessable mass in a rearward (e.g., CCW) direction on the first axis (i.e., roll axis). With said null-phase damping precessional torque causing the precessable mass to have a reverse (e.g., CCW) pressure (or momentum) on the roll axis, apply a null-phase dampable-forcing torque (of a more moderate magnitude) by changing the direction of the tilt (e.g., apply a rightward tilt) on the third axis (pitch axis) so that precessional torque is now moving the precessable mass in a forward (e.g., CW) direction on the first axis (roll axis). Said “brief reverse precessional torque” (pre-first precessional torque) causes a residual momentum that will damp the first precessional torque. The residual momentum (i.e., glide effect or coasting) from said pre-first precessional torque on the first axis counteracts the rearward reaction of the engine as a whole to the first precessional torque that occurs once the precessable mass begins to precess in a forward direction (e.g., CW) on the first axis (roll axis) during the beginning of the null phase. Said first precessional torque is due to the pivoting of the pendulous precessable mass on the third axis (e.g., pitch axis) which is a function of the third-axis motive torquer.

As said first precessional torque continues to be induced on the roll axis by the null-phase dampable-forcing torque on the pitch axis, said precessable mass will precess towards the 9 O'clock position, in a forward (e.g., CW) direction. This forward precession will have little or no rearward reaction on the entire engine given that the usual rearward reactive movement was counteracted by the residual momentum from the said pre-first precessional torque. It is important to note that, as an additional operational step, it may be necessary to power the orbit of the precessable mass on the roll axis after the pre-first first precessional torque has been terminated. The powering of the roll-axis orbit can take the form of applying a motive torque on the first axis (e.g., roll axis) or the form of applying a resistive torque on said first axis. Said pre-first precessional torque can be followed by the activation of said first-axis motive torquer for a majority of said minimized thrust phase wherein said first-axis motive torque is applied simultaneously with said first precessional torque. These changes in acceleration can assist in redirecting the first precessional torque in an orthogonal direction during the null phase.

NOTE: Said pre-first precessional torque on the roll axis can be executed by different types of hardware. Some examples are as follows: 1) a guide track that functions as the pitch-axis resistive torquer wherein said guide track suddenly curves upward near the end of the thrust phase 2) a guide track that functions as the pitch-axis resistive torquer wherein an actuator pulses the end of track outwardly at the time that the null phase begins, or 3) or by a pitch-axis motive torquer (e.g., step motor or spring) motorizing an outward tilt of the pendulous precessable mass on the pitch axis.

Near the end of the null phase and in close proximity to the 9 O'clock position return the pendulous precessable mass to the same angle of incidence on the pitch axis that said mass had at the beginning of the thrust phase. This is done by the functionality of the third-axis (e.g., pitch axis) motive torquer. This return of the pendulous precessable mass to the start position on the pitch axis could cause a brief rearward (e.g., CCW) precessional torque on the first axis (and therefore a forwardly reaction of the entire engine). Said brief rearward (e.g., CCW) precessional torque is referred to as the post-first precessional torque. Since said post-first precessional torque causes a reaction of the entire engine in the desired direction (i.e., forward), no damping is needed.

### Introduction to Methods XV and XVI.

The above counteracting (e.g., damping) of the reactivity to the null-phase first precessional torque at the beginning of said null phase (by using said pre-first precessional torque) could also be achieved by at least two other methods (Methods XV and XVI).

### Operational Method XV 302 (Rotary Overlapping Method):

What makes Operational Method XV 302 unique from method XIV is that the null-phase damping torque is a forward residual momentum that is left over from the orbiting of said precessable mass on said first axis during said thrust phase, wherein the hurrying of precession caused by said forward residual momentum redirects the torque axis of said first precessional torque in a different direction.

What we have is a residual forward momentum of the precessable mass on the first axis that is left over from the thrust-phase dampable-forcing torque wherein said residual forward torque has a velocity that is greater than the anticipated forward velocity of the null-phase first precessional torque. Said first precessional torque is caused by the activating of a third-axis motive torquer that applies a null-phase dampable-forcing torque that is of a lesser magnitude than the residual forward momentum from the thrust-phase dampable-forcing torque (wherein as said residual forward momentum now a null-phase damping forcing torque). The simultaneous combination of the residual momentum from the thrust-phase dampable-forcing torque and the first precessional torque will together cause a hurrying of precession during the null phase. Said hurrying of precession will minimize the rearward reaction of the engine as a whole caused by the initiation of said first precessional torque at the onset of the null-phase portion of the orbit on the roll axis. To achieve proper functioning, it may also be necessary to add the additional operational step of powering the orbit of the precessable mass on the roll axis at the time of the first precessional torque. Said powering can take the form of applying a forward motive torque on the first axis (e.g., roll axis) or by applying resistive torque (e.g., braking or temporary immobilization) on said first axis. Either form of acceleration assists in redirecting the first precessional torque in an orthogonal direction during the null phase.

### Operational Method XVI 303 (Tilt-Motive Method):

What makes this method unique from method XIV is that the null-phase damping torque is a forward motive torque caused by the first-axis motive torquer for a majority of said null phase, wherein the hurrying of precession caused by said forward motive torque of the first-axis motive torquer, redirects the torque axis of said first precessional torque in a different direction. This method uses a first-axis forward velocity (i.e., damping forcing torque) effected upon the precessable mass by a roll-axis motive torquer during the majority of the null phase wherein said forward velocity is executed simultaneously with a third-axis fractional pivoting of the pendulous mass that is caused by the pitch-axis motive torquer. Bear in mind that this third-axis fractional pivoting of said pendulous mass (null-phase dampable-forcing torque) should be of a lesser torque than the first-axis damping forcing torque effected by the roll-axis motive torquer. By doing this, said first-precessional torque is hurried in a forward (e.g., CW) direction by the roll-axis damping forcing torque. The hurrying of precession will redirect the torque axis of the first precessional torque to be substantially parallel to that of the pitch axis.

### Operational Method XVII 304 (Oscillatory Tilt Method):

What makes Method XVII 304 unique is that, for an oscillatory method, the null-phase damping torque is a pre-first precessional torque on the first-axis caused by a third-axis damping forcing torque, wherein said pre-first precessional torque causes a rearward residual momentum that is substantially in the opposite direction to the general direction of movement of the engine 99, wherein said rearward residual momentum is instantly followed by said first-precessional torque in such a way that the rearward residual momentum is simultaneous with the first precessional torque, wherein the delaying of said first precessional torque is caused by said pre-first residual momentum that causes the redirection of the torque axis of said first precessional torque in a different direction.

This method does not cause the precessable mass to make a full rotation (orbit) on the roll axis. Said precessable mass oscillates back and forth with the thrust phase being the rearward oscillation and the null phase being the forward oscillation. (“Forward” is relative to the general direction of movement of the engine 99.) This method uses a delaying 261 of precession during the thrust phase and null phases. This method is especially applicable to the Tilt MUTINT embodiment 156 (FIG. 6A) wherein the “first axis” is the roll axis and the “third axis” is the pitch axis. This method is also relevant to the Tangent MUTINT embodiment 155 (FIG. 5A) wherein the “first axis” becomes the pitch axis and the “third axis” becomes the roll axis. The steps below, however, are written for the Oscillatory Tilt MUTINT which is a methodical modification of the Rotary Tilt MUTINT. For this method, the first-axis motive torquer (on the roll axis) is powered for most, if not all, of the thrust phase. Movement on the third axis (pitch axis) during the thrust phase is mostly restricted (e.g., braked or immobilized) by the pitch-axis resistive torquer. (There are, however, exceptions for having pitch-axis movement during the beginning and end portions of said thrust phase.)

The thrust phase, for horizontal inertial propulsion, begins with the precessable mass at substantially the 2 O'clock position (e.g., anywhere from the 1:30 to 3 O'clock positions) and said thrust phase continues in a CCW direction on the roll axis till substantially the 10 O'clock position (e.g., anywhere from the 9 O'clock to 10:30 positions). Begin the thrust phase by pivoting the precessable mass on the first axis (e.g., roll axis) with the roll-axis motive torquer in a given direction (e.g., CCW) with the precessable mass spinning in a given direction (e.g., CCW). The forced orbiting of the precessable mass with precession-related motion (e.g., spinning) on the roll axis will cause said second precessional torque on the third axis (e.g., pitch axis). A thrust-phase damping forcing torque needs to be applied to said second precessional torque so as to redirect the torque axis of said second precessional torque to be shifted in an orthogonal direction so that now the torque axis of the second precessional torque is parallel to the torque axis of the roll axis. Said thrust-phase damping forcing torque is accomplished by resisting (e.g., braking or immobilizing) said second precessional torque by activating the pitch-axis resistive torquer. (There is also the option of turning off the precession-related motion e.g., spin, of the precessable mass during the thrust phase so that Newton's third-law reaction occurs wherein the spin is started up again before the null phase commences.) The strategy for the thrust phase of this method is to displace the precessable mass from substantially the 2 O'clock to the 10 O'clock positions with the goal of maximizing reactivity by damping the second precessional torque. Said reactivity to the thrust phase's movement on the roll axis moves the entire engine in the opposite direction, be it linear or rotary.

At the beginning of the null phase (or near the end of the thrust phase), when the precessable mass is in close proximity to the 10 O'clock position, stop the thrust-phase resistive torquing and simultaneously cause a precessional torque that will have the effect of briefly delaying the anticipated first precessional torque. Said effect of briefly delaying is done by fractionally tilting the precessable mass (e.g., with a left-ward tilt) on the third axis (e.g., pitch-axis) so as to cause a brief rearward precessional torque that is in the same direction the previous thrust-phase roll-axis movement (e.g., CCW). (It is referred to as “brief” because the null phase will immediately reverse the direction of the oscillation caused by the brief rearward precessional torque.) Said brief rearward precessional torque is a damping precessional torque that is referred to as the pre-first precessional torque. With said pre-first precessional torque being in a CCW direction it causes the precessable mass to have a forward (e.g., CW) reaction on the roll axis. With the residual rearward (e.g., CCW) momentum on the roll axis, instantly switch the direction of the tilt on the pitch axis by applying a null-phase dampable-forcing torque (e.g., apply a rightward tilt) so that first precessional torque is now moving the precessable mass in a forward (e.g., CW) direction on the first axis.

Said pre-first precessional torque does its work by causing a residual momentum (i.e., glide effect or coasting) that counteracts the reaction to the first precessional torque that occurs once the precessable mass begins to precess in a forward direction (e.g., CW) on the first axis (roll axis) during the beginning of the null phase. Said first precessional torque will have little or no rearward reaction on the entire engine given that the usual rearward reactive movement was counteracted by the reactive momentum from the damping forcing torque (that induced said pre-first precessional torque).

NOTE: Said reversal of direction of precessional torque (pre-first precessional torque) on the roll axis can be executed by different types of hardware. Some examples are as follows: 1) a guide track that functions as the resistive torquer wherein said guide track suddenly curves upward near the end of the thrust phase 2) a guide track that functions as the resistive torquer wherein an actuator pulses the end of track outwardly (on the pitch axis) just before as the null phase begins, or 3) or by a pitch-axis motive torquer (e.g., step motor or spring) motorizing an outward tilt of the pendulous precessable mass on the pitch axis.

Near the end of the null phase and in close proximity to the 2 O'clock position (and/or during the beginning of the thrust phase) return the pendulous precessable mass to the same angle of incidence that said mass had at the beginning of the thrust phase. This is done by the functionality of the third-axis (e.g., pitch axis) motive torquer. This return of the pendulous precessable mass to the start position on the pitch axis could cause a brief rearward (e.g., CCW) precessional torque (using the null-phase direction of orbit as a reference) on the first axis (and therefore a forwardly reaction of the entire engine). Said brief rearward (e.g., CW) precessional torque is referred to as the post-first precessional torque. Since said post-first precessional torque causes a reaction of the entire engine in the desired direction (i.e., forward), no damping is needed.

### Operational Method XVIII 305 (Tilt Resistive Method):

What makes this method unique is that the null-phase damping torque is a resistive torque caused by the first-axis resistive torquer at the onset of said null phase, wherein the delaying of precession caused by the first-axis resistive torque, redirects the torque axis of said first precessional torque in a different direction.

This method has a first-axis resistive torque (i.e., damping forcing torque) effected upon the first precessional torque of the precessable masses by a roll-axis resistive torquer temporarily at the onset of the null phase wherein said resistive torque causes a delaying of the first precessional torque. This temporary delaying of precession at the onset of the null phase is executed simultaneously with a fractional third-axis pivoting of the pendulous mass that causes said first precessional torque. Said first precessional torque is not temporary but continues for a majority of the null phase. Bear in mind that this third-axis pivoting of said pendulous mass (null-phase dampable-forcing torque) should be of a lesser torque than the first-axis damping forcing torque caused by the roll-axis resistive torquer. By doing this, said first-precessional torque is passively delayed by said null-phase damping forcing torque. The delaying of the first precessional torque will redirect the torque axis of the first precessional torque to be substantially parallel to the pitch axis.

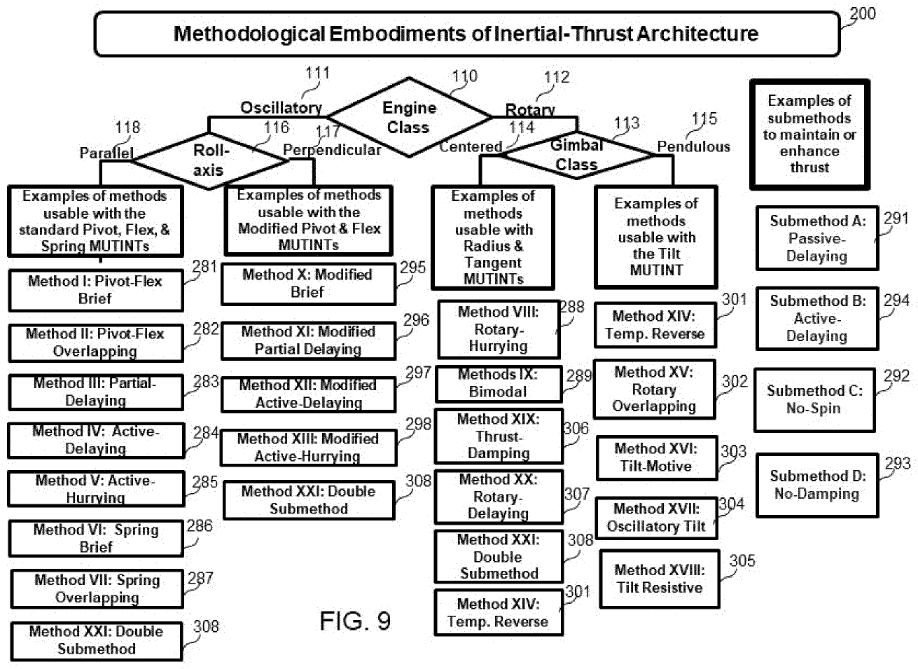

The thrust phase for Operational Method XVIII 305 will use one of the four submethods (A, B, C, or D) listed on FIG. 9. Of special significance is submethod A 291.

### Operational Method XIX 306 (Thrust-Damping Method):

A variation for Method VIII (Rotary-Hurrying Method 288) is to conduct the null phase similar to the Rotary-Hurrying Method 288 but modify the thrust phase. In the thrust phase maintain (or decrease) the same given direction of rotational velocity (e.g., CW) of the roll-axis motive torquer (e.g., central motor 1) on the third axis but increase the velocity of the pitch-axis motive torquer (e.g., gimbal motor 53) on the first axis. (See submethod B 294.) In this modification of the thrust phase, the roll-axis torquing system is generating the dampable forcing torque and the pitch-axis torquing system is generating the damping forcing torque. Once the ¼ reverse turn is complete, temporarily immobilize i.e., turn off, the pitch-axis motive torquer (e.g., gimbal step motor 53) on the first axis. In this Phase-Two scenario, the dampable forcing torque from the roll-axis motive torque (e.g., central motor 1) on the third axis should be less than the damping forcing torque from the pitch-axis motive torque function of the pitch-axis torquing system (e.g., gimbal step motor 53) on the first axis. After the ¼ turn is completed now the axis of the rotor 14 is as it was at the start of the null phase (i.e., in a diagonal configuration). At this point the continued dampable forcing torque from the roll-axis motive torquer will cause the spinning rotor 14 to have a tendency to precess in a CCW direction (direction determined when looking outwards from the roll-axis motive torquer) on the pitch axis. Since the rotor's second precessional torque on the pitch axis will be passively 241 resisted 261 or immobilized (delayed) by the pitch-axis resistive torquer, it will cause for the torque axis of said second precessional torque to be redirected by up to 90 degrees and thereby become substantially parallel to the axis of rotation of the third axis and will therefore not negate the inertia gained by the displacement of the rotor's mass 14. NOTE: A given torque exerted on either the first or third axes does not necessarily involve angular movement. Torque, for this disclosure, can also the presence of pressure or force to twist in a given direction without the twisting motion actually taking place (as is the case in the thrust phase of this method).

### Operational Method XX 307 (Rotary-Delaying Method):

Another variation for Method VIII (Rotary-Hurrying Method 288) is to apply a delaying of precession technique wherein the rotor is spinning in a given direction (e.g., a CCW direction) for both the null and thrust phases. For this method the third axis is the roll axis and the first axis is the pitch axis. The null phase 211 begins with the rotor 14 spinning in a given direction (e.g., CCW direction) on said second axis (spin axis) for the Radius MUTINT (CW for the Tangent MUTINT) and with the axis of the rotor in a diagonal position on the pitch axis (e.g., 45 degrees or less with the face of the rotor being substantially a 1:30/7:30 position, for the Radius MUTINT 154.) Pivot the gimbal motor in a CW direction on the pitch axis. Simultaneously engage the roll-axis motive torquer (e.g., central motor 1) on the third axis with a relatively greater torque than the pitch-axis motive torquer (e.g., gimbal motor). The pivoting of the precessable mass on the first axis will have a tendency to reverse (delay) the CW rotation of the central motor and pendulous subframe 52. As the CW orbit progresses (due to the central motor's torque) on the third axis, the gimbal motor 53 on the first axis continues to pivot the gimbal 55 in a CW direction to complete ¼ of a turn. The dampable forcing torque that the gimbal step motor 53 exerts during the ¼ turn on the first axis should be less than that of the central motor 1 (damping forcing torque) on the third axis. (Since, in the null phase, the torque from the central motor 1 on the third axis is relatively greater than that of the gimbal step motor 53 on the first axis, said ¼ turn should be completed shortly after the rotor 14 passes the 6 o'clock-position.) Said ¼ turn causes the rotor 14 to precess opposing the CW direction of orbit on the third axis and, given the central motor's CW rotational direction on the third axis, said CW orbit delays the original precession 262. Since the original precession is being delayed 161, now the torque axis of said first precessional torque has been redirected to being parallel to the torque axis of the pitch axis. The rotor gimbal will also have a tendency/pressure to pivot in a CW direction. After the gimbal step motor 53 completes the ¼ turn, then the gimbal motor 53 stops pivoting the precession unit on the first axis till the 9 o'clock position is reached.

A modification in the thrust phase would be to maintain the same CW rotational velocity (or diminish said velocity) of the central motor 1 on the third axis but increase the torque of the gimbal motor 53 on the first axis. The CW rotation of the roll-axis motive torquer (e.g., central motor) will cause the precessable mass to have a tendency to pivot in a CW direction on the pitch axis. As this CW rotation continues on the third axis, then simultaneously orbit the gimbal in a CCW direction on the roll axis to cause a delaying of the precession caused by the pivoting motion on the third axis. Once the ¼ reverse turn is complete, temporarily immobilize i.e., turn off, the gimbal step motor 53 on the first axis. In this Phase-Two scenario, the torque from the central motor 1 on the third axis should be less than the torque from the gimbal step motor 53 on the first axis. After the ¼ turn is completed now the axis of the rotor is diagonal to the tangent of the orbit for the Radius MUTINT. Since the rotor's second precessional torque will be actively 241 resisted 261 (delayed) by a reversal of the gimbal step motor's direction on the pitch axis, said reversal will cause for the torque axis of the second precessional torque to be redirected by up to 90 degrees and thereby become substantially parallel to roll axis. Given that the torque axes are now substantially aligned, a movement of the precessable mass in a curved trajectory on the roll axis will not negate the inertia gained by the displacement of said precessable mass 14.

At this point repeat Phase One again, ad infinitum. NOTE: A variation would be to stop the spinning of the rotor motor 13 on the second axis at the beginning of the thrust phase and restart it at the beginning of phase one however that would deprive said thrust phase of any advantage gained from precessional redirection.

### Operational Method XXI 308 (Double-Submethod Method):

Per the definition used in this disclosure, the overall level of inertia of the precessable mass during the null phase (in the direction of the curved trajectory) is relatively less than the overall level of inertia of the precessable mass during the thrust phase. This allows for the usage of back-to-back submethods to create inertial thrust. In Phase One, for this method, use submethod C 292 or submethod D 293. In Phase Two, for this method, use submethod A 291 or submethod B 294. Thus, the precessable mass in Phase One would have the usual inertial reactivity and in Phase Two said precessable mass would have an increased level of inertial reactivity in the direction of the curved trajectory. The inequality of inertial levels between the phases allows for the creation of a net inertial thrust in the general direction of movement of the engine.

### Operational Submethod A 291 (Passive-Delaying Submethod):

Submethod A is a restatement, in generalized terms, encompassing many of the Phase-Two (thrust-phase) methods. This method is a prolonged 252 submethod because a third-axis dampable forcing torque causes a second-precessional torque on the first axis wherein said second precessional torque is passively delayed 241 for the majority of Phase Two. The passive resistance caused by the third-axis resistive torquer (e.g., shaft brake, the resistive function of the gimbal motor, or a guide track) resists (delays) 241 the second precessional torque on the first axis (pitch axis or roll axis depending on the methodological embodiment) and thereby redirects the torque axis of said second precessional torque in a substantially perpendicular direction onto the third axis (pitch axis or roll axis depending on the method). Said substantially perpendicular redirection of the torque axis of the second precessional torque is now parallel to the third axis. Said redirection of the second precessional torque enhances the forward movement of the MUTINT during the thrust phase. For more specific information, consult Phase Two of the preceding operational methods. NOTE: Though the Prolonged-Passive Method 291 is the method most frequently described in the above methodological explanations yet the No-spin method 292 (See below.) can also be adapted to Phase Two for any methodological embodiment.

### Operational Submethod B 294 (Active-Delaying Submethod):

Submethod B encompasses many of the Phase-Two (thrust-phase) methods. This method is referred to as “prolonged” 252 because a third-axis dampable-forcing torque causes a second-precessional torque on the first axis wherein said second precessional torque is actively delayed 242 for the majority of Phase Two. The active resistance caused by the third-axis resistive torquer (e.g., actuator or motor) reverses the second precessional torque on the first axis (pitch axis or roll axis depending on the method) and thereby redirects the torque axis of said second precessional torque in a substantially perpendicular direction onto the third axis (pitch axis or roll axis depending on the method). Said perpendicular redirection of the torque axis of the second precessional torque is now parallel to the third axis. Said redirection therefore enhances the forward movement of the MUTINT during the thrust phase. For more specific information, consult Phase Two of the preceding operational methods.

### Operational Submethod C 292 (No-Spin Submethod):

This submethod is used when no damping and no precession-related motion (e.g., spinning or vibration) is desired during the thrust phase wherein the thrust phase terminates or lessens the second precessional torque for a duration of the thrust phase by stopping or slowing a spinning of the at least one precessable mass. Said second precessional torque on said first axis is induced only if said precessable mass has precession-related motion (e.g., spinning). A given thrust-phase damping forcing torque redirects the torque axis of said second precessional torque in a different direction, if said precessable mass is spinning, or does not redirect the torque axis of said second precessional torque in a different, if spinning of said precessable mass is stopped.

In this method the precession-related movement (e.g., spinning or vibration) of the precessable mass can be stopped for the duration of the thrust phase. However, the cessation of precession-related movement deprives the thrust phase of any inertial enhancements that occur when actively or passively redirecting said second precessional torque during the thrust phase. Submethod C can be adapted to Phase Two of numerous methodological embodiments.

### Operational Submethod D 293 (No-Damping Submethod):

This submethod is used when precession-related motion (e.g., spinning or vibration) is ongoing however, if any precessional torque is induced during this phase, said precessional torque is not damped. Note that this submethod allows for either a precession that is not damped or a precession that is not induced. Precession is not induced, for example, if the face of the rotor is aligned with the direction of the angular movement. The rotor is called “saturated” or in state of saturation when this occurs. Intentionally saturating a precessable mass is a useful technique especially during the thrust phase.

As to automating the five MUTINT embodiments 100, persons of skill in the art will know that if automation is used in any of the preceding Operational Methods that sensors 21 & 22 can be activated when the rotors 14 and the associated arms 29 have precessed to the desired position. The adjustable sensors 21 & 22 (or other method such as manual or pre-programmed signals/pulses) will send signals to the Programmable Automation Module 17 to turn the power off or on to the central motor 1 & 26; to apply the brake calipers 24; to modulate the speed and torque of a given motor, and any other such function to execute the full range of methodology without constant human intervention or oversight.

### Glossary

a: is defined as one or as more than one.
acceleration: the rate of change of velocity of an object with respect to time. Acceleration comprises
an increase in velocity as well as a decrease of velocity.
action: a thing done wherein there may or may not be a comparable reaction produced as a result.
active damping: this is the dynamic excitation or minimization of an oscillation wherein a dynamic movement redirects, negates, or amplifies a precessional torque or another angular or linear movement.
actuator: a mechanical device that is either a complete torquing system in that it can cause both motive and resistive torque. It can be referred to as a motive torquer or a resistive torquer depending on the function it is completing in a given context. It is a device for moving or controlling something.
ad infinitum: again and again. in the same way.
angular velocity: is the time rate of change of angular displacement of a mass relative to the origin.
an: is defined as one or as more than one.
another: is defined as at least a second or more.
arc: a continuous portion (as of a circle or ellipse) of a curved line.
architecture: the conceptual structure and logical organization of an inertial thruster system wherein both methodological and mechanical embodiments are integrated.
axis (Singular of axes): The imaginary line around which something rotates or could rotate. Multiple axes are often, but not necessarily, orthogonal to each other. A given axis may be either at a right angle (orthogonal) to another axis or a given axis could be diagonal to another axis.
axle: the bar, rod, tube, or shaft on which rotates components of the machine or apparatus.
bar collar: a ring-like device that goes over a tube, axle, or a shaft and that has protruding bar or rods to which accessories can be mounted.
bimodal: a device employing two types of precessional damping within its method of operations.
braking caliper: an element of a resistive torquer that forms part of brake system that uses a pinching action to cause the brake pads to press onto the disk or other moving surface.
braking mechanism: a resistive torquer device capable of applying a braking action.
braking: the act or process of slowing or stopping a rotor, axle, shaft, or pendulous gimbal in order to keep it stationary or immobilized.
brief torque duration; the passive resisting of precession for a partial portion of a phase.
circular trajectory: rotation along a circular path. It can be uniform, with constant angular rate of rotation and constant speed, or non-uniform with a changing rate of rotation.
circular: resembling, or shaped like a circle or an ellipse whether two dimensional or three dimensional.
class: a set or category of things having some property or attribute in common and differentiated from others by kind, type, or quality.
clock wise (CW): in the direction of the rotation of the hands of a clock as viewed from the front or above; circularly to the right from a point taken as the top.
co-located: to locate or be located in jointly or together, as two or more units wherein they share space on the same mechanical device or platform.
configuration: an arrangement of elements in a particular form, figure, or combination.
pendulous arm: a flexible or rigid beam, tube, lever, rod, gimbal, or plate that has one end attached to a rotating shaft and the other end attached to a precession unit. Also referred to as “connecting arm.”
contracted configuration: the configuration of oscillatory inertial thrusters when the pendulous gimbals are contracted and diagonal (or nearly parallel) to the shaft. Said contracted configuration is an example of the range of motion of a given embodiment but it is not intended to limit the full range of oscillation available to persons of skill in the art. Said full range of motion is 180 degrees for an oscillatory embodiment. Also referred to as extended-actuator configuration.
counterbalance: a weight, mass, force, or torque that balances or offsets an opposing weight, mass, force, or torque.
counter-clock wise (CCW): in the opposite direction to the way in which the hands of a clock move around.
couple: is defined as connected, although not necessarily directly, and not necessarily mechanically.
coupled: is defined as connected, although not necessarily directly, and not necessarily mechanically.
curved trajectory: the arc or full circle described by an object moving while attached to a machine.
dampable-forcing torque: an oscillation or precessional movement that is the subject of receiving an external (forcing) torque. Dampable-forcing torques can cause at least three types of precessional torques: first precessional torque, post-first precessional torque and second precessional torque. This term was formerly referred to as “damped-forcing torque” (with or without the hyphen.)
damping category: the category of damping that is comprised of passive and/or active damping.
damping torques: a torque that damps a dampable torque or a precessional torque. There are at least two types of damping torques 1) damping-forcing torque which is a function of the motive torquer and the resistive torquer that redirects a precessional torque (e.g., first and second precessional torques) and 2), a damping precessional torque that damps another precessional torque and that was itself induced by a damping forcing torque.
damping-forcing torque: is the torque that redirects the original precession by the use of a hurrying or precession or of a delaying of precession.
damping: is the use of an additional external torque or resistance to reverse, redirect, absorb, and interfere with precession, precessional torque, oscillations, movements, or vibrations in such a way that said movements are either amplified or diminished. There are at least two types of damping: active damping and passive damping. Damping comprises an influence within or upon a precessional system that has the effect of modifying precessional torque.
degrees of freedom: in a mechanics context, are specific, defined modes in which a mechanical device or system can move. The number of degrees of freedom is equal to the total number of independent displacements or aspects of motion. There are at least two types of degrees of freedom: rotational and translational.
delaying of precession: this is a torque direction wherein precession is reversed, resisted, retarded, or delayed in such a way that precessional movement is opposed. Similar to “delay of precession.”
device: a thing made or adapted for a particular purpose, especially a piece of mechanical or electronic equipment.
diagonal: a slanting straight pattern or line. This term does not imply any specific angle other than not being parallel and not being perpendicular.
direction: the line or course on which something is moving or is aimed to move or along which something is pointing or facing.
discreet phase: a phase that is individually separate and distinct from the other.
displace: to cause (something) to move from its place. To translate from one position or location to another.
displaceable gyroscopic rotor: a spinnable or rotatable rotor that can be moved or displaced.
displaceable: capable of being displaced or moved.
distinct phase: a phase that does not overlap with the other phase but is separate.
drivetrain: the group of components that delivers power from the motor or supplier of rotational power to the axle, shaft, rotors, precessable mass, pendulous subframe, and/or pendulous gimbals. Same as “drive train.”
duration: the length of time that something lasts.
embodiment: reference throughout this document to “one embodiment’, ‘illustrative embodiments,’ ‘certain embodiments’, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.
engine: a machine or mechanical device that converts motion, movement, torque, precession, or kinetic energy into linear or rotational movement.
enhance: to increase or improve the performance or quality of a trait, action, or condition.
erratic motion: is any precession-related motion, other than spinning or vibration, that acts upon a mass and that is capable of causing an orthogonal movement or precessional torque when said mass is displaced with an angular torque.
extended configuration: the positioning of the pendulous gimbals of an oscillatory device wherein said pendulous gimbals are fully out or protruding. Also referred to as retracted-actuator configuration.
flexible material: the flexible matter or substance from which a thing is made.
follows the other in succession: coming one after the other; repeats.
forcing torque: a torque that either creates precessional torque or that redirects or modifies said precessional torque. There are at least two types of forcing torques: dampable-forcing torque and damping forcing torque.
forward: a relative term referring to the direction that coincides with the general direction of movement 99 of the inertial thruster.
gearing: something that consists of gears or gear-like material.
gimbal: a mechanism that can be pivoted at right angles.
gyroscope: a device consisting of a mass, bar, disk, or weight that is mounted so that it can vibrate, spin, orbit, or rotate wherein said mass, bar, disk, or weight can be of any shape or configuration so long as precession or orthogonal movement can be induced.
having: is defined as comprising (i.e., open language).
hinge (noun): a movable joint or mechanism on which an arm or lever swings as it moves.
hinge (verb): to attach or join with or as if with a hinge.
horizontal: parallel to, in the plane of, or operating in a plane parallel to the horizon or to a baseline.
hurrying of precession: a torque direction wherein precession is hurried or accelerated in the same direction that it was already moving.
including: is defined as comprising (i.e., open language).
induce: to do something, bring about or give rise to, bring on.
inertia: a property of matter by which it remains at rest or in uniform motion in the same straight line unless acted upon by some external force.
inertial thrust: the force or push created by an inertial thruster.
inertial thruster: A device that achieves rectilinear movement without any reactive engagement with a supporting surface or fluid medium. It is substantially synonymous to an inertial-propulsion device and a reactionless drive.
laterally oriented: acting or placed at right angles (or nearly right angles) to the line of motion or of strain.
thrust phase: the phase or stroke of an inertial propulsion device that generates more thrust than the null phase. The thrust phase is also referred to as the “maximized-thrust phase.”
means: when this term precedes a present participle of an operation indicates a desired function for which there is one or more embodiments, i.e., one or more methods, devices, or apparatuses for achieving the desired function and that persons of skill in the art could select from these or their equivalent in view of the disclosure herein and use of the term “means’ is not intended to be limiting.
medium: a substance that makes possible the transfer of energy or force from one location to another.
methodology: a system or grouping of methods and/or submethods and/or techniques.
null phase: the phase or stroke of an inertial propulsion device that generates less reactive thrust than the thrust phase. The null phase is also referred to as the “minimized-thrust phase.”
mode of movement: the way, method, technique, fashion, or manner in which something moves or is displaced.
motor shaft: is a rotating machine element, usually circular in cross section, which is used to transmit power from one part to another, or from a machine which produces power to a machine which absorbs power. The various members such as pulleys and gears are mounted on it.
motor: a machine that supplies motive power for an engine, machine, transmission, or for some other device with moving parts.
motorized precessable mass: a rotor or mass that has a motor or power source attached so that said rotor or mass will spin, orbit, rotate, or vibrate and so that precession can be induced or caused at will.
movement: a change in position of an object over time.
No-Damping Method 292: the method used to achieve or enhance inertial thrust wherein the rotors are not actively precessing.
optional: available to be chosen but not obligatory.
object: the device, vehicle, spacecraft, free body, or extremity of a free body that an inertial thruster is attached to so as to provide attitude control, stabilization, or propulsion to said object.
or: is to be interpreted as an inclusive or meaning any one or any combination. An exception to this definition will occur only when a combination of elements, functions, steps or acts are in some way inherently mutually exclusive.
orbit: the curved path or trajectory of an object or component of a machine.
orbital: relating to an orbit or orbits.
original precession: the first precession that is induced or the precession that is produced by the dampable-forcing torque or the applied torque. Often referred to a first precessional torque if induced during the null phase or second precessional torque if induced during the thrust phase.
orthogonal: of or involving right angles; at right angles. The words “orthogonal” and “substantially orthogonal” refer to the relative orientation of various rotation axes and/or vectors in three-dimensional space. These words are intended to describe, merely by way of example, a preferred arrangement or embodiment and are not intended to be limiting. It is not necessary that the vectors or axes be 90 degrees apart, merely that they not all be parallel.
oscillatory: to swing or move back and forth either in a straight line or on a curved trajectory.
overlapping: not distinct but with shared time or space. The effects of one action or force has an affect or impact on the following force or precession
overlapping phase: a phase that is not distinct from the following phase in that both, for a portion of their duration, occur at the same time.
parallel: aligned side by side should the lines be extended indefinitely. The words “parallel” and “substantially parallel” refer to the relative orientation of various rotation axes and/or vectors in three-dimensional space. These words are intended to describe, merely by way of example, a preferred arrangement or embodiment and are not intended to be limiting. It is not necessary that the vectors or axes be perfectly aligned, merely that they not all be perpendicular.
parallel orientation: lines, planes, surfaces, or objects that are aligned side by side and are basically equidistant.
passive damping: the lessening of precession by the static resistance that counters the precession.
passive torque: torque that is static in nature such as that caused by friction.
pendulous: having pendulum-like characteristics.
pendulous precessable masses: a precessable mass that is not centered on a gimble. An offset gimbal wherein the pendulous extension is directly attached to the precessable mass or wherein the pendulous mass is housed in a centered pitch-axis gimbal and both the pendulous mass and the centered gimbal are pendulously attached to an element of the roll-axis torquing system (e.g., shaft).
pendulum: a rod, bar, or lever that is attached to a fixed point on which it can oscillate, move, or swing.
perpendicular: at right angles or substantially at right angles. The same as “orthogonal.” The words “perpendicular” and “substantially perpendicular” refer to the relative orientation of various rotation axes and/or vectors in three-dimensional space. These words are intended to describe, merely by way of example, a preferred arrangement or embodiment and are not intended to be limiting. It is not necessary that the vectors or axes be 90 degrees apart, merely that they not all be parallel.
phase: the relationship in time between the successive states or cycles of a repeating system.
pitch: the steepness of a slope.
platform: a structure or machine on which mechanical devices can be mounted.
plurality: is defined as two or as more than two.
position: posture, alignment, or arrangement of a mechanical device capable of multiple configurations.
powertrain: the main components of an apparatus that generates power and delivers it to the rest of the machine.
precessable: any orthogonal or diagonal movement that occurs when an angular torque is applied to a mass that has precession-related motion such as spinning or vibrating.
precessable mass: is a spinnable rotor, vibrating structure gyroscope, Coriolis vibratory gyroscope, cylindrical resonator gyroscope, piezoelectric gyroscopes, tuning-fork gyroscope, vibrating-wheel gyroscope, or a seismic mass that can induce an orthogonal torque when said at least one precessable mass is spun or vibrated, as well as displaced on a curved trajectory.
precession-related motion: motion such as spinning, vibrational motion, elliptical motion, or erratic motion acting upon a mass that is capable of causing an orthogonal movement or precessional torque when said mass is displaced with an angular torque wherein said orthogonal movement is achieved without regard to the its source be it precession, Coriolis effect, centrifugal force, or other force or effect.
precession units: all of the components related to or rigidly attached to a precessable mass, such as a spinning rotor, vibrating structure gyroscope, Coriolis vibratory gyroscope, cylindrical resonator gyroscope, piezoelectric gyroscopes, tuning fork gyroscope, or a vibrating wheel gyroscope.
precession: is any orthogonal or diagonal movement that occurs when a torque is applied to a mass that has precession-related motion such as spinning, vibrational motion, elliptical motion, or erratic motion, wherein said torque is the movement of the axis of a spinning or vibrating body around another axis due to a torque acting to change the direction of the first axis. Said orthogonal or diagonal movement can be the result of conservation of momentum, inertial force, centrifugal force, Coriolis effect and/or any other such causational force or effect.
Precessional torque: the first precession that is induced or the precession that is produced by the dampable-forcing torque or the applied torque. Often referred to a first precessional torque if induced during the null phase or second precessional torque if induced during the thrust phase.
pressure: is the angular or rotational force that exerts force in a given direction but with little or no noticeable movement.
profit: a financial gain, especially the difference between the amount earned and the amount spent in buying, operating, or producing something.
prolonged: the duration for the hurrying or delaying of precession that lasts most (or all) of a phase.
propel: to drive, push, or cause to move in a particular direction.
propulsive: tending or having power to propel.
protruding ends of subframe: the ends of the subframe that extend away from the center.
radial alignment: an alignment that radiates outwardly like the spokes of a wheel.
rate of movement: the rate at which something moves, is done, or acts.
reaction: an occurrence that may or may not be of the same degree or magnitude as the action that initiated said occurrence.
reactive: showing a response or reaction to a stimulus or action.
rearward: a relative term referring to the direction that opposes the net direction of movement of the inertial thruster.
rectilinear: consisting of, or moving in a straight line.
redirect: to change the course or direction of.
Redirected precessional torque: Precessional torque that has been redirected by being subjected to a damping procedure such as the hurrying or delaying of precession. Said redirected precessional torque may be the same in magnitude as the precessional torque or of an even greater magnitude than the precessional torque or may be of a lesser magnitude than the precessional torque.
redirection: the changing of the course or direction of precession.
reset spring: the spring that returns the pendulous gimbal to its original place or position.
reset: to move (something) back to an original place or position.
rigid material: material that is stiff and difficult to bend. Not flexible.
rotary: (of motion) revolving around a center or axis; rotational.
rotatable frame: a frame that can be revolved around a center or axis; rotational frame.
rotatable structure: a structure that can be revolved around a center or axis.
rotation: the action of rotating, spinning, or orbiting around an axis or center.
rotor: the rotating member of a machine or device that is capable of inducing precession; the rotating or spinning portion of a gyroscope or of a mass capable of being precessed.
saturation state: where all momentum vectors are aligned. This state, referred to as a ‘singularity state’, prevents the system from being able to produce torque in one or more directions
second direction of rotation: A direction of rotation that may be the same or different that a first direction of rotation.
shock absorber: a device for absorbing jolts, impact, angular momentum, and/or vibrations wherein the momentum from an accelerating rate of movement is absorbed by at least one shock absorber at an end of a phase.
signal generator: a device that generates a repeating or non-repeating electronic or mechanical signal in either the analog or the digital domain.
Simultaneous: happening at the same time.
spin: a rotation around an axis. Spin, when referring to a precessable mass, also includes any movement of said precessable mass be it spinning, vibrating, oscillating, or any erratic motion.
spinning: a spin motion or something that spins.
spring: a resilient device, typically a helical metal coil, that can be pressed or pulled but returns to its former shape when released.
step motor: a motor which converts electrical pulses into discrete mechanical movements wherein the shaft or spindle of said motor rotates in discrete step increments when electrical command pulses are applied to it in the proper sequence. Also called a stepper or stepping motor.
strategic damping: damping that involves the hurrying or delaying of precession and ideally should be executed with the correct timing, for the correct duration, in the correct direction on a three-dimensional scale, with the correct category, and with the correct magnitude.
subframe: a supporting frame or a pendulous frame.
synchronization link: a rigid bar, lever, or plate, that is attached to the pendulous gimbal and to a point on the central shaft so that all of the pendulous gimbals move in unison.
System: one or more components to accomplish one or more functions wherein said components can be either physically connected or separated and located on different parts of the engine.
tangential alignment: the alignment with the tangent of the circular orbit of a device.
thrust: a force or a push.
torque direction: positive or negative torque. Also called the hurrying of precession or the delaying of precession.
torque: a twisting force that tends to cause rotation. Torque can be either the actual angular movement or it can also be pressure or force in an angular direction with little or no noticeable movement.
torque-induced precession (gyroscopic precession): is the phenomenon in which the axis of a spinning object moves at right angles to the direction that would normally result from the external torque. The same as gyroscopic precession.
torquer: is a system comprising an array of one or more components for applying forcing torque and modifying torque to a thruster wherein the forcing and modifying torques can be passive or active. Said array can be co-located or located on different parts of the thruster torquing system: a system for applying motive and/or resistive torques to a rotor having precession-related motion and/or to moveable components on an engine or on a machine so as to displace mass and/or modify the direction of the original precession. A means for conveying and controlling rotational energy.
trajectory: the curved or linear path followed by an object moving through space or while connected to a rotating device.
travel: the length of a mechanical stroke or movement.
unimodal: using a single mode or technique.
vertical: at right angles to a horizontal plane; in a direction, or having an alignment, such that the top is directly above the bottom.
worm gear: a mechanical arrangement consisting of a toothed wheel worked by a short revolving cylinder (worm) bearing a screw thread.
worm-gear motor: a motor using a gear arrangement in which a worm (which is a gear in the form of a screw) meshes with a worm gear. Said motor has the advantage of being internally braked and therefore resists back-driveability.

What is claimed is:

1. An inertial-thruster engine comprising:
a first-axis torquing system configured to cause a forcing torque on a first axis in a forward or reverse direction,
At least one precessable mass associated with said first-axis torquing system wherein said precessable mass is pendulous, and wherein said precessable mass is configured to cause a precession-related motion on a second axis in a forward or reverse direction,
A third-axis torquing system associated with said first-axis torquing system and said precessable mass, wherein said third-axis torquing system is configured to cause a forcing torque on a third axis in a forward or reverse, wherein upon an angular movement of said at least one precessable mass on either said first axis or on said third axis, and upon having a precession-related motion of said at least one precessable mass on said second axis, a precessional torque is induced on either said first axis or said third axis, wherein said first-axis torquing system and said third-axis torquing system are able to simultaneously cause a redirection of said precessional torque.

2. The internal thruster-engine of claim 1, wherein the first-axis torquing system further comprises a first-axis motive torquer and a first-axis resistive torquer, wherein said first-axis motive torquer causes, as needed, a forward or a reverse angular movement of said precessable mass on said first axis, and wherein said first-axis resistive torquer causes, as needed, a first-axis resisting of angular movement of said precessable mass on said first axis.

3. The inertial-thruster engine of claim 1, wherein the third-axis torquing system further comprises a third-axis motive torquer and a third-axis resistive torquer, wherein said third-axis motive torquer causes, as needed, a forward or a reverse angular movement of said precessable mass on said third axis, and wherein said third-axis resistive torquer causes, as needed, a third-axis resisting of angular movement of said precessable mass on said third axis.

4. The inertial-thruster engine of claim 1, wherein said precessable mass is pendulously associated, either directly or indirectly, to said third-axis torquing system.

5. The inertial-thruster engine of claim 1, wherein said precessable mass in pendulously associated, either directly or indirectly, to said first-axis torquing system.

6. The inertial-thruster engine of claim 1 wherein said precession-related motion comprises at least one of a spinning motion, a vibrational motion, an erratic motion, or an elliptical motion.

7. The inertial-thruster engine of claim 1, wherein said first-axis torquing system can cause a first-axis torque wherein said first-axis torque can resist a first-axis movement and can induce a first-axis movement of said at least one precessable mass in either a substantially perpendicular direction relative to said first axis or a substantially parallel direction relative to said first axis.

8. The inertial-thruster engine of claim 7, wherein said first-axis movement is a first-axis displacement that causes a curved trajectory of said at least one precessable mass.

9. The inertial-thruster engine of claim 1 wherein said third-axis torquing system is configured to cause a third-axis torque wherein said third-axis torque is capable of resisting a third-axis movement and can induce a third-axis movement of said at least one precessable mass in either said substantially perpendicular direction relative to said third axis or said substantially parallel direction relative to said third axis.

10. The inertial-thruster engine of claim 9, wherein said third-axis movement is a third-axis displacement that causes said curved trajectory of said at least one precessable mass.

11. The inertial-thruster engine of claim 1, wherein said third-axis torquing system can cause a third-axis torque at the same time that said first-axis torquing system causes a first-axis torque, wherein a combination of torques causes a redirection of the torque axis of said precessional torque in either a substantially perpendicular direction or a substantially parallel direction.

12. The inertial-thruster engine of claim 1, wherein said redirection of precessional torque comprises at least one of a modification of the magnitude of precessional torque without changing direction, a maintaining of the same magnitude of precessional torque in another direction, an increase of the magnitude of precessional torque in another direction, or a decreasing of the magnitude of precessional torque in another direction.

13. A method for operating an inertial-thruster engine comprising:
rotating a shaft of said engine in a first direction of rotation on a first axis, wherein the rotating of said shaft moves at least one precessable mass associated with said shaft, wherein said at least one precessable mass has precession-related motion in a second direction of rotation on a second axis, wherein upon moving of said at least one precessable mass on said first axis, and upon having a precession-related motion of said at least one precessable mass on said second axis, a first precessional torque is induced on a third axis, and
wherein the torque axis of said first precessional torque comprises a force that has an axis that is either substantially perpendicular to the roll axis of the engine or substantially parallel to the roll axis of the engine;
to define a null phase, applying a null-phase damping forcing torque on said third axis simultaneously with a null-phase dampable-forcing torque caused by the pivoting of the shaft on said first axis, wherein the null-phase damping forcing torque actively or passively damps said first precessional torque, wherein said null-phase damping forcing torque redirects the torque axis of said first precessional torque in a different direction; and
to define a thrust phase, applying a thrust-phase damping forcing torque that damps a second precessional torque of the at least one precessable mass on said first axis and applying a thrust-phase dampable-forcing torque that causes a curved trajectory of the precessable mass on said third axis, wherein said thrust-phase dampable-forcing torque creates said second precessional torque on said first axis if said precessable mass has said precession-related motion, wherein said thrust-phase damping forcing torque either redirects the torque axis of said second precessional torque in a different direction if said at least one precessable mass has precession-related motion, or does not redirect the torque axis of said second precessional torque if said precession-related motion of said at least one precessable mass is stopped, and wherein the movement of the at least one precessable mass causes an opposite reaction that produces a unilinear or a curvilinear motion of the engine substantially forward and in said general forward direction of movement of the engine.

14. The method of claim 13, wherein the precession-related motion of said precessable mass can be replaced by other precession-related motions such as a vibrational motion, an erratic motion, an elliptical motion, or a spinning motion.

15. A method for operating an inertial-thruster engine comprising:
rotating a shaft of said engine in a forward or reverse direction of rotation on a first axis, wherein the rotating of said shaft displaces at least one precessable mass associated with said shaft, wherein said at least one precessable mass has precession-related motion on a second axis in a forward or reverse direction, wherein upon displacing of said at least one precessable mass on said first axis or said third axis, and upon having a precession-related motion of said at least one precessable mass on said second axis, a first precessional torque or a second precessional torque is induced on said first or said third axis, and
wherein said first precessional torque comprises a force that is either substantially rearward and opposite to the general direction of movement of the engine or substantially forward and in the general direction of movement of the engine; and
to define a null phase, applying a null-phase damping torque on said third axis simultaneously with a null-phase dampable-forcing torque caused by the rotating of the shaft on the first axis, wherein the null-phase damping torque which actively or passively damps said first precessional torque on said third axis, wherein said null-phase damping torque causes a redirecting of the torque axis of said first precessional torque in a substantially perpendicular direction that is substantially parallel to said first axis, and wherein said redirecting of the torque axis of said first precessional torque minimizes a rearward reaction of the engine in said minimized thrust phase; and
to define a thrust phase, applying a thrust-phase damping torque to reverse, restrict, or stop the rotating of the shaft on said first axis and simultaneously applying a thrust-phase dampable-forcing torque that reverses a curved trajectory of the at least one precessable mass on said third axis, and wherein said thrust-phase dampable-forcing torque displaces the at least one precessable mass and causes an opposite reaction that produces a unilinear or curvilinear motion of the engine substantially forward and in said general direction of movement of the engine in said thrust phase.

16. The method of claim 15, wherein said first precessional torque comprises a force that is substantially forward and in the general direction of movement of the engine, wherein applying a positive torque as the null-phase damping forcing torque on said third axis actively damps said first precessional torque by further accelerating a curved trajectory of said at least one precessable mass substantially forward and in the general direction of movement of the engine, and wherein said null-phase damping forcing torque is greater than said first precessional torque.

17. The method of claim 15, wherein said first precessional torque comprises a force that is substantially rearward and opposite to the general direction of movement of the engine, and wherein applying a negative torque as the null-phase damping forcing torque on said third axis actively damps said first precessional torque by displacing said at least one precessable mass in a curved trajectory that is substantially forward and in the same general direction of movement of the engine, and wherein said null-phase damping forcing torque is greater than said first precessional torque.

18. The method of claim 15, wherein said first precessional torque comprises a force that is substantially forward and in the general direction of movement of the engine, and wherein the applying of said null-phase damping forcing torque on said third axis damps said first precessional torque by immobilizing the displacement of said at least one precessable mass on said third axis, reversing the displacement of said at least one precessable mass on the roll axis, instantly reversing the curved trajectory of said at least one precessable mass on said third axis, or applying a partial resistance to the curved displacement of said at least one precessable mass on said third axis.

19. The method of claim 18, wherein said immobilizing of the displacement of said at least one precessable mass is done, wherein the immobilizing is applied as said null-phase damping forcing torque on said third axis before precession begins and only during a beginning of said null phase with said immobilizing continuing only until the torque axis of said first precessional torque is redirected to an axis that is substantially parallel to said first axis, and wherein said null-phase damping forcing torque is of a force greater than said first precessional torque.

20. The method of claim 19, wherein said immobilizing of the displacement of said at least one precessable mass on said third axis is done by stopping a curved trajectory of said at least one precessable mass from moving into substantially the same direction as said general direction of movement of the engine by activating said third-axis torquing system to counter said first precessional torque from displacing said at least one precessable mass substantially forward and in the general direction of movement of the engine, and wherein said third-axis torquing system comprises at least one of a third-axis motive torquer or a third-axis resistive torquer.

21. The method of claim 19, wherein said immobilizing of the displacement of the at least one precessable mass on said third axis is done by locking said at least one precessable mass to restrain said at least one precessable mass from moving substantially forward and in the general direction of movement of the engine.

22. The method of claim 18, wherein said partial resistance is applied to said first precessional torque, wherein said partial resistance comprises a passive damping that slows the curved displacement of the at least one precessable mass on said third axis for a duration of said null phase, wherein the minimizing of a rearward reaction of the engine is achieved by said partial resistance of the first precessional torque resulting in the redirection of the torque axis of said first precessional torque, and wherein said passive damping generates a resistance less than that of said first precessional torque.

23. The method of claim 15, wherein the at least one precessable mass is displaced by said null-phase damping forcing torque at a constant angular velocity on said third axis so as to redirect the torque axis of said first precessional torque on said third axis to be substantially parallel to said first axis during said null phase, wherein said null-phase damping forcing torque is greater than said first precessional torque, and wherein said first precessional torque comprises a force that is substantially rearward and opposite to the general direction of movement of the engine.

24. The method of claim 15, wherein said thrust-phase dampable-forcing torque creates a second precessional torque on said first axis if said precessable mass is spinning, wherein said thrust-phase damping forcing torque redirects the torque axis of said second precessional torque in a different direction, if said precessable mass is spinning, or does not redirect the torque axis of said second precessional torque in a different, if spinning of said precessable mass is stopped.

25. The method of claim 24, wherein the minimized thrust phase and the thrust phase follow one another in succession and are discrete or partially overlap with one another.

26. The method of claim 24, wherein said null phase and said thrust phase partially overlap with one another, wherein a reversal of the curved trajectory of the at least one precessable mass on said third axis during a portion of said thrust phase initially generates a negative torque that causes a resistance and a delaying of precession at an onset of said null phase, wherein said resistance is from a rearward momentum of the at least one precessable mass during said thrust phase, and wherein said rearward momentum is opposite to the general direction of movement of the engine.

27. The method of claim 24, wherein the thrust phase, if said precessable mass is spinning, redirects the torque axis of the said second precessional torque to an axis that is substantially parallel to said third axis, and wherein said at least one precessable mass has a curved trajectory with a torque axis that is substantially aligned with said third axis.

28. The method of claim 24, wherein the thrust phase terminates or lessens the second precessional torque for a duration of the thrust phase by stopping or slowing a spinning of the at least one precessable mass.

29. The method of claim 24, wherein the thrust phase displaces the at least one precessable mass at an accelerating rate of movement.

30. The method of claim 29, wherein the momentum from said accelerating rate of movement is absorbed by at least one shock absorber at an end of said thrust phase.

31. The method of claim 24, wherein said null phase and said thrust phase are carried out within two or more interconnected engines on a platform, and wherein said null phase and said thrust phase occur simultaneously or overlap so as to smooth out intermittent movement, thereby creating a generally continuous unidirectional motion of said platform.

32. The method of claim 24, wherein said shaft is said first-axis torquing system with a dual function of producing a null-phase dampable-forcing torque and producing said thrust-phase damping forcing torque on said first axis, wherein said null-phase dampable-forcing torque can cause a rotation in either direction of said first-axis torquing system and said at least one precessable mass, wherein said thrust-phase damping forcing torque immobilizes or reverses the rotation of said first-axis torquing system, and wherein said first-axis torquing system comprises at least one of a first-axis motive torquer or a first-axis resistive torquer.

33. The method of claim 20, wherein said third-axis torquing system has a dual function of both producing a thrust-phase dampable-forcing torque and a said null-phase damping forcing torque on said third axis, wherein said thrust-phase dampable-forcing torque initiates a second precessional torque by displacing said at least one precessable mass, and wherein said null-phase damping forcing torque damps said first precessional torque.

34. The method of claim 24, wherein said at least one precessable mass is a spinnable rotor, vibrating structure gyroscope, Coriolis vibratory gyroscope, cylindrical resonator gyroscope, piezoelectric gyroscopes, tuning-fork gyroscope, vibrating-wheel gyroscope, or a seismic mass that can induce an orthogonal torque when said at least one precessable mass is spun or vibrated, as well as displaced on a curved trajectory.

35. The method of claim 24 wherein said null phase and said thrust phase follow one another in succession so as create said unidirectional motion in an intended direction of rectilinear or curvilinear movement of said engine and wherein said null phase and said thrust phase, in combination, comprise a methodology for operating of an inertial-thruster.

36. The method of claim 18, wherein the thrust-phase dampable-forcing torque causes a reversal of the curved trajectory of the at least one precessable mass on said third axis during a portion of said thrust phase and initially generates a negative torque that causes a resistance and a delaying of said first precessional torque at an onset of said null phase.

37. A method for operating an inertial-thruster engine comprising,
pivoting a shaft of said engine on a third-axis, wherein the pivoting of said shaft on the third axis, moves at least one precessable mass associated with said shaft, wherein said at least one precessable mass has precession-related motion on a second axis, wherein upon moving of said at least one precessable mass on said third axis, and upon having precession-related motion of said at least one precessable mass on said second axis, either a reverse precessional torque or a forwards precessional torque is induced on a first axis; and
pivoting a shaft of said engine on said first-axis, wherein the pivoting of said shaft moves at least one precessable mass associated with said shaft, wherein said at least one precessable mass has precession-related motion on said second axis, wherein upon moving of said at least one precessable mass on said first axis, and upon having precession-related motion of said at least one precessable mass on said second axis, either a reverse precessional torque or a forwards precessional torque is induced on said third axis; and
to define a null phase, applying a null-phase damping torque and a null-phase dampable-forcing torque, wherein said null-phase dampable-forcing torque is caused by said pivoting of the shaft on the third axis and thereby inducing a first-precessional torque on said first axis, wherein said null-phase dampable-forcing torque is applied for a majority of the null phase, and wherein at least one null-phase damping torque redirects the torque axis of said first precessional torque in a different direction; and
to define a thrust phase, applying a thrust-phase dampable-forcing torque that causes a curved trajectory of said precessable mass on said first axis, wherein said thrust-phase dampable-forcing torque creates a second precessional torque on said third axis, if said precessable mass has precession-related motion, and applying a thrust-phase damping forcing torque that damps said second precessional torque of the at least one precessable mass on said third axis, wherein said thrust-phase damping forcing torque either redirects said second precessional torque in a different direction, if said at least one precessable mass spinning, or does not redirect said second precessional torque if spinning of said at least one precessable mass is stopped, and wherein the movement of the at least one precessable mass causes an opposite reaction that produces a unilinear or curvilinear motion of the engine that is substantially forward and in said general forward direction of movement of the engine.

38. The method of claim 37, wherein said null-phase damping torque is a pre-first precessional torque on the first-axis caused by a third-axis damping forcing torque, wherein said pre-first precessional torque causes a rearward residual momentum that is substantially in the opposite direction to the general direction of movement of the engine, wherein said rearward residual momentum is instantly followed by said first-precessional torque, wherein the delaying of precession caused by said pre-first residual momentum causes the redirection of the torque axis of said first precessional torque in a different direction.

39. The method of claim 37, wherein said null-phase damping torque is a forward residual momentum that is left over from the orbiting of said precessable mass on said first axis during said thrust phase, wherein the hurrying of precession caused by said forward residual momentum redirects the torque axis of said first precessional torque in a different direction.

40. The method of claim 37, wherein said null-phase damping torque is a forward motive torque caused by the first-axis motive torquer for a majority of said null phase, wherein the hurrying of precession caused by said forward motive torque of the first-axis motive torquer, redirects the torque axis of said first precessional torque in a different direction.

41. The method of claim 37, wherein said null-phase damping torque is a temporary resistive torque caused by said first-axis resistive torquer that is applied only at the onset of said first-precessional torque, wherein the delaying of precession caused by said temporary resistive torque causes the redirection of the torque axis of said first precessional torque in a different direction.

42. The method of claim 38, wherein said pre-first precessional torque is followed by the activation of said first-axis motive torquer for a majority of said minimized thrust phase wherein said first-axis motive torque is applied simultaneously with said first precessional torque.

43. The method of claim 37, wherein a brief rearward torque or a brief forward torque on the first axis that is simultaneous to the onset of said first precessional torque causes a delaying or hurrying of said first precessional torque during said onset of said minimized-thrust phase, and wherein said delaying or hurrying of said first precessional torque redirects said first precessional torque in a different direction.
